(19) United States
(12) Patent Application Publication
(10) Pub. No.: US 2009/0009922 A1
(43) Pub. Date: Jan. 8, 2009

(54) ELECTRIC-INSULATING SHEET NEUTRALIZING DEVICE, NETURALIZING METHOD AND PRODUCTION METHOD

(75) Inventors: Yasuyuki Hirai, Shiga (JP); Satoko Morioka, Kyoto (JP); Harumi Tanaka, Shiga (JP)

Correspondence Address: RATNERPRESTIA, P.O. BOX 980, VALLEY FORGE, PA, 19482, US

(73) Assignee: TORAY INDUSTRIES, INC., Tokyo (JP)

(21) Appl. No.: 11/814,989

(22) PCT Filed: Jan. 24, 2006
(86) PCT No.: PCT/JP2006/300990

§ 371 Date: Jul. 27, 2007

(30) Foreign Application Priority Data
Jan. 28, 2005 (JP) 2005-020932
Oct. 21, 2005 (JP) 2005-306684

(51) Int. Cl. H05F 3/04

(52) U.S. Cl. 361/213

(57) ABSTRACT

A neutralizing device for an electric-insulating sheet comprising at least two neutralizing units provided on the moving route of an electric-insulating sheet at intervals in the moving direction of the sheet, each neutralizing unit having a first electrode unit disposed on the first surface side of the sheet and a second electrode unit disposed on the second surface side of the sheet, the first electrode unit having a first ion generating electrode, the second electrode unit having a second ion generating electrode disposed facing the first ion generating electrode, wherein, in each neutralizing unit, the first ion generating electrode and the second ion generating electrode are so related as to be given a dc inter-ion-generating-electrode potential difference, and, when a total number of the neutralizing units is n (n: integer of at least two), the inter-ion-generating-electrode potential difference in at least n/4 (fractional portion rounded up) neutralizing units out of n neutralizing units and the inter-ion-generating-electrode potential difference in the other neutralizing units are in mutually-reverse-polarity potential difference relation.

### TECHNICAL FIELD

The present invention relates to a static eliminator, a static eliminating method and a production method for an insulating sheet.

### BACKGROUND ART

The charges of an insulating sheet, such as a plastic film or the like, can inhibit the processing of the sheet during a sheet processing operation. As a result, the quality of the processed product does not become as expected in some cases. For example, in the case where a sheet having locally strong charges or discharge marks which are called static marks caused by electrostatic discharge is subjected to processing, such as printing or coating with a coating material, the resultant processed product has uneven coat of the coating material or ink. In production processes of metallizing films for capacitors, wrapping, etc., processed products sometimes have static marks after a coating process, such as vacuum deposition, sputtering, etc. The strong charges in a portion of a film having a static mark leads to the close adherence of the film to another member due to electrostatic force, which becomes a cause of occurrence of various problems such as a conveyance failure, a positioning-related problem, and a cut-sheet jog failure.

Conventionally used to avoid such problems are: a self-discharge type static eliminator in which a grounded brush-like conductor is brought close to a charged insulating sheet to cause corona discharge at the tip of the brush for static elimination, and an alternating-current or direct-current voltage application type static eliminator in which power-frequency high voltage or direct-current high voltage is applied to needle electrodes to cause corona discharge for static elimination. In the self-discharge type static eliminator and the voltage application type static eliminator, ions from corona discharge are attracted to an insulating sheet due to the electric field created by the charges of the sheet, thereby neutralizing the charges of the insulating sheet, that is, accomplishing static elimination. Therefore, it is possible to reduce the potential of a sheet that is charged at a high potential.

However, the charges of an insulating sheet is, due to electrostatic discharge on the sheet or the like, often in a state where regions having positive charge and negative charge are mixed at small pitches on one side surface or both side surfaces of the sheet. Particularly, in the case where both sides of a sheet are charged, each side surface is often charged with the opposite polarities. The charges in this state are called “both-sided bipolar charges”. The electric fields of an insulating sheet having such charges concentrate only in an interior of the sheet (in the direction of thickness) and vicinities of the surfaces of the sheet. Therefore, the insulating sheet cannot attract a sufficient amount of ions from an ion generating portion (the tip of a brush or the pointed end of a needle electrode) of the static eliminator that is at a position slightly apart from the sheet. Thus, substantially no static eliminating effect can be obtained with respect to sheets that have such a fine charge pattern.

In this regard, there are known a static eliminator 1 for sheets (see Patent Document 1) shown in FIG. 1 and a static eliminator 2 for sheets (see Patent Document 2) shown in FIG. 2 in which opposite-phase alternating voltages are applied to an ion generating electrode and an ion attracting electrode that are disposed apart from each other at opposite sides of an insulating sheet.

According to the static eliminators of Patent document 1 and Patent Document 2, the insulating sheet S is irradiated in a forced fashion with ions by the electric field between an ion generating electrode 1b and an ion attracting electrode 1d, or the electric field between an electrode for generating ion 2b and an electrode for accelerating ion 2d, and the electric field between an ion generating electrode 2f and an electrode for accelerating ion 2h, independently of the electric fields caused by the charges of the sheet S. Therefore, it is considered that the static eliminating effect is high even on a sheet having a fine charge pattern.

However, in the case where ions are irradiated in a forced fashion from one side of the sheet S as in the static eliminator 1 shown in FIG. 1 which is disclosed in Patent Document 1, the sheet S becomes charged with the polarity of the ions irradiated in a forced fashion, and causes the following two problems.

The first problem is that the potential of the sheet S rises due to the ions irradiated in a forced fashion. Even though the charges of the sheet S is of a charge density of the order of only 1 μC/m², the potential of the sheet S to a grounded structure rises to several 10 kV or higher as the sheet S is irradiated from one side thereof with ions of one polarity during a state where the sheet S is being conveyed in the air. This phenomenon occurs because, as the distance to the grounded structure is greater, the capacitance of the sheet S becomes smaller, and the potential thereof becomes higher if the charge density is fixed.

The potential measured during the state where the sheet S is being conveyed in the air will be hereinafter referred to as “aerial potential”. If the aerial potential rises, the ions receive repulsion based on the Coulomb's force due to the charges of the sheet S, and are hindered from reaching the sheet S. In other words, only a small amount of ions brought to the sheet S by the forced irradiation during an initial period raises the absolute value of potential of the sheet S. Therefore, even if ions of the same polarity continue to be irradiated in a forced fashion, the sheet S comes to fail to accept any more ions.

That is, a state is formed in which irradiation of a sufficient amount of ions to the sheet S is not achieved even if a large amount of ions is generated at the ion generating electrode. The amount of ions that can be irradiated thereto is as small as about 1 μC/m². This value is, generally, much smaller than the charge density of each side of a sheet S that is charged in the both-sided bipolar fashion due to discharge traces or the like. According to a study by the present inventors, the charge density at sites of discharge traces or the like on each side of a sheet S is about several 10 to several 100 μC/m².

The second problem is that since alternating voltage is used, unevenness of positive and negative charges corresponding to the polarities of ions irradiated in a forced fashion occurs in the sheet S in the traveling direction of the sheet S. To remove this unevenness, further direct-current and alternating-current static eliminators 1e and 1f are often required downstream of the static eliminator 1.

In the static eliminator 1 of Patent document 1, only one side surface (static elimination surface) of a sheet S is irradiated with ions. Therefore, in the case where the sheet S is both-side bipolar charged, the charges present in the side surface (non-static elimination surface) opposite to the static elimination surface cannot be eliminated (neutralized). This phenomenon occurs because in an insulating sheet S, charges cannot easily move in the directions of the thickness thereof.

While the charges present in the non-static elimination surface of the sheet S are kept, ions equal in amount but opposite in polarity to the charges of the non-static elimination surface attach to sites on the opposite side surface (static elimination surface) that are at the same positions in the in-plane directions as the charges on the non-static elimination surface. This phenomenon occurs because irradiated ions are attracted by the Coulomb's force, regardless of the difference between the charges on the both sides (the static elimination surface and the non-static elimination surface) of the sheet S.

In the sheet S obtained finally by the static eliminator 1 of Patent document 1, that is, after being processed by the direct-current and alternating-current static eliminators 1e and 1f disposed downstream, the sum of the local charge densities of both the surfaces at the same sites in the in-plane directions of the sheet S (apparent charge density) is substantially zero. In reality, however, this state is a state where both surfaces of the insulating sheet S at a site of the same position in the in-plane directions of the sheet S are charged in equal amounts but with opposite polarities. Such a state of the sheet S is referred to as “apparent non-charged” state, and such static elimination is referred to as “apparent static elimination”.

In the static eliminator 2 shown in FIG. 2 which is disclosed in Patent document 2, ions are irradiated to both side surfaces of the sheet S. However, this ion irradiation is performed not simultaneously but alternately on both surfaces of the sheet S. Therefore, during each step of ion irradiation, the aforementioned first and second problems occur as in the static eliminator 1 disclosed in Patent Document 1. Due to the presence of the first problem, the amount of ion irradiation that reaches the sheet S is small. As a result, with regard to a sheet S charged in the both-sided bipolar fashion, the static eliminator 2 has substantially no ability to reduce the charges on each side of the sheet S. Therefore, similar to the static eliminator 1 disclosed in Patent Document 1, the static eliminator 2 is substantially unable to eliminate the charges of the sheet S any further than the “apparent non-charged” state.

A static eliminator 3 shown in FIG. 3 is disclosed in Patent Document 3. This static eliminator 3 has a structure in which a first ion generating electrode 3a to which a direct-current voltage of the positive polarity is applied is disposed at the side of one side surface of the sheet S, at an interval from the sheet S, and a second ion generating electrode 3c to which a direct-current voltage of the negative polarity is applied is disposed at the side of the opposite surface of the sheet S, at an interval from the sheet S, and ions of the opposite polarities are simultaneously irradiated at both surfaces of the sheet S.

According to the knowledge of the present inventors, although not described in Patent Document 3, the static eliminator 3, unlike the static eliminator 2 disclosed in Patent Document 2, is unlikely to have the aforementioned first and second problems since ions of the opposite polarities are simultaneously irradiated at both surfaces of the sheet S. That is, in the static eliminator 3 of Patent Document 3, the “aerial potential” of the sheet S does not rise, and therefore sufficient ion irradiation can be accomplished on both surfaces of the sheet S.

In the static eliminator 3 disclosed in Patent Document 3, however, one surface of the sheet S is irradiated only with positive ions, and the opposite surface is irradiated only with negative ions. Therefore, for example, while static elimination effect can be obtained only for the sites on the sheet where a first surface 100 is negatively charged and a second surface 200 is positively charged, static elimination effect cannot be obtained for the sites on the sheet where the first surface 100 is positively charged and the second surface 200 is negatively charged. Moreover, a phenomenon in which the charge on each surface of a sheet S increases has been recognized in the case where the polarities of charges of the surfaces of the sheet S are the same as the polarities of ions irradiated to the surfaces of the sheet S.

A static eliminator 4 shown in FIG. 4 is disclosed in Patent Document 3 or Patent Document 4. This static eliminator 4 has a structure in which a pair of ion generating electrodes 4a and 4c to which alternating-current voltages of opposite polarities are disposed at both surfaces of a sheet S, at intervals left from the sheet S, and both surfaces of the sheet S are simultaneously irradiated with ions of opposite polarities while the polarities thereof change with time.

In the case where alternating-current voltages are used, it appears that ions of the positive and negative polarities are irradiated to each one of the first surface 100 and the second surface 200 of the sheet. However, in a view of various portions of the moving sheet S, sites where the first surface 100 is irradiated with positive ions (the second surface 200 is irradiated with negative ions) and sites where the first surface 100 is irradiated with negative ions (the second surface 200 is irradiated with positive ions) merely alternate cyclically in the traveling direction of the sheet S. That is, even in the ideal case, individual sites of the sheet S merely undergo irradiation of each surface thereof with ions of a corresponding one of the polarities.

In a view of an individual site at an arbitrary position in the traveling direction of the sheet S, the polarities of charges of both surfaces of the sheet S are opposite in polarity to each other, and the aerial potential is substantially zero. If the amounts of ion attachment to the surfaces of the sheet S are viewed in terms of individual sites in the traveling direction of the sheet S, positive and negative ions alternately attach cyclically, that is, uneven ion attachment occurs. With this technology alone, sufficient static charges cannot be achieved on each surface of a sheet S with positive and negative charges mingled, and what can be achieved is, at most, “apparent non-charged”.

According to the knowledge of the present inventors, as forms of ion generating electrodes disposed at the surfaces of a sheet S, Patent Document 3 presents a form in which three wires to which direct-current voltages of the same polarity are applied are disposed in parallel with the traveling direction of the sheet S, and one wire to which alternating-current is applied. However, in any one of these forms, each site in the sheet S is merely irradiated with ions of one polarity at each one of the surfaces of the sheet S.

In the case where a plurality of static eliminators as disclosed in Patent document 3 or Patent Document 4 in which a pair of ion generating electrodes to which alternating-current voltages of opposite polarities are applied are disposed at intervals from the sheet S, and both surfaces of the sheet S are simultaneously irradiated with ions of opposite polarities while the polarities thereof change with time are juxtaposed in the traveling direction of the sheet S, ion attachment unevenness, including the polarities of ions attached, occur in various sites in the movement direction of the sheet S. Therefore, the ion attachment unevenness in various sites in each surface of the sheet S sometimes increases depending on conditions, such as the moving speed of the sheet S, the magnitude and frequency of alternating-current voltage, the intervals between the static eliminators in the traveling direction of the sheet S, etc.

Patent Document 5 discloses an apparatus in which a pair of ion generating electrodes to which direct-current voltages of opposite polarities are applied are disposed at opposite sides of two superimposed sheets S, and ions of opposite polarities are irradiated to both surfaces of the sheets S so as to stick the sheets S together. However, with regard to such apparatuses for sticking sheets S together, the object is only to charge the individual sheets S in opposite polarities, without any consideration made on the static elimination of each one of the sheets S.

The present inventors have recognized that as for such an insulating sheet in a state where each surface is charged despite apparent non-charged, the original charge pattern develops again if during a processing of the sheet, metal vapor deposition or application of a coating agent or the like is performed on the sheet.

If metal vapor deposition is performed on a sheet of apparent non-charged for the purpose of conductive coating processing, charges opposite in polarity to the charges in the vapor deposition surface of the sheet are induced in a metal vapor deposition layer surface located at the interface with the sheet, so that the potential at the interface becomes zero. Since charges exist in the non-vapor deposition surface of the sheet, an electric field due to the charges in the non-vapor deposition is formed near the non-vapor deposition surface of the sheet, so that a static mark develops.

In the case of application of a coating agent, a metallic roll that is a conductive roll is used as a backup roll, and the application of a coating agent is sometimes performed on the sheet over the roll. In this case, as for the contact surfaces of the sheet and the metallic roll, charges opposite in polarity to the charges on the sheet are induced in the surface of the metallic roll, so that the potential at the contact surfaces becomes zero. Since charges exist in the non-contact surface of the sheet (the surface of application of a coating agent), an electric field due to the charges in the application surface forms in the vicinity of the application surface, thereby causing application unevenness of the coating agent.

As previously described, any one of the conventional technologies merely performs at most “apparent static elimination” on an insulating sheet. The conventional technologies cannot resolve the problems of occurrence of static marks following a coating process, such as vacuum vapor deposition, sputtering or the like, a jog failure of cut sheets due to a slip failure, attachment unevenness of an ink or a coating agent, etc.

Patent Document 1: JP 2,651,476 B

Patent Document 2: JP 2002-313596 A

Patent Document 3: JP 2004-039421 A

Patent Document 4: U.S. Pat. No. 3,475,652 B

Patent Document 5: U.S. Pat. No. 3,892,614 B

Non-Patent Document 1: Static Electricity Handbook, edited by the Static Electricity Society, 0hmu Co., Ltd., 1998, p. 46

### DISCLOSURE OF THE INVENTION

### Problems to be Solved by the Invention

An object of the present invention is to provide a static eliminator and a static eliminating method that solve the problems in the conventional technologies, and can easily eliminate charged regions of the positive polarity and the negative polarity mingling at small pitches in one surface or both surfaces of an insulating sheet. In particular, the present invention provides a static eliminator and a static eliminating method that can be used in a wide range of the moving speed of the sheet that is subjected to the static eliminating process.

### Means for Solving the Problems

In order to achieve the aforementioned objects, the static eliminator for an insulating sheet of the present invention comprises the following modes.

(1) A static eliminator for an insulating sheet having at least two static eliminating units that are provided with an interval left therebetween in a traveling direction of an insulating sheet, in association with a traveling path of said sheet, each of said static eliminating units having a first electrode unit disposed at a first surface side of said sheet, and a second electrode unit disposed at a second surface side of said sheet, said first electrode unit having a first ion generating electrode, said second electrode unit having a second ion generating electrode that is disposed facing said first ion generating electrode, said static eliminator having a relationship that a direct-current inter-ion generating electrode potential difference is given between said first ion generating electrode and said second ion generating electrode in each of said static eliminating units, and having a relationship that, where the total number of said static eliminating unit is n (n is an integer of 2 or greater), said inter-ion generating electrode potential difference in n/4 number or more (fraction part counted as one) of said static eliminating units among the n number of said static eliminating units, and said inter-ion generating electrode potential difference in the other said static eliminating units are potential differences that are opposite in polarity to each other.

Hereupon, an electric potential difference and an electric voltage are generally used as a synonym each other in the field of the present invention, and it is possible to replace the wording of the electric potential difference with the wording of the electric voltage.

(2) A static eliminator for an insulating sheet having at least two static eliminating units that are provided with an interval left therebetween in a traveling direction of an insulating sheet, in association with a traveling path of said sheet, each of said static eliminating units having a first electrode unit disposed at a first surface side of said sheet, and a second electrode unit disposed at a second surface side of said sheet, said first electrode unit having a first ion generating electrode, said second electrode unit having a second ion generating electrode that is disposed facing said first ion generating electrode, said static eliminator having a relationship that said first ion generating electrode and said second ion generating electrode in each of said static eliminating units are given a direct-current inter-ion generating electrode potential difference by applying direct-current voltages opposite in polarity to each other, and having a relationship that, where the total number of said static eliminating unit is n (n is an integer of 2 or greater), said inter-ion generating electrode potential difference in n/4 number or more (fraction part counted as one) of said static eliminating units among the n number of said static eliminating units, and said inter-ion generating electrode potential difference in the other said static eliminating units are potential differences that are opposite in polarity to each other.

This embodiment is described as follows by replacing the electric potential difference with the electric voltage in the embodiment.

A static eliminator for an insulating sheet having at least two static eliminating units that are provided with an interval left therebetween in a traveling direction of an insulating sheet, in association with a traveling path of said sheet, each of said static eliminating units having a first electrode unit disposed at a first surface side of said sheet, and a second electrode unit disposed at a second surface side of said sheet, said first electrode unit having a first ion generating electrode, said second electrode unit having a second ion generating electrode that is disposed facing said first ion generating electrode, said static eliminator having a relationship that in each of said static eliminating units a direct-current voltage applied to said first ion generating electrode and said second ion generating electrode are opposite in polarity to each other, and having a relationship that, where the total number of said static eliminating unit is n (n is an integer of 2 or greater), the voltage applied to said first ion generating electrode in n/4 number or more (fraction part counted as one) of said static eliminating units among the n number of said static eliminating units and the voltage applied to said first ion generating electrode in the other said static eliminating units are opposite in polarity to each other.

(3) A static eliminator for an insulating sheet having at least two static eliminating units that are provided with an interval left therebetween in a movement direction of an insulating sheet, in association with a traveling path of said sheet, each of said static eliminating units having a first electrode unit disposed at a first surface side of said sheet, and a second electrode unit disposed at a second surface side of said sheet, said first electrode unit having a first ion generating electrode, said second electrode unit having a second ion generating electrode that is disposed facing said first ion generating electrode, said static eliminator having a relationship that said first ion generating electrode and said second ion generating electrode in each of said static eliminating units are given a direct-current inter-ion generating electrode potential difference by applying a direct-current voltages opposite in polarity to each other with respect to a ground potential to the first and second ion generating electrodes, or by applying a ground potential to one of the first and second ion generating electrodes, and a direct-current voltage to the other one of the first and second ion generating electrodes, and having a relationship that, where the total number of said static eliminating unit is n (n is an integer of 2 or greater), said inter-ion generating electrode potential difference in n/4 number or more (fraction part counted as one) of said static eliminating units among the n number of said static eliminating units, and said inter-ion generating electrode potential difference in the other said static eliminating units are potential differences that are opposite in polarity to each other.

(4) A static eliminator for an insulating sheet having at least two static eliminating units that are provided with an interval left therebetween in a traveling direction of an insulating sheet, in association with a traveling path of said sheet, each of said static eliminating units having a first electrode unit disposed at a first surface side of said sheet, and a second electrode unit disposed at a second surface side of said sheet, said first electrode unit having a first ion generating electrode, said second electrode unit having a second ion generating electrode that is disposed facing said first ion generating electrode, said static eliminator having a relationship that said first ion generating electrode and said second ion generating electrode in each of said static eliminating units are given a direct-current inter-ion generating electrode potential difference by giving potential difference opposite in polarity to each other with reference to a predetermined common potential, and having a relationship that, where the total number of said static eliminating unit is n (n is an integer of 2 or greater), said inter-ion generating electrode potential difference in n/4 number or more (fraction part counted as one) of said static eliminating units among the n number of said static eliminating units, and said inter-ion generating electrode potential difference in the other said static eliminating units are potential differences that are opposite in polarity to each other.

(5) The static eliminator for an insulating sheet according to anyone of the items (1) to (4), having a relationship that said inter-ion generating electrode potential difference in n/2 number or more (fraction part disregarded) of said static eliminating units among the n number of said static eliminating units is a potential difference that is opposite in polarity to said inter-ion generating electrode potential difference in the other said static eliminating units.

(6) The static eliminator for an insulating sheet according to any one of the items (1) to (4), having a relationship that with regard to all of said static eliminating units, said inter-ion generating electrode potential differences of said static eliminating units adjacent in the traveling direction of said sheet are potential differences that are opposite in polarity to each other.

(7) A static eliminator for an insulating sheet having at least two static eliminating units that are provided with an interval left therebetween in a traveling direction of an insulating sheet, in association with a traveling path of said sheet, each of said static eliminating units having a first electrode unit disposed at a first surface side of said sheet, and a second electrode unit disposed at a second surface side of said sheet, said first electrode unit having a first ion generating electrode, said second electrode unit having a second ion generating electrode that is disposed facing said first ion generating electrode,

(a) wherein said first electrode unit and said second electrode unit in at least one of said static eliminating units are both ion generating electrode exposed type electrode units, and

(b) wherein said static eliminator has a relationship that direct-current and/or alternating-current inter-ion generating electrode potential difference is given between said first ion generating electrode and said second ion generating electrode in each of said static eliminating units, and

(c) wherein said static eliminator has a relationship that, where the total number of said static eliminating unit is n (n is an integer of 2 or greater), said inter-ion generating electrode potential difference in n/4 number or more (fraction part counted as one) of said static eliminating units among the n number of said static eliminating units, and said inter-ion generating electrode potential difference in the other said static eliminating units are potential differences that are opposite in polarity to each other.

(8) The static eliminator for an insulating sheet according to any one of the items (1) to (4) and (7), having a relationship that in at least one pair of said static eliminating units adjacent in the traveling direction of said sheet, said inter-ion generating electrode potential differences of said at least one pair of said static eliminating units are potential differences that are opposite in polarity to each other, and a static eliminating unit interval of said at least one pair of said static eliminating units is 0.8 or greater times to 3.0 or less times a maximum value of normal direction inter-electrode distances of said at least one pair of said static eliminating units.

(9) The static eliminator for an insulating sheet according to the item (8), having a relationship that the static eliminating unit interval of said at least one pair of said static eliminating units is 0.8 or greater times to 2.0 or less times the maximum value of the normal direction inter-electrode distances of said at least one pair of said static eliminating units.

(10) The static eliminator for an insulating sheet according to any one of the items (1) to (4), wherein in each of said static eliminating units, said first electrode unit has a first shield electrode and said second electrode unit has a second shield electrode, and having a relationship that in at least one pair of said static eliminating units adjacent in the traveling direction of said sheet, said inter-ion generating electrode potential differences of said at least one pair of said static eliminating units are potential differences that are opposite in polarity to each other, and a static eliminating unit interval of said at least one pair of said static eliminating units is 1.0 or greater times to 1.5 or less times a mean value of widthwise dimensions of said at least one pair of said static eliminating units.

(11) The static eliminator for an insulating sheet according to any one of the items (1) to (4) and (7), having a relationship that in at least one pair of said static eliminating units adjacent in the traveling direction of said sheet, said inter-ion generating electrode potential differences of said at least one pair of said static eliminating units are potential differences that are equal in polarity to each other, and a static eliminating unit interval of said at least one pair of said static eliminating units is 2.0 or greater times a maximum value of normal direction inter-electrode distances of said at least one pair of said static eliminating units.

(12) The static eliminator for an insulating sheet according to any one of the items (1) to (4), wherein in each of said static eliminating units, said first electrode unit has a first shield electrode and said second electrode unit has a second shield electrode, and having a relationship that in at least one pair of said static eliminating units adjacent in the traveling direction of said sheet, said inter-ion generating electrode potential differences of said at least one pair of said static eliminating units are potential differences that are equal in polarity to each other, and a static eliminating unit interval of said at least one pair of said static eliminating units is 1.5 or greater times a mean value of widthwise dimensions of said at least one pair of said static eliminating units.

(13) The static eliminator for an insulating sheet according to any one of the items (1) to (4) and (7), wherein a power supply that gives said inter-ion generating electrode potential difference of each of said static eliminating units comprises a direct-current power supply whose ripple factor is 5% or less.

(14) The static eliminator for an insulating sheet according to any one of the items (1) to (4) and (7), having measurement means disposed at a downstream side of said static eliminating units in the traveling direction of said sheet for measuring a surface potential of a side of said insulating sheet opposite from a ground electrically conductive component while keeping said electrical insulating sheet in contact with said ground electrically conductive component, and control means for controlling said inter-ion generating electrode potential difference in at least one of said static eliminating units on a basis of a measurement value of said surface potential.

(15) The static eliminator for an insulating sheet according to any one of the items (1) to (4) and (7), having a relationship that an absolute value of said inter-ion generating electrode potential difference of a static eliminating unit that is provided most downstream in the traveling direction of said sheet among said static eliminating units is smaller than said inter-ion generating electrode potential difference of the other said static eliminating units.

(16) The static eliminator for an insulating sheet according to any one of the items (1) to (4) and (7), wherein a normal direction inter-electrode distance of a static eliminating unit that is provided most downstream in the traveling direction of said sheet among said static eliminating units is greater than the normal direction inter-electrode distance of the other said static eliminating units.

(17) The static eliminator for an insulating sheet according to any one of the items (1) to (4) and (7), wherein an electrode discrepancy of at least a static eliminating unit that is provided most downstream in the traveling direction of said sheet among said static eliminating units is greater than the electrode discrepancy of the other static eliminating units.

(18) The static eliminator for an insulating sheet according to any one of the items (1) to (4) and (7), having at least one alternating-current static eliminating unit that has a first alternating-current ion generating electrode and a second alternating-current ion generating electrode that are disposed facing each other across said sheet, at a downstream side of said static eliminating units in the traveling direction of said sheet, and having a relationship that an alternating-current inter-ion generating electrode potential difference is given between said first alternating-current ion generating electrode and said second alternating-current ion generating electrode.

(19) The static eliminator for an insulating sheet according to any one of the items (1) to (4) and (7), having a relationship that a positive or negative direct-current voltage is applied from at least one single power supply to said first ion generating electrode of at least one of said static eliminating units among said n number of said static eliminating units, and to said second ion generating electrode of at least one of said static eliminating units that is equal in number to said at least one of said static eliminating units and that is other than said at least one of said static eliminating units.

In order to achieve the aforementioned objects, the static eliminating method for an insulating sheet of the present invention comprises the following modes.

(20) A static eliminating method for an insulating sheet, wherein a pair of ion clouds whose polarities do not temporally change are irradiated to an insulating sheet in motion, simultaneously from a side of a first surface and a side of a second surface of said sheet so that a potential difference is given between both surfaces, and then a pair of ion clouds whose polarities have been reversed from the polarities of the previous irradiation and whose polarities do not temporally change are irradiated to the first surface and the second surface of said sheet simultaneously with respect to the surfaces of said sheet, and the irradiation of said ion clouds is performed so that the amounts of ions of the two polarities become substantially equal.

(21) A static eliminating method for an insulating sheet, wherein, where a temporal mean value of said inter-ion generating electrode potential difference in the mth (m is an integer of 1 or greater ton or less) one of said static eliminating units in respect to the traveling direction of said sheet is Vₘ [unit: kV], and a normal direction inter-electrode distance of the mth static eliminating unit is d₁₋ₘ [unit: mm], and a ripple factor of said inter-ion generating electrode potential difference is yₘ [unit: %], static elimination of said insulating sheet is performed by using the static eliminator according to any one of the items (1) to (4) and (7) so that

a relationship expressed by an expression |Vₘ|/d₁₋ₘ>0.26 is satisfied, and

at least one relationship of a first relationship expressed by an expression yₘ≦5 and a second relationship expressed by an expression |Vₘ|<16 and an expression |Vₘ|/d₁₋ₘ<0.35 is satisfied.

(22) The static eliminating method for an insulating sheet according to the item (21), wherein a peak to peak amplitude of a sum of the voltage applied to said first ion generating electrode and the voltage applied to said second ion generating electrode in said mth static eliminating unit is 0.05 or greater times to 0.975 or less times an absolute value of the temporal mean value of said inter-ion generating electrode potential difference in said mth static eliminating unit.

(23) A static eliminating method for an insulating sheet, wherein said first ion generating electrode and said second ion generating electrode in each of said static eliminating units are given a direct-current inter-ion generating electrode potential difference by applying direct-current voltages opposite in polarity to each other, and wherein, where temporal mean values of the direct-current voltages applied to said first ion generating electrode and said second ion generating electrode in the mth (m is an integer of 1 or greater to n or less) one of said static eliminating units in respect to the traveling direction of said sheet are V₁₋ₘ [unit: kV] and V₂₋ₘ [unit: kV], respectively, and a normal direction inter-electrode distance of the mth static eliminating unit is d₁₋ₘ [unit: mm], and a mean ripple factor of a ripple factor of said direct-current voltage applied to said first ion generating electrode and a ripple factor of said direct-current voltage applied to said second ion generating electrode in said mth static eliminating unit is xₘ [unit: %], static elimination of said insulating sheet is performed by using the static eliminator according to any one of the items (1) to (4) and (7) so that

a relationship expressed by an expression |V₁₋ₘ-V₂₋ₘ|/d₁₋ₘ>0.26 is satisfied, and

at least one relationship of a first relationship expressed by an expression xₘ≦5 and a second relationship expressed by an expression |V₁₋ₘ|<8, an expression |V₂₋ₘ|<8 and an expression |V₁₋ₘ-V₂₋ₘ|/d₁₋ₘ<0.35 is satisfied.

In order to achieve the aforementioned objects, the method for producing a charge-eliminated insulating sheet of the present invention comprises the following modes.

(24) A method for producing a charge-eliminated insulating sheet, wherein a pair of ion clouds whose polarities do not temporally change are irradiated to an insulating sheet in motion, simultaneously from a first surface side and a second surface side of said sheet so that a potential difference is given between both surfaces, and then a pair of ion clouds whose polarities have been reversed from the polarities of the previous irradiation and whose polarities do not temporally change are irradiated to the first surface and the second surface of said sheet simultaneously with respect to the surfaces of said sheet, and the irradiation of said ion clouds is performed so that the amounts of ions of the two polarities become substantially equal.

(25) A method for producing a charge-eliminated insulating sheet, wherein, where a temporal mean value of said inter-ion generating electrode potential difference in the mth (m is an integer of 1 or greater to n or less) one of said static eliminating units in respect to the traveling direction of said sheet is Vₘ [unit: kV], and a normal direction inter-electrode distance of the mth static eliminating unit is d₁₋ₘ [unit: mm], and a ripple factor of said inter-ion generating electrode potential difference is yₘ [unit: %], static elimination of said insulating sheet is performed by using the static eliminator according to any one of the items (1) to (4) and (7) so that

a relationship expressed by an expression |Vₘ|/d₁₋ₘ>0.26 is satisfied, and

at least one relationship of a first relationship expressed by an expression yₘ≦5 and a second relationship expressed by an expression |Vₘ|<16 and an expression |Vₘ|/d₁₋ₘ<0.35 is satisfied.

(26) A method for producing a charge-eliminated insulating sheet, according to the item (25), wherein a peak to peak amplitude of a sum of the voltage applied to said first ion generating electrode and the voltage applied to said second ion generating electrode in said mth static eliminating unit is 0.05 or greater times to 0.975 or less times an absolute value of the temporal mean value of said inter-ion generating electrode potential difference in said mth static eliminating unit.

(27) A method for producing a charge-eliminated insulating sheet, wherein said first ion generating electrode and said second ion generating electrode in each of said static eliminating units are given a direct-current inter-ion generating electrode potential difference by applying direct-current voltages opposite in polarity to each other, and wherein, where temporal mean values of the direct-current voltages applied to said first ion generating electrode and said second ion generating electrode in the mth (m is an integer of 1 or greater to n or less) static eliminating unit in respect to the traveling direction of said sheet are V₁₋ₘ [unit: kV] and V₂₋ₘ [unit: kV], respectively, and a normal direction inter-electrode distance of the mth static eliminating unit is d₁₋ₘ [unit: mm], and a mean ripple factor of a ripple factor of said direct-current voltage applied to said first ion generating electrode and a ripple factor of said direct-current voltage applied to said second ion generating electrode in said mth static eliminating unit is xₘ [unit: %], static elimination of said insulating sheet is performed by using the static eliminator according to any one of the items (1) to (4) and (7) so that

a relationship expressed by an expression |V₁₋ₘ-V₂₋ₘ|/d₁₋ₘ>0.26 is satisfied, and

at least one relationship of a first relationship expressed by an expression xₘ≦5 and a second relationship expressed by an expression |V₁₋ₘ|<8, an expression |V₂₋ₘ|<8 and an expression |V₁₋ₘ-V₂₋ₘ|/d₁₋ₘ<0.35 is satisfied.

Typical examples of the insulating sheet to which the present invention is applied include a plastic film, fabric and paper. The sheet can be fed from a long sheet wound as a roll or sheet by sheet.

Examples of the plastic film include a polyethylene terephthalate film, polyethylene naphthalate film, polypropylene film, polystyrene film, polycarbonate film, polyimide film, polyphenylene sulfide film, nylon film, aramid film, polyethylene film, etc. In general a plastic film has high insulation performance compared with sheets of other materials.

The static elimination technique provided by the invention can be effectively used for eliminating charges from a plastic film, especially for eliminating the positively and negatively charged sites alternately formed at a small pitch in the surfaces of the film.

In the present invention, the “traveling path of an insulating sheet” means a space through which the insulating sheet passes for being liberated from charges.

In the present invention, the “direction normal to an insulating sheet” means a direction normal to a plane (hereinafter, referred to as virtual mean plane) defined where an insulating sheet traveling in the traveling path is considered to be a plane free from sagging in the width direction assuming that the sheet is not affected by external force, such as gravity or the like; and in the case where there is a fluctuation in the position of the sheet in the direction normal of the sheet associated with traveling of the insulating sheet, the sheet is assumed to be in a temporally averaged position.

In the present invention, the “width direction” means a direction corresponding to the in-plane direction of the virtual mean plane, perpendicular to the traveling direction of the insulating sheet. Furthermore, in the case where “positions in the width direction” are mentioned, the term means positions within a range that actually contributes to static elimination.

In the invention, “the pointed end of ion-generating electrode” means the region that forms an electric field capable of generating ions, among respective portions of the ion generating electrode and that is nearest to the virtual mean plane. The ion generating electrode is often extended in the width direction. In this case, “the pointed ends” are determined at the respective positions in the width direction.

For example, in the case where the ion generating electrode is substituted by a wire electrode formed by a wire extending in the width direction of the sheet, the regions among the wire nearest to the virtual mean plane at the respective positions in the width direction correspond the regions. In the case where the ion generating electrode is an array of needle electrodes installed at predetermined intervals in the width direction and extending in the direction normal to the insulating sheet, the region among respective portions of the respective needle nearest to the virtual mean plane (the tips of the respective needle electrodes) correspond to the regions at those position in the width direction. At positions in the width direction where no tip of needle exist, “the pointed ends of the ion generating electrodes” are defined at the respective positions on a bent line 8aL connecting the respective tips of the needle electrodes provided at predetermined intervals in the width direction as shown in FIG. 6G. The bent line 8aL is called the virtual line of the pointed ends of the ion generating electrodes. At positions in the width direction where the tips of the needle electrodes exist, the positions on the virtual line of the pointed ends of the ion generating electrodes agree with the tips of the needle electrodes.

In the present invention, the “first and second ion generating electrodes are disposed facing each other” means that the first and second ion generating electrodes face each other through the sheet traveling path or the virtual mean plane, and that at each position in the width direction there exists no conductor such as a shield electrode between the position of the feet of the perpendiculars from the pointed end of the first ion generating electrode to the plane including the position of the pointed end of the second ion generating electrode and parallel to the virtual mean plane, and the position of the pointed end of the second ion generating electrode, and there exists no conductor such as a shield electrode between the position of the feet of the perpendiculars from the pointed end of the second ion generating electrode to the plane including the position of the pointed end of the first ion generating electrode and parallel to the virtual mean plane, and the position of the pointed end of the first ion generating electrode, and that the interval between the pointed end of the first ion generating electrode and the pointed end of the second ion generating electrode in the traveling direction of the sheet is within 10% of the normal direction inter-electrode distance.

In the invention, “ions” mean various charge carriers such as electrons, atoms gaining or losing electrons, molecules having charges, molecular clusters and suspended particles.

In the invention, “an ion cloud” means a group of ions generated by ion generating electrode, which spreads and floats in a certain space like a cloud without staying in a specific place.

In the invention, “an ion generating electrode” means an electrode capable of generating ions in the space near the pointed ends of the electrode due to, for example, the corona discharge caused by application of a high voltage.

In the invention, “a shield electrode” means an electrode disposed near ion-generating electrode, to give an adequate potential difference between the shield electrode and the ion generating electrode, for assisting the corona discharge at the pointed ends of the ion generating electrode.

In the present invention, the “ion generating electrode exposed type” electrode unit means electrode unit as shown in FIG. 6D wherein no conductor mainly of a metal or the like exists, except ion generating electrodes and conductors for supplying electricity thereto, within three-dimensional virtual spheres each having a radius that is ½ of the normal direction inter-electrode distance d₁₋ₘ in a static eliminating unit constructed of the electrode units, with the center each being at the pointed end of the ion generating electrode of the electrode unit.

In the present invention, the “partial electrodes” mean individual conductor portions if as indicated by 8a₁, 8a₂, . . . in FIG. 12A or FIG. 12B, the ion generating electrode of an electrode unit is constructed as an assembly 8a of many conductors that are divided in the width direction.

In the present invention, the “inter-ion generating electrode potential difference” means an potential difference obtained by subtracting the potential of the second ion generating electrode from the potential of the first ion generating electrode in a static eliminating unit. The “direct-current inter-ion generating electrode potential difference” means an potential difference which maintains the same polarity of the inter-ion generating electrode potential continuously for 1 second or longer without a reversal in the polarity, and has a ripple factor of 20% or less. The polarity of the ion generating electrode potential is preferably maintained without a reversal for 20 seconds or longer, and more preferably during one time of static elimination operation of one sheet. The one time of static elimination operation for one sheet means, for example, a static elimination operation from the beginning to the end of conveyance of one sheet roll. However, a reversal in polarity due to a non-cyclic noise component, such as white noise or the like, is not considered to be the reversal in polarity herein. A direct-current component at a certain moment of the inter-ion generating electrode potential difference is defined as a mean value of the potential difference in the previous one second from that moment.

The ripple factor yₘ of the inter-ion generating electrode potential difference in the mth static eliminating unit is defined by the expression Pr/P=yₘ/100 where, with respect to the applied voltage waveform (temporal mean value of applied voltage: V₁₋ₘ [unit: kV]) to the first ion generating electrode and the applied voltage waveform (temporal mean value of applied voltage: V₂₋ₘ [unit: kV]) to the second ion generating electrode as shown in FIG. 19A, the direct-current component of the waveform of the absolute value of the amount of difference ΔV [unit: kV] in the applied voltage as shown in FIG. 19B is P [unit: kV], and the peak to peak amplitude of the cyclic fluctuation component thereof is Pr [unit: kV].

In the present invention, “the “inter-ion generating electrode potential difference” in a static eliminating unit and the inter-ion generating electrode potential difference” in the other static eliminating units are potential differences that are opposite in polarity to each other” means that the polarity of the inter-ion generating electrode potential difference in a static eliminating unit and the polarity of the inter-ion generating electrode potential difference in the other static eliminating units are opposite in polarity to each other.

In the present invention, the “predetermined common potential” means a potential that serves as a reference for a power supply line connected from a high-voltage power supply to each ion generating electrode, and that is defined commonly for each static eliminating unit. Generally, the potential of the ground in the vicinity of the static eliminator or a frame of a facility of producing sheet or the like is considered to be the ground point, and this potential is set as 0 [unit: V], and as a predetermined common potential. In the case where the reference potential has a potential other than 0 [unit: V], this potential is referred to as “predetermined common potential”.

In the present invention, the “charge pattern” means a state where at least a site of an insulating sheet is locally positively and/or negatively charged.

In the present invention, the “apparent charge density” means the sum of the local charge densities in both surfaces of the insulating sheet at the same site in the in-plane directions of the insulating sheet. The local charge density means a charge density measured in an area of 6 mm or less in diameter, and more preferably, 2 mm or less in diameter, on a surface of the insulating sheet.

In the invention, “being apparently non-charged” means a state where the apparent charge densities at respective sites in the in-plane direction of an insulating sheet are substantially zero (not less than −2 μC/m² and not more than 2 μC/m²).

In the invention, the “rear side equilibrium potential” of the first surface of an insulating sheet means the potential of the first surface measured when the measuring probe of a electrostatic voltmeter is sufficiently kept as close as keeping a clearance of about 0.5 to about 2 mm to the first surface in such a condition that a grounded conductor is kept in contact with the second surface to induce the charges in the grounded conductor to ensure that the potential of the second surface may be substantially kept at zero. The measuring probe of the electrostatic voltmeter has as small as less than 2 mm in the diameter of the opening for measurement. The probe can be, for example, probe 1017 (opening diameter 1.75 mm) or 1017EH (opening diameter 0.5 mm) produced by Monroe Electronics, Inc. In the invention, “keeping the rear surface (second surface) of the insulating sheet in contact with a ground electrically conductive component” means that both of them are kept in tight contact with each other in such a state that there is no clear air layer between the insulating sheet and the metallic roll. This state means that the thickness of the air layer remaining between both of them is 20% or less of the thickness of the sheet and 10 μm or less.

To obtain the distribution of the rear side equilibrium potential in the first surface, either the probe of the electrostatic voltmeter or the sheet having the ground conductive component kept in contact with its rear surface (second surface) is made to travel at a low speed (about 5 mm/sec) using a moving means capable of being adjusted in position such as an XY stage, to measure the rear side equilibrium potential one after another, and the obtained data are one-dimensionally or two-dimensionally mapped. The rear side equilibrium potential of the second surface can also be measured similarly.

In the present invention, the “aerial potential” of an insulating sheet means a potential measured in a state where the insulating sheet is floating in the air. Since the thickness of the sheet is sufficiently small in relation to the distance between the sheet and the grounded earth, this potential becomes an potential for the ground point, of the sum of the charges of the first surface and the charges of the second surface of the insulating sheet. In the present invention, the predetermined common potential for the various potentials, is considered to be the ground point, that is, 0 [unit: V], unless otherwise mentioned.

In the present invention, the “normal direction inter-electrode distance d₁₋ₘ” of the mth static eliminating unit means, as shown in FIG. 6A, the distance in the direction normal of the sheet between the pointed end of the first ion generating electrode 5dₘ in the first electrode unit EUdₘ and the pointed end of the second ion generating electrode 5fₘ in the second electrode unit EUfₘ of the mth static eliminating unit SUₘ from upstream in the traveling direction of the sheet. In the case where the expression “mth static eliminating unit” is merely used, the static eliminating unit refers to the static eliminating unit in the mth place (m=1, 2, . . . , n) counted from upstream in the traveling direction of the sheet.

In the present invention, the “static eliminating unit interval d₂₋ₚ” between the pth static eliminating unit and the p+1th static eliminating unit, as shown in FIG. 6B, means an interval in the traveling direction of the sheet between the midpoint 5xₚ of a line segment connecting the pointed end of the first ion generating electrode 5dₚ and the pointed end of the second ion generating electrode 5fₚ of the pth static eliminating unit SUₚ, and the midpoint 5xₚ₊₁ of a line segment connecting the pointed end of the first ion generating electrode 5dₚ₊₁ and the pointed end of the second ion generating electrode 5fₚ₊₁ of the p+1th static eliminating unit SUₚ₊₁.

In the present invention, the “widthwise dimension Wₘ” of the mth static eliminating unit means, in the case where the first electrode unit EUdₘ of the mth static eliminating unit has a first shield electrode 5gₘ and the second electrode unit EUfₘ thereof has a second shield electrode 5hₘ, the distance in the traveling direction of the sheet between the most upstream point and the most downstream point in the traveling direction of the sheet, of a projected image obtained by projecting all of the first and second ion generating electrodes 5dₘ, 5fₘ and the first and second shield electrodes 5gₘ, 5hₘ forming the first electrode unit EUdₘ and the second electrode unit EUfₘ of the mth static eliminating unit SUₘ, perpendicularly onto the virtual mean plane, as shown in FIG. 6C.

In the present invention, the “electrode discrepancy d₀₋ₘ” of a static eliminating unit, as shown in FIG. 6F, means an interval in the traveling direction of the sheet between the pointed end of the first ion generating electrode 5dₘ and its facing pointed end of the second ion generating electrode 5fₘ in the mth static eliminating unit.

In the present invention, the “direct-current power supply” means a power supply whose output voltage maintains the same polarity for one second or longer without reversing in polarity with respect to the ground point or a predetermined common potential, and which has a ripple factor of 20% or less. The polarity is maintained so as not to reverse, preferably for 20 seconds or longer, and more preferably, during one time of static elimination operation for one sheet. The one time of static elimination operation for one sheet means, for example, a static elimination operation from the beginning to the end of conveyance of one sheet roll. However, a reversal in polarity due to a non-cyclic noise component, such as white noise or the like, is not considered to be the reversal in polarity herein. A direct-current component at a certain moment of the aforementioned direct-current power supply is defined as a mean value of the voltages in the previous one second from that moment.

The direct-current voltage whose “ripple factor” is x % means a direct-current voltage that satisfies the expression Vr/V=x/100 where V [unit: kV] is the direct-current component of voltage, and Vr [unit: kV] is the peak to peak amplitude of a cyclic fluctuation component thereof.

The “ion clouds that do not temporally change in polarity” means ion clouds that continuously maintained the same polarity for one second or longer without a reversal in polarity. Such clouds are also called direct-current-fashion ion clouds. Incidentally, the polarity of ion clouds are usually maintained so as not to reverse, preferably for 20 seconds or longer, and more preferably, during one time of static elimination operation for one sheet.

In the present invention, “voltage being supplied from a single power supply” means that voltage is supplied from a single output terminal of a power supply device to ion generating electrodes or the like, through a conductor line that involves a potential fall to a degree that substantially does not affect the amount of ions generated from the ion generating electrodes.

### EFFECTS OF THE INVENTION

According to the present invention, insulating sheet surfaces in a charged state in which positive and negative charges mingle on the one and other side of the sheet are brought to a state being apparently non-charged in a wide range of the sheet traveling speed, and the charges on each surface of the sheet are uniformly reduced without unevenness in the traveling direction of the sheet. Therefore, occurrence of drawbacks in later processing steps, such as a failure in the metallization onto the sheet, a paint-specks in a coating process, etc., can be restrained.

### BRIEF DESCRIPTION OF THE DRAWINGS

FIG. 1 is a schematic front view drawing of an example of the conventional static eliminator.

FIG. 2 is a schematic front view drawing of another example of the conventional static eliminator.

FIG. 3 is a schematic front view drawing of still another example of the conventional static eliminator.

FIG. 4 is a schematic front view drawing of a further example of the conventional static eliminator.

FIG. 5 is a schematic front view drawing of an embodiment of the static eliminator of the present invention.

FIG. 6A is a schematic front view drawing showing an example of static eliminating units used in the static eliminator of the present invention, and showing a positional relationship between a first electrode unit and a second electrode unit in the static eliminating unit.

FIG. 6B is a schematic front view illustration showing another positional relationship between the first electrode unit and the second electrode unit in the static eliminating unit shown in FIG. 6A, and a positional relationship between adjacent two static-eliminating units.

FIG. 6C is a schematic front view illustration showing still another positional relationship between the first electrode unit and the second electrode unit in the static eliminating unit shown in FIG. 6A.

FIG. 6D is a schematic front view drawing showing another example of the static eliminating units used in the static eliminator of the present invention, and showing a positional relationship between the first electrode unit and the second electrode unit in the static eliminating unit.

FIG. 6E is a schematic front view drawing showing still another positional relationship between the first electrode unit and the second electrode unit in the static eliminating unit shown in FIG. 6A.

FIG. 6F is a schematic front view drawing showing another example of the static eliminating units used in the static eliminator of the present invention, and showing a positional relationship between the first electrode unit and the second electrode unit in the static eliminating unit.

FIG. 6G is a schematic side view drawing showing an array of needle electrodes in the width direction of an example of the first electrode unit or the second electrode unit in another example of the static eliminating units used in the static eliminator of the present invention.

FIG. 7 is a graphs showing the state of applied voltage to ion generating electrodes of an example of the static eliminator of the present invention.

FIG. 8 is a schematic front view drawing of another embodiment of the static eliminator of the present invention.

FIG. 9 is a schematic front view drawing of still another embodiment of the static eliminator of the present invention

FIG. 10 is a plane view drawing schematically showing the situation of charges of a charged insulating sheet (raw film A-1, and raw film A-2) used for static elimination in the examples.

FIG. 11 is a graph showing the distribution of rear side equilibrium potential of a raw film A-1 used for static elimination in the examples.

FIG. 12A is a schematic perspective view drawing of an example of the electrode units used in the static eliminator of the present invention.

FIG. 12B is a schematic perspective view drawing of another example of the electrode units used in the static eliminator of the present invention.

FIG. 13 is a schematic front view drawing of an example of the conventional static eliminator.

FIG. 14 is a schematic perspective view drawing of an electrode unit used in the conventional static eliminator of FIG. 13.

FIG. 15 is a schematic front view drawing of a further embodiment of the static eliminator of the present invention.

FIG. 16 is a graph showing a relationship among the amount of ion attachment, the output current and the static eliminating unit interval in an example of the case where a sheet is static-eliminated through the use of the static eliminator of the present invention.

FIG. 17A is a graph showing an example of the results of measurement of the amount of ion attachment in the case where the ion generating electrode exposed type electrode units are used in the static eliminator of the present invention.

FIG. 17B is a graph showing an example of the results of measurement of the output current in the case where the ion generating electrode exposed type electrode units are used in the static eliminator of the present invention.

FIG. 18A is a graph showing an example of the results of measurement of the amount of ion attachment in the case where electrode units that are not the ion generating electrode exposed type electrode units are used in the static eliminator of the present invention.

FIG. 18B is a graph showing an example of the results of measurement of the output current in the case where electrode units that are not the ion generating electrode exposed type electrode units are used in the static eliminator of the present invention.

FIG. 19A is a graph showing an example of the state of applied voltage to ion generating electrodes in the static eliminator of the present invention.

FIG. 19B is a graph showing an example of the state of the inter-ion generating electrode potential difference between ion generating electrodes disposed facing each other in the static eliminator of the present invention.

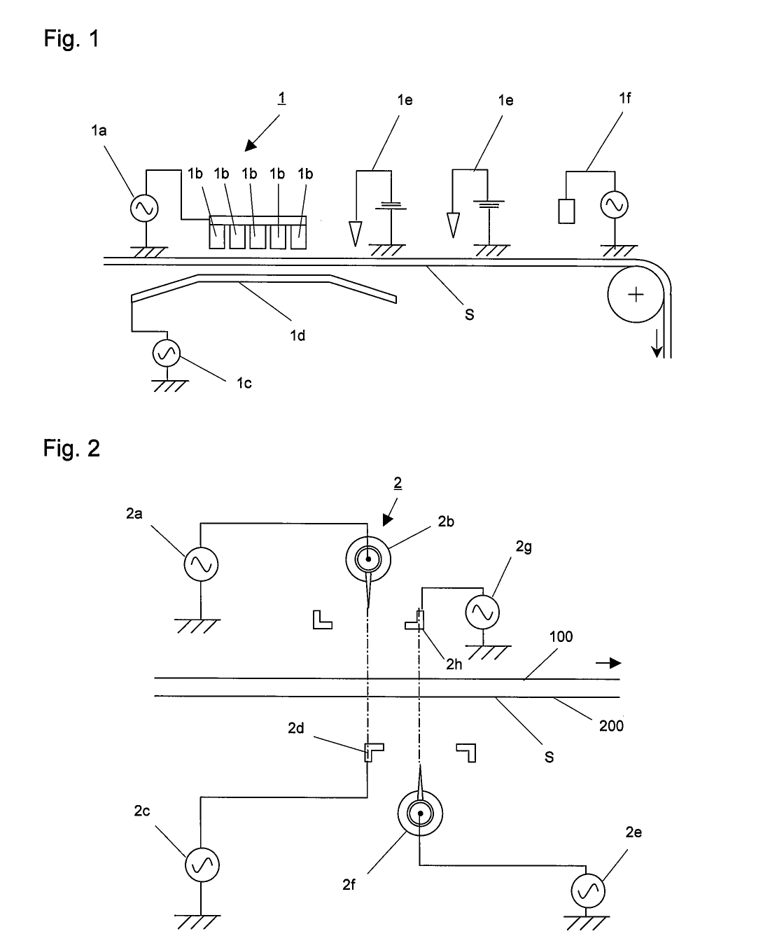

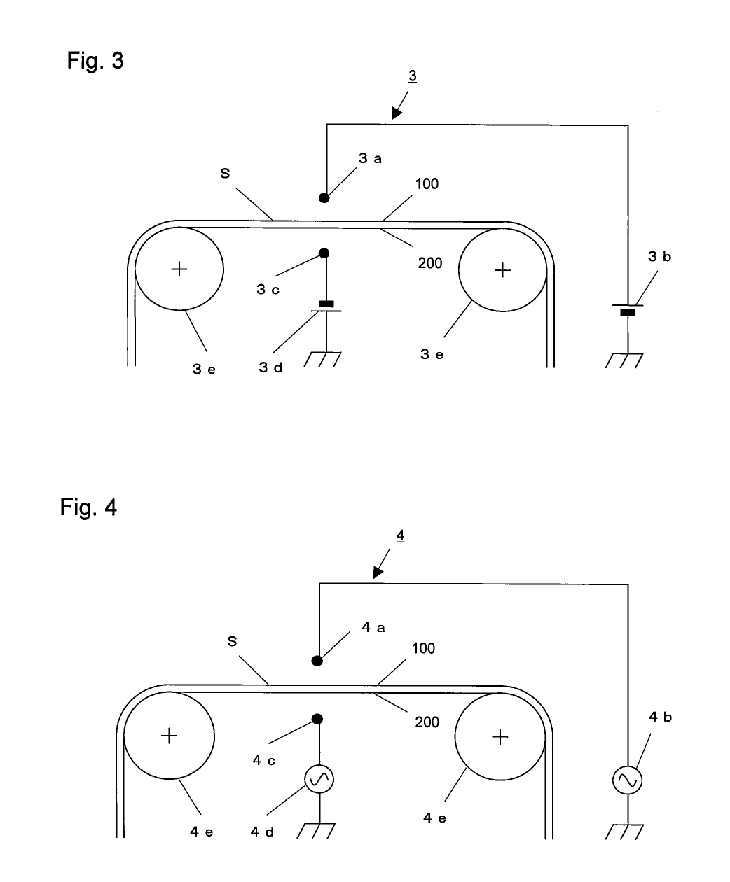

### DESCRIPTION OF SYMBOLS IN DRAWINGS

1: static eliminator
1a: alternating-current power supply
1b: ion generating electrode
1c: alternating-current power supply
1d: ion-attracting electrode
1e: direct-current static eliminating member
1f: alternating-current static eliminating member
S: insulating sheet
2: static eliminator
2a: alternating-current power supply
2b: electrode for generating ion
2c: alternating-current power supply (opposite in phase to the alternating-current power supply 2a)
2d: electrode for accelerating ion
2e: alternating-current power supply
2f: ion generating electrode
2g: alternating-current power supply (opposite in phase to the alternating-current power supply 2e)
2h: electrode for accelerating ion
100: first surface of the insulating sheet
200: second surface of the insulating sheet
3: static eliminator
3a: ion generating electrode
3b: direct-current power supply
3c: ion generating electrode
3d: direct-current power supply (opposite in polarity to the direct-current power supply 3b)
3e: guide roll
4: static eliminator
4a: ion generating electrode
4b: alternating-current power supply
4c: ion generating electrode
4d: alternating-current power supply (opposite in phase to the alternating-current power supply 4b)
4e: guide roll
5: static eliminator
5a: guide roll
5b: guide roll
5ab: traveling direction of sheet
5c: direct-current power supply
5e: direct-current power supply (opposite in polarity to the direct-current power supply 5c)
5d₁: first ion generating electrode of the first static eliminating unit in the traveling direction of the sheet
5f₁: second ion generating electrode of the first static eliminating unit in the traveling direction of the sheet
5d₂: first ion generating electrode of the second static eliminating unit in the traveling direction of the sheet
5f₂: second ion generating electrode of the second static eliminating unit in the traveling direction of the sheet
5dₘ: first ion generating electrode of the mth static eliminating unit in the traveling direction of the sheet
5fₘ: second ion generating electrode of the mth static eliminating unit in the traveling direction of the sheet
5gₘ: first shield electrode of the mth static eliminating unit in the traveling direction of the sheet
5hₘ: second shield electrode of the mth static eliminating unit in the traveling direction of the sheet
5dₚ: first ion generating electrode of the pth static eliminating unit in the traveling direction of the sheet
5fₚ: second ion generating electrode of the pth static eliminating unit in the traveling direction of the sheet
5gₚ: first shield electrode of the pth static eliminating unit in the traveling direction of the sheet
5hₚ: second shield electrode of the pth static eliminating unit in the traveling direction of the sheet
5i: first alternating-current ion generating electrode
5j: second alternating-current ion generating electrode
5k: alternating-current power supply
5l: alternating-current power supply (opposite in phase to the alternating-current power supply 5k)
5m: potential measurement means (electrostatic voltmeter)
5n: control means of the inter-ion generating electrode potential difference
5xₚ: midpoint of a line segment connecting the pointed end of the first ion generating electrode and the pointed end of the second ion generating electrode of the pth static eliminating unit in the traveling direction of the sheet
5xₚ₊₁: midpoint of a line segment connecting the pointed end of the first ion generating electrode and the pointed end of the second ion generating electrode of the p+1th static eliminating unit in the traveling direction of the sheet
6: static eliminator
6a: guide roll
6b: guide roll
6ab: traveling direction of the sheet
6c: alternating-current power supply
6e: alternating-current power supply (opposite in phase to the alternating-current power supply 6c)
7: electrode unit
7a: needle electrode array
7b: shield electrode
7d: insulating component
8A: ion generating electrode exposed type electrode unit
8B: electrode unit that is not the ion generating electrode exposed type electrode unit
8a: needle electrode array
8a₁: one of partial electrodes constituting the needle electrode array
8a₂: one of partial electrodes constituting the needle electrode array
8b: shield electrode
8d: insulating component
8e: insulating component
8aL: bent line connecting needle pinpoints provided at predetermined intervals in the width direction of the sheet
d₅: intervals of the needle electrode array in the width direction of the sheet [unit: mm]
Wₘ: widthwise dimension of the mth static eliminating unit in the traveling direction of the sheet [unit: mm]
SOgₘ: opening width of the first shield electrode of the mth static eliminating unit in the traveling direction of the sheet [unit: mm]

SOhₘ: opening width of the second shield electrode of the mth static eliminating unit in the traveling direction of the sheet s [unit: mm]

d₀₋ₘ: electrode discrepancy in the mth static eliminating unit in the traveling direction of the sheet [unit: mm]

d₀₋₆: electrode discrepancy in the 6th static eliminating unit in the traveling direction of the sheet [unit: mm]

d₁₋ₘ: normal direction inter-electrode distance of the mth static eliminating unit in the traveling direction of the sheet [unit: mm]

d₂₋ₚ: static eliminating unit interval between the pth static eliminating unit and the p+1th static eliminating unit in the traveling direction of the sheet [unit: mm]

SU₁: 1st static eliminating unit in the traveling direction of the sheet

SU₇: 7th static eliminating unit in the traveling direction of the sheet

SU₈: 8th static eliminating unit in the traveling direction of the sheet

SUₚ: pth static eliminating unit in the traveling direction of the sheet

SUₚ₊₁: p+1th static eliminating unit in the traveling direction of the sheet

SUₘ: mth static eliminating unit in the traveling direction of the sheet

SUₙ: nth (most downstream) static eliminating unit in the traveling direction of the sheet

EUd₁: first electrode unit of the 1st static eliminating unit in the traveling direction of the sheet

EUdₚ: first electrode unit of the pth static eliminating unit in the traveling direction of the sheet

EUdₚ₊₁: first electrode unit of the p+1th static eliminating unit in the traveling direction of the sheet

EUdₘ: first electrode unit of the mth static eliminating unit in the traveling direction of the sheet

EUdₙ: first electrode unit of the nth (most downstream) static eliminating unit in the traveling direction of the sheet

EUf₁: second electrode unit of the 1st static eliminating unit in the traveling direction of the sheet

EUfₚ: second electrode unit of the pth static eliminating unit in the traveling direction of the sheet

EUfₚ₊₁: second electrode unit of the p+1th static eliminating unit in the traveling direction of the sheet

EUfₘ: second electrode unit of the mth static eliminating unit in the traveling direction of the sheet

EUfₙ: second electrode unit of the nth (most downstream) static eliminating unit in the traveling direction of the sheet

V: direct-current applied voltage to the ion generating electrodes [unit: kV]

ΔV: difference between the first ion generating electrode potential and the second ion generating electrode potential in a static eliminating unit [unit: kV]

t: time [unit: sec]

V₁₋ₘ: temporal mean value of the direct-current voltage applied to the first ion generating electrode in the mth static eliminating unit [unit: kV]

V₂₋ₘ: temporal mean value of the direct-current voltage applied to the second ion generating electrode in the mth static eliminating unit [unit: kV]

xₘ: mean ripple factor of the ripple factor x₁₋ₘ of the direct-current voltage applied to the first ion generating electrode and the ripple factor x₂₋ₘ of the direct-current voltage applied to the second ion generating electrode in the mth static eliminating unit [unit: %]

yₘ: ripple factor of the inter-ion generating electrode potential difference in the mth static eliminating unit [unit: %]

A-A′: the centerline of the cyclically charged portions

MD: the traveling direction of the sheet

TD: the width direction of the sheet

V_{f}: waveform of rear side equilibrium potential

I: output current value from a high-voltage power supply [unit: mA]

Q: charge density of ions that attach to a surface of film that travels at 100 m/min [unit: μC/m²]

d₂₀: static eliminating unit interval [unit: mm]

SP: measured data of rear side equilibrium potential

I: measured data of output current value from the high-voltage power supply

### BEST MODES FOR CARRYING OUT THE INVENTION

Embodiments of the static eliminator for an insulating sheet of the present invention will be described hereinafter with reference to the drawings. Description will be made with regard to a case where a plastic film (hereinafter, simply referred to as “film”) is used as an insulating sheet. However, the present invention is not limited to these examples.

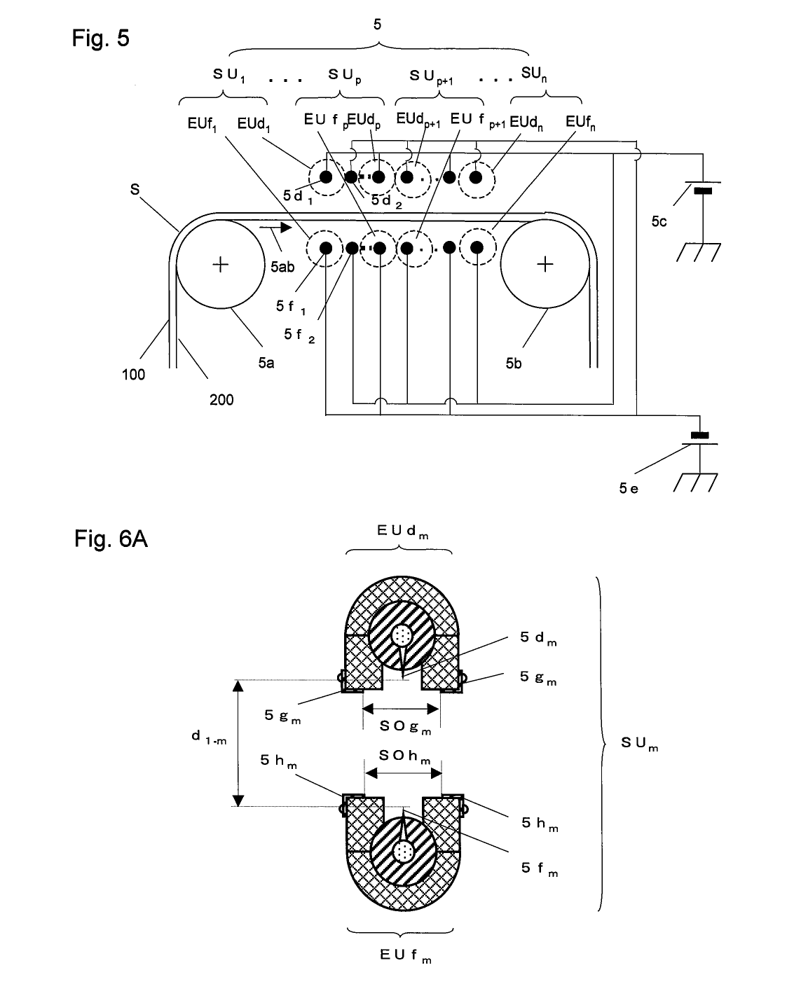

FIG. 5 is an elevation schematic drawing of an embodiment of the static eliminator of the present invention. This static eliminator 5 is preferably used for eliminating charges from a film. In FIG. 5, a traveling film S is placed over a guide roll 5a and a guide roll 5b. The guide roll 5a and the guide roll 5b are each rotated clockwise by respective motors (not shown in the drawing). The film S continuously moves, due to rotation of the guide rolls 5a, 5b, at speed u [in mm/sec] in the direction of an arrow 5ab. Between the guide roll 5a and the guide roll 5b, n number (where n is an integer of 2 or greater) static eliminating units SU₁, . . . , SUₙ are installed at intervals left therebetween in the traveling direction of the film S (direction of the arrow 5ab). These static eliminating units SU₁, . . . , SUₙ constitute the static eliminator 5.

The 1st static eliminating unit SU₁ comprises a first electrode unit EUd₁ and a second electrode unit EUf₁. The first electrode unit EUd₁ faces a first surface 100 of the film S, and is provided at an interval from the first surface 100. The second electrode unit EUf₁ faces a second surface 200 of the film S, and is provided at an interval from the second surface 200. The first electrode unit EUd₁ and the second electrode unit EUf₁ face each other across the film S.

In the 1st static eliminating unit SU₁, a first ion generating electrode 5d₁ is connected to a first direct-current power supply 5c, and a second ion generating electrode 5f₁ is connected to a second direct-current power supply 5e. The first direct-current power supply 5c and the second direct-current power supply 5e have potentials that are opposite in polarity to each other. Therefore, the first ion generating electrode 5d₁ and the second ion generating electrode 5f₁ are connected to direct-current power supplies that output voltages that are opposite in polarity to each other.

In the 2nd static eliminating unit SU₂, a first ion generating electrode 5d₂ is connected to the second direct-current power supply 5e, and a second ion generating electrode 5f₂ is connected to the first direct-current power supply 5c. Therefore, the first ion generating electrode 5d₂ and the second ion generating electrode 5f₂ are connected to direct-current power supplies that output voltages that are opposite in polarity to each other, and the first ion generating electrode 5d₁ in the 1st static eliminating unit SU₁ and the first ion generating electrode 5d₂ in the 2nd static eliminating unit SU₂ are connected to direct-current power supplies that output voltages that are opposite in polarity to each other, and the second ion generating electrode 5f₁ in the 1st static eliminating unit SU₁ and the second ion generating electrode 5f₂ in the 2nd static eliminating unit SU₂ are connected to direct-current power supplies that output voltages that are opposite in polarity to each other.

Where m is an integer of 1 or greater to n or less, the mth static eliminating unit SUₘ, similar to the 1st static eliminating unit SU₁, comprise a first electrode unit EUdₘ that faces the first surface 100 of the film S, and a second electrode unit EUfₘ that faces the second surface 200 of the film S. The first electrode unit EUdₘ and the second electrode unit EUfₘ are provided at intervals from the film S, and face each other across the film S. The first electrode unit EUdₘ has a first ion generating electrode 5dₘ, and the second electrode unit EUfₘ has a second ion generating electrode 5fₘ.

In each static eliminating unit SUₘ, the first ion generating electrode 5dₘ and the second ion generating electrode 5fₘ are connected to direct-current power supplies that output voltages that are opposite in polarity to each other. As for the adjacent pth and p+1th static eliminating units (where p is an integer of 1 or greater to n−1 or less), the first ion generating electrode 5dₚ in the pth static eliminating unit SUₚ and the first ion generating electrode 5dₚ₊₁ in the p+1th static eliminating unit SUₚ₊₁ are connected to direct-current power supplies that output voltages that are opposite in polarity to each other. The second ion generating electrode 5fₚ in the pth static eliminating unit SUₚ and the second ion generating electrode 5fₚ₊₁ in the p+1th static eliminating unit SUₚ₊₁ are connected to direct-current power supplies that output voltages that are opposite in polarity to each other.

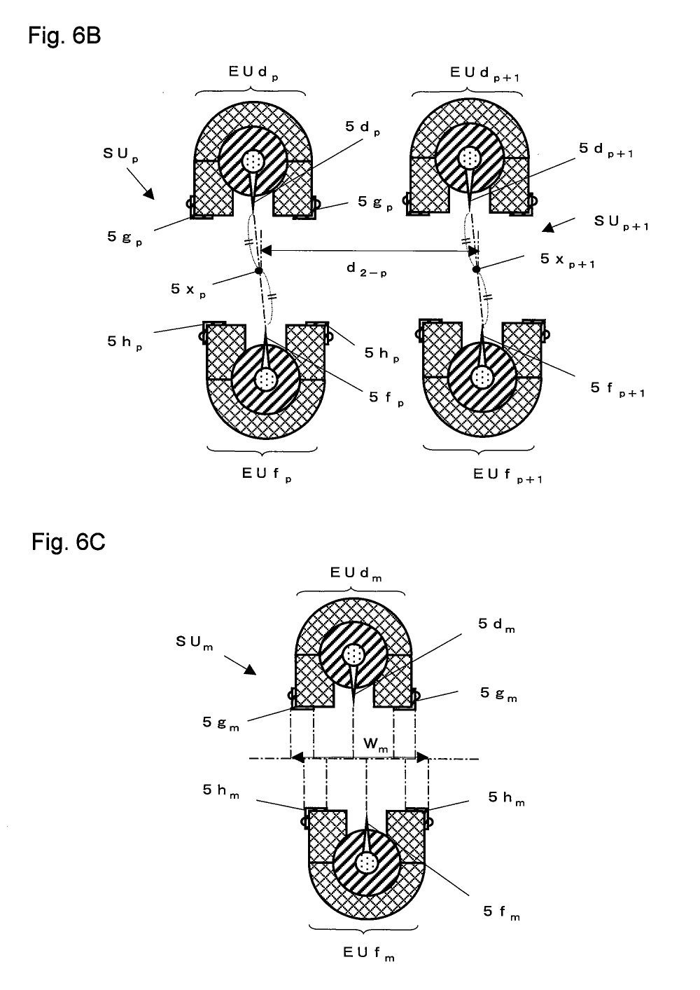

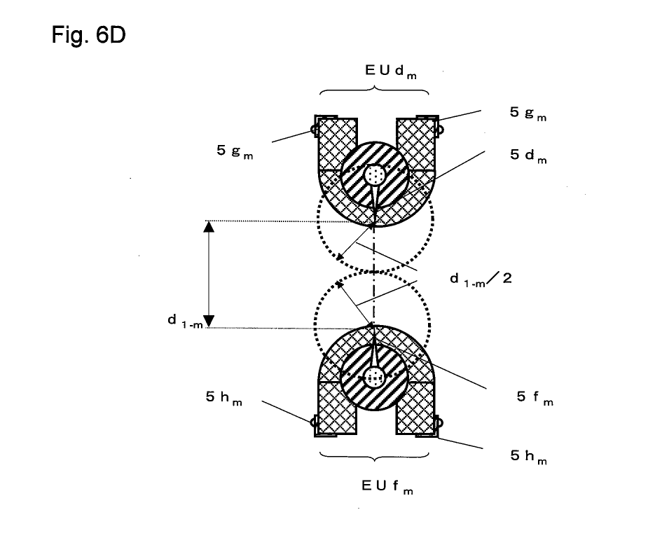

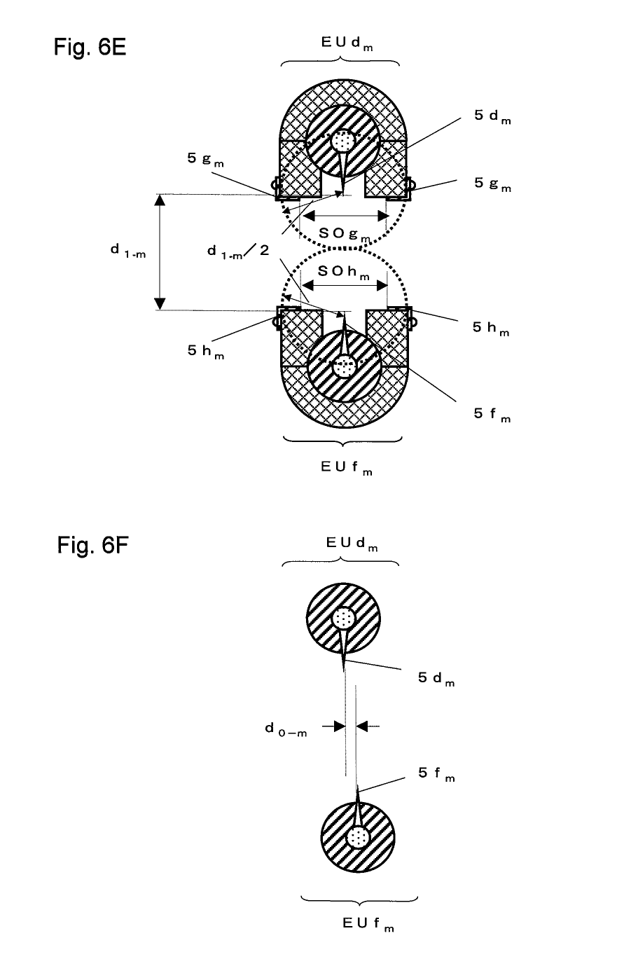

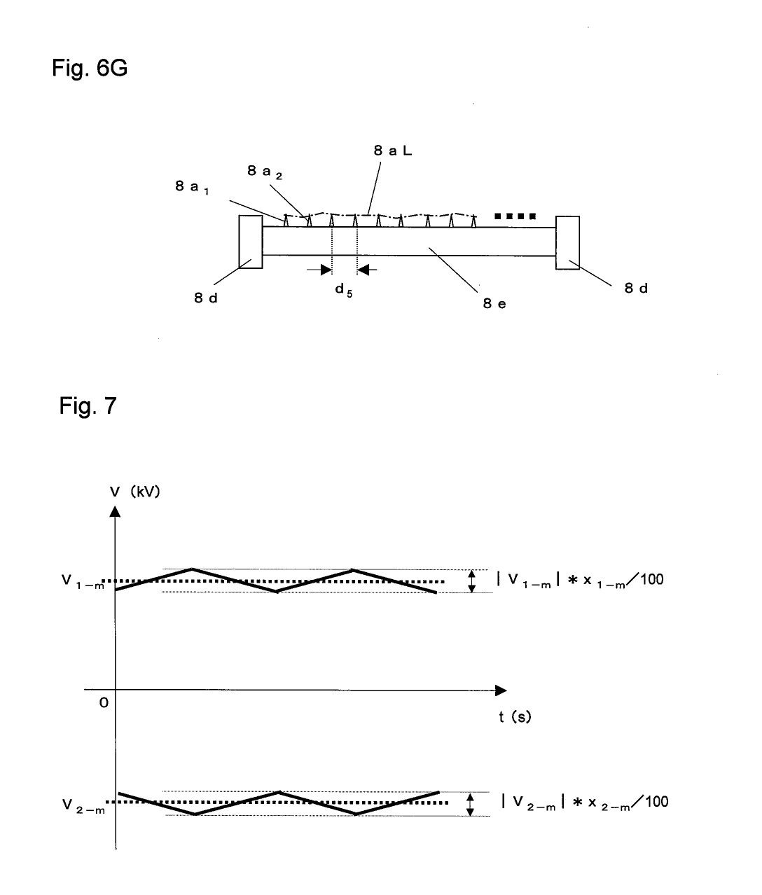

An example of the construction of the static eliminating unit SUₘ (where m is an integer of 1 or greater to n or less) in the static eliminator 5 will be described with reference to FIG. 6A. In FIG. 6A, the first electrode unit EUdₘ has a first ion generating electrode 5dₘ, and a first shield electrode 5gₘ that has an opening portion SOgₘ for the first ion generating electrode 5dₘ. The second electrode unit EUfₘ has a second ion generating electrode 5fₘ, and a second shield electrode 5hₘ that has an opening portion SOhₘ for the second ion generating electrode 5fₘ.

The opening portion SOgₘ of the first shield electrode 5gₘ is open in the vicinity of a pointed end of the first ion generating electrode 5dₘ, toward the film S. The opening portion SOhₘ of the second shield electrode 5hₘ is open in the vicinity of a pointed end of the second ion generating electrode 5fₘ, toward the film S. The first and second shield electrodes 5gₘ, 5hₘ are provided so as to have a function of helping the discharge from the first and second ion generating electrodes 5dₘ, 5fₘ, respectively, when given an appropriate potential difference with respect to the ion generating electrodes 5dₘ, 5fₘ. The first ion generating electrode 5dₘ and the second ion generating electrode 5fₘ face each other across the film S.

In order to irradiate positive and negative ions in a forced fashion simultaneously to both surfaces of the film, it is preferable to give a potential difference between the first and second ion generating electrodes so that the mean electric field strength |Vₘ|/d₁₋ₘ between the first and second ion generating electrodes becomes greater than 0.26. Herein, d₁₋ₘ [unit: mm] is the normal direction inter-electrode distance, and Vₘ [unit: kV] is the temporal mean value of the inter-ion generating electrode potential difference. This is because if the mean electric field strength between the first and second ion generating electrodes is equal to or greater than the aforementioned value, forcible irradiation of ions to the film S occurs. This phenomenon has been recognized by the present inventors from the knowledge of an increase in the discharge current.

That is, it has been discovered by the present inventors that when the mean electric field strength between the first and second ion generating electrodes is 0.26 or greater, the discharge current increases in comparison with a state where the two ion generating electrode 5dₘ, 5fₘ do not face each other, that is, a case where each electrode is used singly, and that this current increase can be an index of forcible irradiation of ions to the film S.

Furthermore, with regard to the static eliminating unit SUₘ having a construction in which the first electrode unit EUdₘ and the second electrode unit EUfₘ disposed facing each other, it has been recognized that, by using, as the first electrode unit and the second electrode unit, electrode units EUdₘ, EUfₘ of an ion generating electrode exposed type electrode units, as shown in FIG. 6D, FIG. 6F in which the shield electrodes 5gₘ, 5hₘ are not disposed in the vicinities of the ion generating electrodes 5dₘ, 5fₘ, the amount of ions that attach to the surfaces of the film S can be increased in comparison with the case of using the electrode units EUdₘ, EUfₘ as shown in FIG. 6E in which the shield electrodes 5gₘ, 5hₘ are disposed in the vicinities of the ion generating electrodes 5dₘ, 5fₘ.

Reasons for this are as follows. In static eliminators for films currently used in the field of industry, arrangement of two electrode units facing each other across a film S as in the present invention is not provided, but electrode units are individually used one at a time. In this case, shield electrodes are considered essential since, as shown in FIG. 6E, the shield electrode 5gₘ and the shield electrode 5hₘ are disposed in the vicinities of the pointed ends of the ion generating electrode 5dₘ and the ion generating electrode 5fₘ, respectively, and are connected to the earth so that a stable potential difference is given between the shield electrode 5gₘ and the ion generating electrode 5dₘ or between the shield electrode 5gₘ and the ion generating electrode 5fₘ to generate ions. It has been considered that without the shield electrodes, the apparatus does not withstand practical use; for example, the discharge becomes unstable, and so on.

However, according to the knowledge of the present inventors, it has turned out that in the present invention in which the first electrode unit EUdₘ and the second electrode unit EUfₘ are disposed facing each other, voltages opposite in polarity to each other are applied to the first ion generating electrode 5dₘ and the second ion generating electrode 5fₘ, with reference to a “predetermined common potential”, as described below, and therefore, a stable inter-ion generating electrode potential difference is obtained between the ion generating electrode 5dₘ and the ion generating electrode 5fₘ, and shield electrodes can be done without.

If electrode units each having a shield electrode are disposed facing each other as shown in FIG. 6E, a stable potential difference is obtained between the first shield electrode 5gₘ and the first ion generating electrode 5dₘ, and between the second shield electrode 5hₘ and the second ion generating electrode 5fₘ, as previously described. Therefore, electrode units having a shield electrode may be used. In this case, however, the ions generated from the first and second ion generating electrodes are roughly grouped into an amount that attach to the surfaces of the film S, and an amount that leaks to the earth or the like via the shield electrodes. The latter cannot contribute to static elimination from surfaces of the film S.

In other words, useless ions are generated in great amounts. Therefore, with regard to the output current to be supplied from the power supply to each ion generating electrode, there is a need to supply an current that corresponds to both the former and the latter, and a power supply with a large capacity becomes needed. Hence, in order to eliminate the ions that are uselessly generated and cause most of the ions generated from the ion generating electrodes to attach to the surfaces of the film S and efficiently contribute to static elimination from the surfaces of the film S with a small output current, a form in which the first and second electrode units are the ion generating electrode exposed type electrode units, and the first ion generating electrode and the second ion generating electrode are disposed facing each other across the film S is further preferred. As a result, a power supply with a small output current capacity suffices.

In this manner, the amount of ions that can be irradiated to each surface of the film S reaches about 30 to 150 μC/m² in absolute value. This makes it possible to bring about a considerable reduction of the charges in each surface of the film S which cannot be achieved by the technologies disclosed in Patent Document 1 or Patent Document 2.

Besides the above-described method in which a direct-current inter-ion generating electrode potential difference is given between the first and second ion generating electrodes by applying a direct-current voltage, the present inventors have considered a method in which pair of positive and negative ion cloud pair that changes in a time-series fashion are irradiated to a film by applying alternating-current voltages of opposite polarities are applied to the first ion generating electrodes 5d₁ to 5dₙ of the static elimination units, and to the second ion generating electrodes 5f₁ to 5fₙ of the static elimination units, that is, by giving an alternating-current inter-ion generating electrode potential difference between the first and second ion generating electrodes in each static elimination unit.

However, in the case where alternating-current voltages are applied, too, it has been recognized that if only one static eliminating unit is provided, each site of the film S, traveling at a high speed, merely undergo irradiation of each surface of the film S with ions of a corresponding one of the polarities cyclically in the traveling direction of the film S, and the mingled positive and negative charges cannot be eliminated, as stated above about Patent Document 3 and Patent Document 4. Therefore, in the case where alternating-current voltages are applied, too, two or more static eliminating units are needed.

Furthermore, in the case where the number of static eliminating units is two, or in the case where the three or more static eliminating units are disposed at equal intervals, a phenomenon in which the static eliminating ability declines occurs at a specific traveling speed of the film S, as described below.

That is, in the case where the alternating-current voltages applied to the first ion generating electrodes 5d₁ to 5dₙ of the static eliminating units are the same in phase, a state in which sites on the film S where ions of the positive polarity are irradiated to the first surface of the film S (ions of the negative polarity are irradiated to the second surface of the film S) from all the static eliminating units, and sites thereon where ions of the negative polarity are irradiated to the first surface of the film S (ions of the positive polarity are irradiated to the second surface of the film S) from all the static eliminating units cyclically occur is produced at a specific traveling speed. This state is termed synchronous superimposed state.

Where the frequency of the alternating-current voltage applied is f [unit: Hz] and all the static eliminating unit intervals d₂₋₁ to d₂₋₍ₙ₋₁) are d₂₀ [unit: mm], the state is produced at a traveling speed uₐ [unit: mm/sec] if the traveling speed u satisfies the relationship of the expression auₐ=d₂₀·f (where a is a natural number).

In the synchronous superimposed state, the following two problems sometimes occur.

Problem 1: Since ion irradiation is biased to one polarity at respective sites on the film S, it is difficult to eliminate charges whose polarity is the same as the biased polarity at respective sites on the film S.

Problem 2: Since the states of adherence of positive and negative ions from the respective static eliminating units onto the film S which cyclically occur in the traveling direction of the film S are superimposed on one another in such a fashion that the polarities from the static eliminating units are the same, the charges on the surfaces of the film S are increased. In this case, the charges on the surfaces of the film S are opposite in polarity, and therefore the film is in the “apparently non-charged” state.

Further, in the case where alternating-current voltages are applied, the amount of ions generated is zero or very small at or around the time point (arc extinction point) at which the voltage becomes zero. Therefore, at a speed u_{b} [unit: mm/sec] that satisfies expression bu_{b}=2d₂₀·f (where b is a natural number), the following problem occurs.

Problem 3: A site where the amount of ions irradiated from any one of the static eliminating units is small occurs on the film S.

The case where b is an even number means synchronous superimposition, and the aforementioned problem 1 and problem 2 occur in portions where the amount of ion irradiation is large, and the aforementioned problem 3 occurs in portions where the amount of ion irradiation is small. The case where b is an odd number means a state that can be said to be anti-synchronous superimposition, and the aforementioned problem 1 and problem 2 do not occur. However, on the film S, portions where the amount of irradiation is large with regard to both positive ions and negative ions, and portions where the amount of irradiation is small with regard to both positive ions and negative ions, which are referred to the aforementioned problem 3, occur in the cycle of u_{b}/2f [unit: mm] in the traveling direction of the film S. The portions where the amount of irradiation is large with regard to both positive ions and negative ions get high static eliminating ability, and therefore have no problem. On the other hand, the portions where the amount of irradiation is small with regard to both positive ions and negative ions suffer from low static eliminating ability. If static elimination is performed by a static eliminator as mentioned above, the static eliminating ability of the entire apparatus is limited by portions of low static eliminating ability which appear on the film S in the cycle of u_{b}/2f [unit: mm]. That is, the static eliminating ability of the entire apparatus becomes low.

In the case where a process in which the traveling speed of the film S is constant or limited within a narrow range is an object process to which the static eliminator is applied, it is possible to select a static eliminating unit interval d₂₀ and a frequency f of the applied voltage such that the range of traveling speed of the film S does not include the range of traveling speed of the film S where the aforementioned problems of synchronous superimposition and anti-synchronous superimposition occur. However, during such a process that includes the rewinding of the film S or the like, the traveling speed of the film S greatly changes from zero to high speed, for example, about several 100 m/min. In the case where such a process is an object process to which the static eliminator is applied, it sometimes becomes very difficult to select a static eliminating unit interval d₂₀ and a frequency f of the applied voltage such that the entire range of traveling speed does not include the range of traveling speed where the aforementioned problems of synchronous superimposition and anti-synchronous superimposition occur, if dimensions of the static eliminator within a practical range are considered.

Complete synchronous superimposition can be avoided by changing the phase or frequency of the applied alternating-current voltage for respective static eliminating units, or changing the static eliminating unit intervals d₂₋₁ to d₂₋₍ₙ₋₁₎, etc. However, according to the knowledge of the present inventors, even if a complete synchronous superimposition state is avoided, it is not easy to completely balance the amounts of irradiation of positive and negative ions (the number of times of irradiation) without depending on the traveling speed of the film S.

Thus, in the case where, during the process where the traveling speed of the film S greatly changes, an alternating-current inter-ion generating electrode potential difference is given between the first and second ion generating electrodes of the static eliminating units by applying alternating-current voltages of opposite polarities to the first and second ion generating electrodes, the aforementioned problems of synchronous superimposition and anti-synchronous superimposition will not be completely resolved.

Therefore, particularly during the process where the traveling speed of the film S greatly changes, it is important that a direct-current inter-ion generating electrode potential difference be given between the first ion generating electrode and the second ion generating electrode of each static eliminating unit. In the case where an alternating-current inter-ion generating electrode potential difference is given, a design change of the static eliminating unit intervals d₂₋₁ to d₂₋₍ₙ₋₁₎ in accordance with the traveling speed of the film S is necessary. On the other hand, in the case where a direct-current inter-ion generating electrode potential difference is given, the design change of the static eliminating unit intervals in accordance with the traveling speed of the film S becomes unnecessary. As a result, a particularly preferable advantage that an easy-to-use static eliminator can be easily obtained.

As methods for giving a direct-current inter-ion generating electrode potential difference between the first ion generating electrode and the second ion generating electrode, there are a method in which direct-current voltages equal in polarity and different in value with respect to the ground potential are applied to the first and second ion generating electrodes, and a method in which the potential of either the first or second ion generating electrodes is set at the ground potential and a direct-current voltage is applied only to the other ion generating electrode, besides the method in which direct-current voltage of opposite polarities with respect to the ground potential are applied to the first and second ion generating electrodes as in the mode described above. There is also a method in which voltages obtained by superimposing alternating-current voltages of the same phase on a direct-current voltage are applied.

However, in the case where direct-current voltages of the same polarity with respect to the ground potential are applied to the first and second ion generating electrodes, ions opposite in polarity to the applied voltage are generated at the ion generating electrodes at the side of the smaller absolute value of applied voltage. That is, the polarity of the applied voltage to ion generating electrodes and the polarity of the current that flows through the ion generating electrodes disaccord. Therefore, there arises a need to use a power supply called fourth quadrant type power supply or attraction type power supply (for example, AC/DC high-voltage amplifier MODEL 20/20B by TRek Incorporated, or the like).

A similar problem can also occur in the case where direct-current voltages with superimposition of alternating-current voltages of the same phase are applied to the first and second ion generating electrodes. Therefore, in this case, too, there is a need to select a power supply.

Furthermore, for example, in the case where a positive voltage with respect to a “predetermined common potential” (for example, 0 [unit: V]) is applied to the first ion generating electrodes and the second ion generating electrodes are earthed and have a potential of 0 [unit: V], it is also possible to attach ions of opposite polarities to the each surface of the film S, due to the potential difference between the first and second ion generating electrodes. Particularly in the case where certain potentials are given to all the ion generating electrodes when the “predetermined common potential” is 0 [unit: V], a potential difference occurs between the first or second ion generating electrodes of static eliminating units adjacent in the traveling direction of the film S, so that more ions can be attached to the each surface of the film S. This mode is more preferable.

In the case where a shield electrode is disposed in the vicinity of an ion generating electrode, ion generation will be restrained if the polarity of the potential difference between the ion generating electrodes facing each other, and the polarity of the potential difference between the ion generating electrode and the shield electrode disposed in the vicinity thereof are opposite in polarity to each other.

This is, for example, a case where the potential of the first ion generating electrode 5d₁ is +10 kV, and the potential of the second ion generating electrode 5f₁ is +20 kV, and the potential of the first and second shield electrodes 5g₁, 5h₁ is 0 kV. In this case, as for the second ion generating electrode, the potential difference with respect to the facing first ion generating electrode is +10 kV, and the potential difference with respect to the second shield electrode is +20 kV, thus according in polarity. However, as for the first ion generating electrode, the potential difference with respect to the facing second ion generating electrode is −10 kV, and the potential difference with respect to the first shield electrode is +10 kV, thus disaccording in polarity. Therefore, the generation of ions at the first ion generating electrode is restrained.

In this case, the positive ions irradiated from the first ion generating electrodes are, though only slightly, more than the negative ions irradiated from the second ion generating electrodes, so that the film as a whole may be positively charged. Thus, in the case where shield electrodes are disposed in the vicinities of the first and/or second ion generating electrodes, it is preferable that the potential of the shield electrodes be set so as to be an intermediate potential between the potentials of the first and second ion generating electrodes.

In particular, in order to avoid spark discharge between the ion generating electrodes and the shield electrodes, it is preferable that the potential of the shield electrodes be a mean (+15 kV in the aforementioned example) of the potentials of the first and second ion generating electrodes. However, in the case where shield electrodes are disposed, it is preferable that the potential of the shield electrodes be the ground potential, in view of prevention of discharge to surrounding structures, safety of operating persons in the vicinity, etc.

Therefore, a construction in which direct-current voltages of opposite polarities whose absolute values with respect to the ground potential are substantially equal are applied to the first and second ion generating electrodes, and the potential of the shield electrodes is the ground potential, is a preferable construction in the case where shield electrodes are used. In this construction, the polarity of the voltage applied to the ion generating electrodes and the polarity of the current that flows through the ion generating electrodes also accord. Therefore, a special power supply, such as a fourth quadrant type power supply presented above or the like, becomes unnecessary, and a general high-voltage power supply can be used. In this respect, too, this mode is preferable.

It is preferable that the inter-ion generating electrode potential difference is given so as to be a direct-current potential difference whose ripple factor is 5% or less. This is because if the inter-ion generating electrode potential difference has a certain amount or greater of ripple, temporal unevenness in the amount of ion generation from the ion generating electrodes and the amount of ions attaching to the each surface of the film S. In this case, a problem similar to that in the case where alternating-current inter-ion generating electrode potential differences are given, that is, the problem where charges due to excessive attachment unevenness of ions or portions with the amount of attachment being small with respect to both positive ions and negative ions occur in the traveling direction of the film S arises.

With regard to this problem, the present inventors have found a phenomenon where, in the present invention that brings about forcible irradiation of ions by creating strong electric fields between the ion generating electrodes that face each other across a film S, a slight change of the electric fields between the facing ion generating electrodes produces a great change in the amount of ions irradiated to the surfaces of the film S. This phenomenon is considered to be based on the subsequently explained causes.

Cause A: The amount of ion generation is affected by precedent ions. That is, if the absolute value of the inter-ion generating electrode potential difference slightly declines and the strength of the electric field between the facing ion generating electrodes slightly weakens, the amount of ion generation considerably declines due to the influence of the space electric fields created by precedent ions that exist in the vicinities of the ion generating electrode pointed ends.

Cause B: Strong electric fields are formed between the ion generating electrodes facing across the film S, so that ions do not considerably diffuse, and ions are irradiated to the surfaces of the film S due to drift caused by the electric fields between the ion generating electrodes. Therefore, fluctuations in the amount of ion generation substantially directly become fluctuations in the amount of ion attachment to the film S.

The present inventors have found that if, in each static eliminating unit, the ripple factor becomes 5% or higher with respect to the absolute value of the temporal mean value of the inter-ion generating electrode potential difference, the unevenness in the ion attachment amount in the traveling direction of the film S which arises from the temporal fluctuations in the ion generation amount grows to a degree comparable to or surpassing the value of the ripple factor. Therefore, it is preferable that the ripple factor be 5% or less with respect to the absolute value of the temporal mean value of the inter-ion generating electrode potential difference. In particular, in the case of the ripple factor is 1% or less, the unevenness in the ion attachment amount in the traveling direction of the film S can be considered substantially zero; therefore, the case is particularly preferable.

In the case where the normal direction inter-electrode distance is d₁₋ₘ [unit: mm], and where the absolute value of the temporal mean value Vₘ [unit: kV] of the inter-ion generating electrode potential difference is smaller than 16 kV, and where the mean electric field strength |Vₘ|/d₁₋ₘ between the pointed end of the first ion generating electrode and the pointed end of the second ion generating electrode is smaller than 0.35 kV/mm, the unevenness in the ion attachment amount is small if the ripple factor yₘ of the inter-ion generating electrode potential difference is 20% or less.

This is considered to be because in the case where the mean electric field strength |Vₘ|/d₁₋ₘ between the first and second ion generating electrodes is smaller than 0.35 kV/mm, the drift of ions dependent on the mean electric field strength is not sufficiently large, and therefore the influence of the diffusion of ions is relatively large, and hence the unevenness in the ion attachment amount becomes relatively small even if there are fluctuations to some extent in the ion attachment amount due to fluctuations in the ripple factor yₘ. However, the absolute value of the temporal mean value of the inter-ion generating electrode potential difference becoming 16 kV or greater leads to prominent appearance of the influence of space ions in the vicinities of the ion generating electrode pointed ends, and is therefore not preferable. The ripple factor yₘ being 20% or greater leads to an unevenness in the ion attachment amount which is comparable to or surpasses about twice the ripple factor yₘ, and is therefore not preferable.

However, the method in which the strength of electric fields between the ion generating electrodes is reduced, and the method in which the absolute value of the temporal mean value of the inter-ion generating electrode potential difference is reduced are able to reduce the unevenness in the ion attachment amount, but, at the same time, reduce the ion attachment amount as well. Therefore, it is preferable that, within a range where the mean electric field strength |Vₘ|/d₁₋ₘ≧0.35 is satisfied, a direct-current potential difference with a ripple factor of 5% or less be given.

The upper limit of the mean electric field strength |Vₘ|/d₁₋ₘ between the first and second ion generating electrodes is determined by transition to spark discharge. According to Non-Patent Document 1, the absolute value V_{b} [unit: kV] of the spark voltage of negative corona, that is, the voltage at which negative corona discharge switches to spark discharge during application of negative direct-current voltage, is proportional to the inter-electrode distance d [unit: mm], and is about 1.5d. On the other hand, the positive corona spark voltage, that is, the voltage at which positive corona discharge switches to spark discharge during application of positive direct-current voltage, is about ½ of the aforementioned absolute value V_{b}, that is, 0.75d.

Therefore, as long as the relationship of the mean electric field strength |Vₘ|/d₁₋ₘ≧1.5 is satisfied, the spark discharge between the ion generating electrodes is restrained for both positive and negative applied voltages. In the case of a construction in which shield electrodes are disposed in the vicinities of the ion generating electrodes, a voltage is selected within such a range that spark discharge will not occur between the ion generating electrodes and the shield electrodes as well.

In the case where direct-current voltages of opposite polarities with respect to the ground potential are applied to the first and second ion generating electrodes, it is preferable that as for the direct-current power supply used, the ripple factor be 5% or less with respect to the maximum rated output voltage. It is more preferable that the ripple factor be 1% or less. On the other hand, even if in the voltage output specification of the direct-current power supply itself, the ripple factor exceeds 5% with respect to the maximum rated output voltage, it is preferable to use the power supply with a voltage setting such that the ripple factor with respect to the voltage used is 5% or less, and it is more preferable that the ripple factor be 1% or less.

This is because as long as the mean ripple factor xₘ (=(x₁₋ₘ+X₂₋ₘ)/2) of the ripple factor x₁₋ₘ of the direct-current voltage applied to the first ion generating electrodes and the ripple factor x₂₋ₘ of the direct-current voltage applied to the second ion generating electrodes is 5% or less, the ripple factor yₘ of the inter-ion generating electrode potential difference becomes 5% or less even if the phases of the ripple portions (alternating-current components) are opposite in phase to each other.

Therefore, except for the case where the direct-current voltages are aggressively superimposed with alternating-current components of the same phase, as long as the mean ripple factor of the ripple factors of the direct-current voltages applied to the first and second ion generating electrodes is 5% or less, easy use is possible without minding the phase of ripple. Therefore, such a mean ripple factor is preferable. In order to make the ripple factor yₘ of the inter-ion generating electrode potential difference 1% or less, it is appropriate that a direct-current voltage be applied such that the mean ripple factor of the ripple factors of the direct-current voltages applied to the first and second ion generating electrodes will be 1% or less. In this case, too, use is possible without minding the phase of ripple, similarly to the aforementioned case.

From the viewpoint of the influence on the unevenness in the amount of ion attachment to the film S, the lower limit of the ripple factor of the direct-current voltages does not particularly need to be considered. However, practically, it is advisable that the ripple factor is 0.01% or greater. This is because if further increased precision direct-current voltage is applied, there will be substantially no further influence on the unevenness in the amount of ion attachment to the film S while the power supply definitely becomes rather expensive.

The waveform of the ripple portion that satisfies these conditions may be a triangular wave, a sinusoidal wave, a rectangular wave, or a saw-tooth wave. FIG. 7 shows an example of the waveform of direct-current voltage with such triangular wave fluctuations.

Conversely, in the case where the phase of the alternating-current component is controllable, and where the phases of the alternating-current components of the voltage applied to the first ion generating electrode and the voltage applied to the second ion generating electrode are the same in phase, the ripple factor of the applied voltage to the individual ion generating electrodes being 5% or greater is acceptable as long as the ripple factor of the inter-ion generating electrode potential difference is 5% or less. However, even though the ripple factor yₘ of the inter-ion generating electrode potential difference is 5% or less, ripples so great as to lead to a reversal of the polarity of the mean voltage of the applied voltages to the first and second ion generating electrodes are not preferable.

This is because, in the case where voltages of the same polarity with respect to the ground potential are applied to the first and second ion generating electrodes, the film S is sometimes slightly charged with the polarity of the applied voltage. Therefore, it is preferable that the oscillation width of the sum of the voltage applied to the first ion generating electrode and the voltage applied to the second ion generating electrode be 0.975 or less times the absolute value of the temporal mean value of the potential difference between the voltage applied to the first ion generating electrode and the voltage applied to the second ion generating electrode, that is, Vₘ.

Although the case where two static eliminating units SU₁, SU₂ are used, and where the inter-ion generating electrode potential difference in the 1st static eliminating unit SU₁ is positive and the inter-ion generating electrode potential difference in the 2nd static eliminating unit SU₂ is negative has been described above as an example, the polarities of the inter-ion generating electrode potential differences may be opposite to this example.

The total number n of the static eliminating units can assume any value that is 2 or greater in accordance with the amount of charges (charge density) that is desired to be eliminated, the traveling speed of the film S, etc. In that case, however, it is preferable that the number of the static eliminating units whose inter-ion generating electrode potential differences are positive and the number of the static eliminating units whose inter-ion generating electrode potential differences are negative be substantially equal. This is because, for example, if the number of the static eliminating units whose inter-ion generating electrode potential differences are positive is greater than the number of the static eliminating units whose inter-ion generating electrode potential differences are negative, the difference-corresponding number of static eliminating units will provide an increased effect of shifting the polarity of the first surface of the film S to the positive polarity (the second surface thereof to the negative polarity) rather than contribute to the static elimination. However, in this case, too, many ions attach selectively to portions having fine charge patterns, so that there is no change in the feature of having effect of reducing fine charge patterns. The apparent non-charged state is maintained.

Substantial equality between the number of the static eliminating units whose inter-ion generating electrode potential difference is positive and the number of the static eliminating units whose inter-ion generating electrode potential difference is negative specifically means that, of the n number of static eliminating units, the number of the static eliminating units whose inter-ion generating electrode potential difference is positive is k that is an integer that satisfies n/4≦k≦3n/4. For this, even if there is a static eliminating unit that shifts the charges of each surface of the film S to a polarity, half or more of the total number of static eliminating units irradiate positive ions and negative ions in good balance without shifting the charges of each surface of the film S to a polarity.

For the best balance of irradiation of positive and negative ions, construction may be cited in which the polarity of the inter-ion generating electrode potential difference in n/2 number or more (fraction part disregarded) of static eliminating units of all the static eliminating units and the polarity of the inter-ion generating electrode potential difference in the other static eliminating units are opposite in polarity. That is, if n is an even number, the inter-ion generating electrode potential difference is positive in polarity in half the total number of static eliminating units, and the inter-ion generating electrode potential difference is negative in polarity in the other static eliminating units. In the case where n is an odd number, the number of the static eliminating units whose inter-ion generating electrode potential difference is positive, and the number of the static eliminating units whose inter-ion generating electrode potential difference is negative are different from each other by 1.

It is preferable that the inter-ion generating electrode potential difference between adjacent static eliminating units be opposite in polarity to each other as shown in the above-described modes. This is because, for example, if in a static eliminator made up of 10 static eliminating units, the inter-ion generating electrode potential difference is set positive in the upstream 5 static eliminating units, and the inter-ion generating electrode potential difference is set negative in the downstream 5 static eliminating units, it is likely that the film S, after passing through all the static eliminating units, will have the polarity of the first surface shifted to the negative polarity (the second surface shifted to the positive polarity), and will be therefore charged.

A cause for these charges is that the amount of ion attachment to the surfaces of the film S is affected by the amount of charges of the surfaces of the film S. For example, in the case where negative ions are irradiated to a film S whose first surface is strongly positively charged, the amount of attachment of ions to the film S tends to be greater than in the case where negative ions are irradiated to a film S whose first surface is non-charged (the same tendency exists in the case of opposite polarities).

A most preferable mode is an arrangement in which the inter-ion generating electrode potential differences of adjacent static eliminating units are opposite in polarity to each other so that positive and negative ions are irradiated alternately in the traveling direction of the film S.

In the case where the inter-ion generating electrode potential differences of the pth and p+1th (where p is an integer of 1 to n−1) static eliminating units are opposite in polarity to each other, it is preferable that the static eliminating unit interval d₂₋ₚ [unit: mm] between the adjacent pth and p+1th static eliminating units be 0.8 or greater times to 3.0 or less times the maximum value of the values d₁₋ₚ and d₁₋₍ₚ₊₁₎ of the normal direction inter-electrode distance of the adjacent pth and p+1th static eliminating units, and it is more preferable that the static eliminating unit interval d₂₋ₚ be 0.8 or greater times to 2.0 or less times the maximum value of the values d₁₋ₚ and d₁₋₍ₚ₊₁₎ of the normal direction inter-electrode distance of the adjacent pth and p+1th static eliminating units.

This is because if the adjacent distance between static eliminating units whose inter-ion generating electrode potential differences are opposite in polarity is 2.0 or less times the maximum value of the values of the normal direction inter-electrode distance, the electric fields formed by the ion generating electrodes in the adjacent static eliminating units enhance the pinpoint-vicinity electric fields, and therefore increase the ion generation amount.

If the adjacent distance between static eliminating units whose inter-ion generating electrode potential differences are opposite in polarity is less than the maximum value of the values of the normal direction inter-electrode distance, the ions generated are likely to move toward an adjacent ion generating electrode, and recombine before reaching the surfaces of the film S although the ion generation amount increases. Furthermore, the static eliminating unit interval becomes closer to 0.8 or less times the maximum value of the normal direction inter-electrode distances, the proportion of ion recombination increases comparably to or greater than the increase in the ion generation amount, so that the amount of ion that reaches the surfaces of the film S.

Furthermore, the following consideration can be made with regard to portions where the polarities of the inter-ion generating electrode potential differences in adjacent static eliminating units are the same in polarity.

That is, in the case where the inter-ion generating electrode potential differences of adjacent pth and p+1th (where p is an integer of 1 to n−1) static eliminating units are equal in polarity, it is preferable that the static eliminating unit interval d₂₋ₚ [unit: mm] between the adjacent pth and p+1th static eliminating units be 2.0 or greater times the maximum value of the values d₁₋ₚ and d₁₋₍ₚ₊₁₎ of the normal direction inter-electrode distance of the adjacent pth and p+1th static eliminating units.

This is because, contrary to the case where the inter-ion generating electrode potential differences are opposite in polarity to each other, if the distance between the static eliminating units whose inter-ion generating electrode potential differences are equal in polarity is less than 2.0 times the maximum value of the values of the normal direction inter-electrode distance, the electric fields between the adjacent ion generating electrodes weaken the electric fields in the vicinities of the pinpoints, and therefore reduce the ion generation amount. The adjacent distance between static eliminating units is 2.0 or greater times the maximum value of the values of the normal direction inter-electrode distance, the equality in polarity of the inter-ion generating electrode potential differences of the adjacent static eliminating units does not substantially affect the electric fields in the vicinities of the pinpoints of the ion generating electrodes, so that the ion generation amount does not substantially reduce.

In the case where in each static eliminating unit, the first electrode unit has a first shield electrode and the second electrode unit has a second shield electrode, and where the inter-ion generating electrode potential differences of adjacent pth and p+1th (where p is an integer of 1 to n−1) static eliminating units are opposite in polarity to each other, it is preferable that the static eliminating unit interval d₂₋ₚ [unit: mm] between the adjacent pth and p+1th units be 1.0 or greater times to 1.5 or less times the mean value (Wₚ+Wₚ₊₁)/2 [unit: mm] of the widthwise dimensions Wₚ and Wₚ₊₁ of the adjacent pth and p+1th static eliminating units.

If the adjacent distance between static eliminating units whose inter-ion generating electrode potential differences are opposite in polarity is short, the pinpoint-vicinity electric fields of adjacent ion generating electrodes enhance each other, so that the ion generation amount increases in each ion generating electrode. Therefore, it is preferable that the static eliminating unit interval d₂₋ₚ [unit: mm] between the adjacent pth and p+1th units be 1.5 or less times the mean value (Wₚ+Wₚ₊₁)/2 [unit: mm] of the widthwise dimensions of the adjacent pth and p+1th static eliminating units. However, if the adjacent distance between static eliminating units whose inter-ion generating electrode potential differences are opposite in polarity to each other is excessively short, ions of opposite polarities recombine before reaching the surfaces of the film S.

If the electrode units of each static eliminating unit have shield electrodes, ions are irradiated so that they do not concentrate only on a portion of the line segment connecting the first and second ion generating electrodes, but have an extension that is substantially comparable to the widthwise dimensions of each static eliminating unit. This is because the shield electrodes weaken the normal direction electric fields around the line segment connecting the first and second ion generating electrodes. From this extension of ions, it is preferable that the static eliminating unit interval d₂₋ₚ [unit: mm] between adjacent pth and p+1th units be 1.0 or greater times the mean value (Wₚ+Wₚ₊₁)/2 [unit: mm] of the widthwise dimensions of the adjacent pth and p+1th static eliminating units.

In the case where ion generating electrodes adjacent in the traveling direction of the film S mutually enhance the electric fields in the vicinities of the pinpoints thereof, the amounts of ions of opposite polarities irradiated from adjacent ion generating electrodes tend to balance each other. Therefore, the differences in the ion generating ability among the individual static eliminating units are reduced, and the case is particularly preferable.

In the case where in each static eliminating unit, the first electrode unit has a first shield electrode and the second electrode unit has a second shield electrode, and where the inter-ion generating electrode potential differences of adjacent pth and p+1th (where p is an integer of 1 to n−1) static eliminating units are opposite in polarity to each other, it is preferable that the static eliminating unit interval d₂₋ₚ [unit: mm] between the adjacent pth and p+1th units be 1.5 or greater times the mean value (Wₚ+Wₚ₊₁)/2 [unit: mm] of the widthwise dimensions of the adjacent pth and p+1th static eliminating units.

A reason for this can be considered as follows. That is, in the case where each electrode unit of each static eliminating unit has a shield electrode, it is often the case that the electric fields between the ion generating electrodes and the shield electrodes are predominant in discharge. However, if the static eliminating unit interval d₂₋ₚ [unit: mm] between the adjacent pth and p+1th units becomes 1.5 or less times the mean value (Wₚ+Wₚ₊₁)/2 [unit: mm] of the widthwise dimensions of the adjacent pth and p+1th static eliminating units, the influence of the inter-ion generating electrode potential differences of adjacent static eliminating units becomes unignorable, so that the electric fields in the vicinities of the pinpoints are mutually weakened.

In the case where the static eliminating unit interval d₂₋ₚ [unit: mm] between the adjacent pth and p+1th units is greater than 1.5 times the mean value (Wₚ+Wₚ₊₁)/2 [unit: mm] of the widthwise dimensions of the adjacent pth and p+1th static eliminating units, the ion generation amount is substantially no different from that in the case where it is equal to 1.5 times.

As for the relationship between the polarities of the inter-ion generating electrode potential differences and the static eliminating unit interval with regard to static eliminating units adjacent in the traveling direction of the film S, the same relationship is considered to hold with regard to partial electrodes in the width direction of the film S as well.

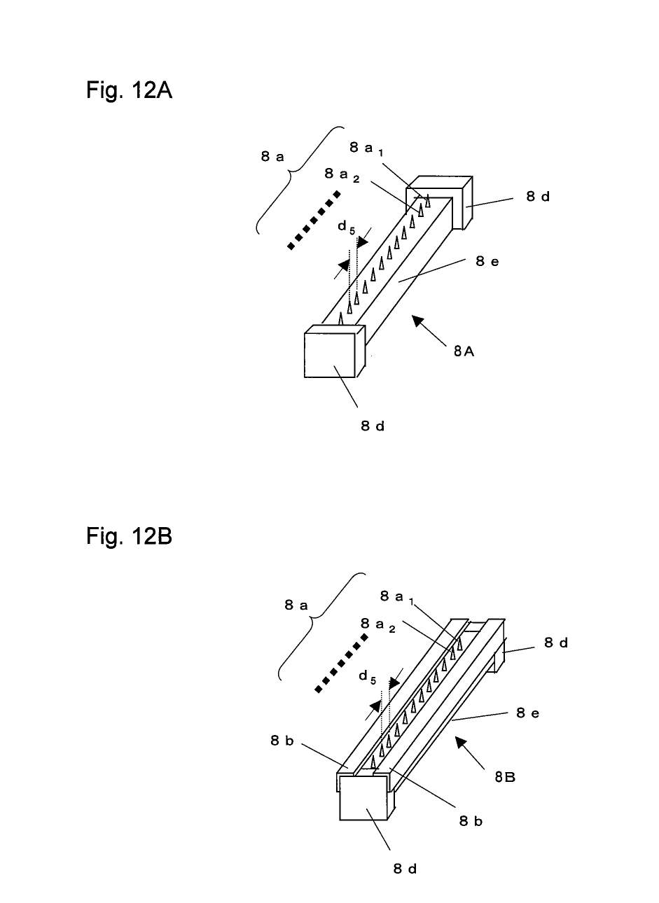

FIG. 12A is a perspective view of an example of the ion generating electrode exposed type electrode units for use in the static eliminator of the present invention, and FIG. 12B is a perspective view of an example of electrode units having shield electrodes for use in the static eliminator of the present invention. In FIG. 12A and FIG. 12B, an ion generating electrode 8a is formed by many partial electrodes 8a₁, 8a₂, . . . such as needle electrodes. In the case where the intervals d₅ between partial electrodes adjacent in the width direction of the film S is small, that is, in the case where the relationship of d₅<0.8d₁₋ₘ is satisfied, application of great potential to partial electrodes adjacent in the width direction of the film S, due to application of voltages opposite in phase to each other or the like, makes it likely for positive and negative ions generated from the partial electrodes to be recombined and neutralized. As a result, the amount of ions attaching to the surfaces of the film S reduces.

Therefore, it is preferable that the voltages applied to partial electrodes adjacent in the width direction of the film S be equal in polarity to each other with respect to a “predetermined common potential” (for example, the ground potential of 0 [unit: V] potential) so that the aforementioned potential difference will become smaller. Hereby, the recombination of positive and negative ions and the thereby caused increase in the output current from the power supply are restrained, so that the use of a small-capacity power supply becomes possible.

In the case where the voltages applied to partial electrodes adjacent in the width direction of the film S are opposite in polarity to each other with respect to the “predetermined common potential”, and where the intervals d₅ between partial electrodes adjacent in the width direction of the film S are large, that is, the relationship of d₅≧0.8d₁₋ₘ is satisfied, the recombination of generated positive and negative ions is restrained, but uniform ion attachment to the entire surfaces in the width direction of the film S becomes difficult. Therefore, a form in which the intervals d₅ between partial electrodes adjacent in the width direction of the film S have a value that is smaller than 0.8 times the maximum value of the normal direction inter-electrode distances of the static eliminating units, and voltages equal in polarity to each other are applied to the partial electrodes adjacent in the width direction of the film S is preferable. Incidentally, each ion generating electrode may be a wire electrode that is made of a single conductor, instead of an assembly of partial electrodes. In that case, the intervals d₅ is considered zero.

Despite adoption of a construction in which the number of static eliminating units whose inter-ion generating electrode potential difference is positive and the number of static eliminating units whose inter-ion generating electrode potential difference is negative are substantially equal and the polarities of the inter-ion generating electrode potential differences of static eliminating units adjacent in the traveling direction of the film S are polarities opposite to each other, it can happen that the each surface of the film S having passed through all the static eliminating units are charged relatively strongly with either the positive or negative polarity. As for causes thereof, the following three points are considered.

Cause C: The amount of ion attachment to each surface of the film S from the static eliminating unit that is the most downstream in the traveling direction of the film S is likely to be large due to the influence of the charge present in each surface of the film S, so that each surface of the film S is charged with one polarity, as described above. This tends to be progressively stronger as the traveling speed of the film S is slower. Furthermore, this tends to be stronger in the case where the electrode units are the ion generating electrode exposed type electrode units.

Cause D: The static eliminating units have differences in the ion generating ability from one another. For example, in the case where the ion generation amount by the 1st static eliminating unit is small and the ion generation amount by the 2nd static eliminating unit is large, the each surfaces of the film S are affected and therefore charged by the ion irradiation from the 2nd static eliminating unit.

Cause E: The shutdown of a static eliminating unit due to a power failure or the like. The each surfaces of the film S are charged with polarities that are opposite to the polarities of the ions that are supposed to have been irradiated to the film S from the shut-down static eliminating unit. Incidentally, in the case where either only direct-current power supplies that output positive voltage or only direct-current power supplies that output negative voltage have failed, the stop of ion attachment to one surface of the film S is accompanied by restraint of ion attachment to the opposite surface of the film, so that apparent charge of the film does not substantially occur.

For the causes C to E, the film S is in the apparent non-charged state even in the case where the each surfaces of the film S are charged with the positive or negative polarity. Each surface of the film S is substantially free from fine charged pattern unevenness and cyclical charged pattern, and the each surfaces of the film S are in a state where they are charged with opposite polarities in a direct-current fashion.

Even with regard to a film having such an charged state, it relatively rarely happens that this charged state itself becomes a problem. This is because, in connection with the coating unevenness and the development of a static mark after vapor deposition or the like, it often happens that local charged portion of a film indicated by charge patterns or the like becomes a problem.

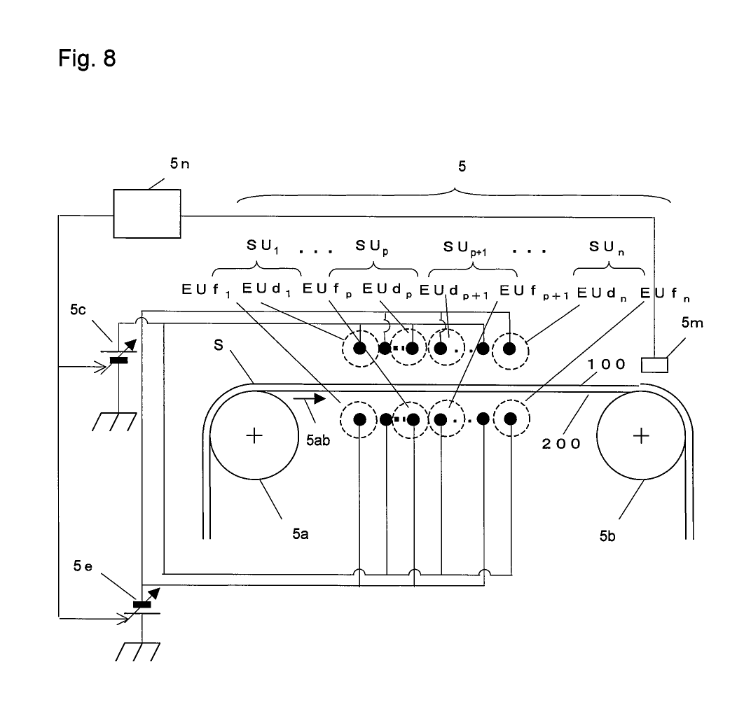

FIG. 8 shows another embodiment of the static eliminator of the present invention. In the case where the amount of charges of each surface of the film S is desired to be reduced, a static eliminator shown in FIG. 8 is preferably used. In FIG. 8, the potential of a first surface 100 of a film S after static elimination (after passing through all the static eliminating units) is measured by a potential measurement means 5m, such as an electrometer or the like, during a state where a second surface 200 of the film S is in contact with an electrically conductive member (guide roll 5b). The inter-ion generating electrode potential difference of one or more static eliminating units is controlled by a control means 5n for the inter-ion generating electrode potential difference.

For example, if the measured potential of the first surface 100 of the film S (rear side equilibrium potential of the first surface 100) is positive, the absolute value of the positive applied voltage, in a static eliminating unit in which the voltage applied to the first ion generating electrode is positive, is reduced so as to reduce the positive inter-ion generating electrode potential difference. Or, in a static eliminating unit in which the voltage applied to the first ion generating electrode is negative, the absolute value of the negative applied voltage is increased so as to increase the negative inter-ion generating electrode potential difference. Hereby, through a control such that the potential of the first surface 100 of the film S becomes close to zero, the amount of charges of each surface of the film S can be adjusted to a lower level.

Although an example of the case where the potential of the first surface 100 of the film S is positive has been presented above, it is appropriate to perform a control that is opposite to the aforementioned one, in the case where the potential is negative. Furthermore, a similar control is possible by measuring the rear side equilibrium potential of the second surface 200 of the film S during a state where the first surface 100 of the film S is in contact with an electrically conductive member.

In the case where the surfaces of the film S after passage through all the static eliminating units are likely to be electrified depending on the polarity of the inter-ion generating electrode potential difference of the most downstream static eliminating unit, it is advisable that the absolute value of the inter-ion generating electrode potential difference in the most downstream, that is, nth static eliminating unit SUₙ be beforehand set smaller than the absolute value of the inter-ion generating electrode potential difference in the other static eliminating units. Or, it is advisable that the normal direction inter-electrode distance d₁₋ₙ of the most downstream static eliminating unit SUₙ be set larger than the normal direction inter-electrode distances d₁₋₁ to d₁₋₍ₙ₋₁₎ of the other static eliminating units. Furthermore, it is advisable that the electrode discrepancy amount d₀₋ₙ of the most downstream nth static eliminating unit be set larger than those of the other static eliminating units.

Furthermore, it is advisable that in the first and second electrode units of one or more static eliminating units that include the most downstream nth unit, the amount of irradiation of ions in the most downstream static eliminating unit be beforehand reduced by using electrode units BB of FIG. 12B that have shield electrodes in the vicinities of the ion generating electrodes, instead of electrode units 8A of the ion generating electrode exposed type electrode units of FIG. 12A. These techniques may be used only for the most downstream static eliminating unit, or may also be used gradually from upstream to downstream static eliminating units.

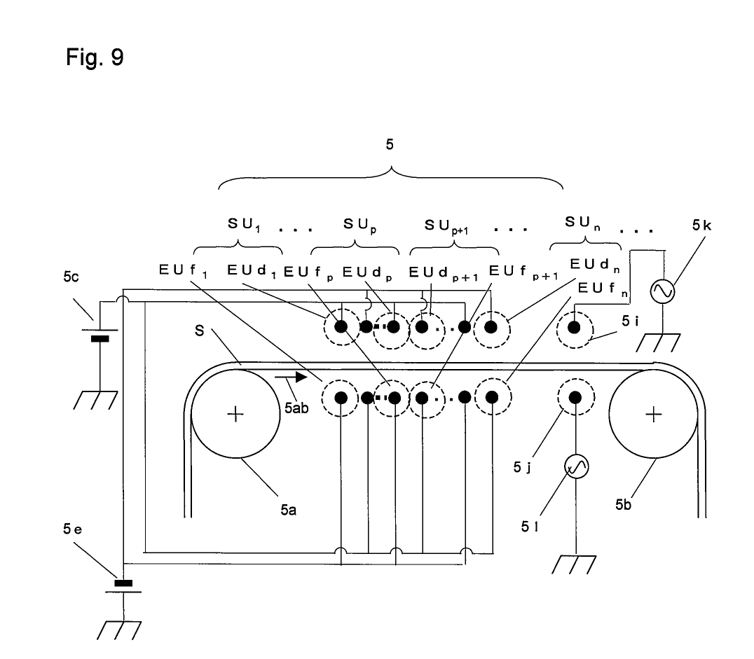

FIG. 9 shows another embodiment of the static eliminator of the present invention. In FIG. 9, a static eliminator 5 further has an alternating-current static eliminating unit that has a first alternating-current ion generating electrode 5i and a second alternating-current ion generating electrode 5j that are disposed facing each other across a film S, downstream of a plurality of direct-current static eliminating units.

A plurality of alternating-current static eliminating units as described above may be provided. Alternating-current voltages opposite in polarity to each other are applied to the first alternating-current ion generating electrode 5i and the second alternating-current ion generating electrode 5j from alternating-current power supplies 5k, 5l, so as to give an alternating-current inter-ion generating electrode potential difference between the first alternating-current ion generating electrode 5i and the second alternating-current ion generating electrode 5j. Hereby, positive and negative weak charge unevenness is intentionally formed in each surface of the film S in the traveling direction of the film S so that the charges of each surface of the film S will not be biased to one polarity.

In particular, in the case where the rate of change of the speed of the film S is large, such as immediately after the start of movement of the film S, immediately before a stop thereof, etc., it is preferable to aggressively use alternating-current static eliminating units. In the static eliminator of FIG. 5, the balance between the positive and negative ion irradiations to various portions of the each surfaces of the film S will not greatly deteriorate depending on the traveling speed of the film S provided that the traveling speed thereof is constant.

However, as for portions of a film S where the rate of speed change of the film S is large, such as immediately after start of movement, immediately before stop, etc., the traveling speed of the film S when a portion of the film S passes directly below the 1st static eliminating unit, and the traveling speed thereof when the portion thereof passes directly below the 2nd static eliminating unit are greatly different from each other. Hereby, a great difference occurs between the amount of ions irradiated from the 1st static eliminating unit onto the surfaces of the film S per unit area and the amount of ions irradiated from the 2nd static eliminating unit onto the surfaces of the film S per unit area. Since this great difference occurs during a very small amount of time (several seconds) of acceleration or deceleration, it is also possible to perform such a control as to shut down or reduce the applied voltage only for this duration.

Even in the case where the respective surfaces of the film S are charged with one polarity due to a failure of a direct-current power supply or the like, the provision of the alternating-current static eliminating unit at the most downstream site can reduce the one-polarity charge of the respective surfaces of the film S. Therefore, it is preferable that an alternating-current static eliminating unit be provided downstream of the direct-current static eliminating units.

In the case where the first and second ion generating electrodes are partial electrodes of a needle-like structure, unevenness of attachment of generated ions sometimes occurs in the width direction of the film S on the each surfaces of the film S, which is particularly prominent in the case of electrode units of the ion generating electrode exposed type electrode units. Reasons for this are considered as follows.

Reason 1: Since the electric fields between the first and second ion generating electrodes that are disposed facing each other are strong and, particularly, the electric fields directly below the facing needle-like partial electrodes are strong, generated ions are likely to be accelerated toward and attach to portions of the sides surfaces of the film S which are directly below the needle-like partial electrodes.

Reason 2: In the ranges between adjacent needle-like partial electrodes arranged in the width direction of the film S, electric fields are weaker than directly below the needle-like partial electrodes, and accordingly, the accelerating force on generated ions is weaker and the amount of generated ions is smaller.

In the aforementioned cases, too, the provision of an alternating-current static eliminating unit at the most downstream site can alleviate the unevenness in the ion attachment amount in the width direction of the film S. Therefore, it is preferable that an alternating-current static eliminating unit be provided downstream of the direct-current static eliminating units.

As for the electrode units of the alternating-current static eliminating unit provided downstream, it is preferable to use electrode units 8B of FIG. 12B that have shield electrodes in the vicinities of the ion generating electrodes, that are not electrode units of the ion generating electrode exposed type electrode units 8A of FIG. 12A. This is because the use of electrode units having shield electrodes makes it possible to attach ions to the surfaces of the film S uniformly without great unevenness in the width direction of the film S. In this case, the shield electrodes had better be given the ground potential.

In order to avoid charges of the individual surfaces of the film S with opposite polarities due to a failure of a power supply or the like, it is preferable that the first ion generating electrode of a static eliminating unit and the second ion generating electrode of another static eliminating unit be connected to a single power supply. As for the number of the static eliminating units connected in this manner, no number is particularly preferred as long as the number of the static eliminating units whose first ion generating electrodes are connected to a single power supply and the number of the static eliminating units whose second ion generating electrodes are connected to the aforementioned single power supply are the same. With such provision, in the case where, for example, a direct-current power supply fails, the ion attachment amount in total reduces; however, since the amounts of ion irradiation to the surfaces of the film S reduce with regard to both positive and negative ions, excessive charges of the surfaces of the film S can be avoided. Thus, a static eliminator that relatively scarcely electrifies the surfaces of the film S with one polarity even in the case of a failure can be obtained.

In the static eliminator of the present invention, the direct-current voltage applied to the ion generating electrodes is preferably about 3 kV or greater to 15 kV or less in absolute value in the atmosphere, and the normal direction inter-electrode distance is preferably 10 mm or greater to 50 mm or less, and the pointed ends of the ion generating electrodes of each static eliminating unit are most preferably in a completely facing arrangement, that is, arranged facing each other without a displacement in the traveling direction of the film. However, in the case where the respective surfaces of the film S after passage through all the direct-current static eliminating units arranged in the traveling direction of the film S are charged with either one of the positive and negative polarities, it is also possible to aggressively adjust the electrode discrepancy amount d₀₋ₙ of the most downstream nth direct-current static eliminating unit so as to balance the positive and negative charges of the respective surfaces of the film S.

Next, results of static elimination of films through the use of static eliminators of the present invention will be described through the use of Examples and Comparative Examples.

Evaluation of results of static elimination in Examples and Comparative Examples were accomplished by the following method.

Measuring Method for Rear Side Equilibrium Potential and Charge Density on Surfaces of Film S:

The surface of a film opposite to a to-be-evaluated surface was brought into close contact with a metallic roll made of a hard chrome-plated roll of 10 cm in diameter, and the potential of the to-be-evaluated surface was measured. As an electrostatic voltmeter, a Model 244 produced by Monroe electronics, Inc. was used. As a sensor thereof, a Probe 1017EH produced by Monroe electronics, Inc. which has an opening diameter of 0.5 mm was used. The sensor was placed at a position of 0.5 mm above the film. The coverage at this position is a range of about 1 mm in diameter according to a catalog of Monroe electronics, Inc. While the metallic roll was being rotated at a low speed of about 1 m/min through the use of a linear motor, the rear side equilibrium potential V_{f} [unit: V] was measured with the electrostatic voltmeter.

The rear side equilibrium potential distribution was determined by the following method. That is, the electrostatic voltmeter is scanned in the width direction of the film, over an appropriate distance corresponding to the structure of the electrode units (for example, a distance that is about twice the width-direction interval of needles, usually, a distance of about 20 mm), so as to determine a position in the width direction where a maximum value of the absolute value thereof is obtained. Next, while the position in the width direction is fixed, the electrostatic voltmeter is scanned in the direction in which the film is moved when the film is subjected to the static elimination process, that is, the longitudinal direction of the film, to measure the potential. As for the rear side equilibrium potential in a film surface, it is ideal to perform measurement two-dimensionally at all points; however, the aforementioned distribution of potential in the longitudinal direction of the film is used as an approximation to the distribution of potential in the film surface.

In the case where the film width exceeds 1 m, portions of about 20 mm in a substantially central portion and edge portions in the width direction of the film are cut out, and the electrostatic voltmeter is scanned to find a location where a maximum value is obtained. After that, the electrostatic voltmeter is scanned in the direction in which the film is moved when the film is subjected to the static elimination process, to measure the potential. Furthermore, in the case where a locally strongly charged site is seen at a specific position in the width direction of the film before static elimination, the electrostatic voltmeter is scanned at the aforementioned position in the width direction, in the traveling direction of the film before and after static elimination, to measure the potential.

From the rear side equilibrium potential V_{f} [unit: V], the charge density σ [unit: C/m²] of the to-be-evaluated surface of the film directly below the sensor was determined through a relational expression σ=C×V_{f} (where C is the capacitance per unit area [unit: F/m²]). Since the film thickness was sufficiently smaller than the measurement coverage, the capacitance per unit area C was approximated by a parallel-plate capacitance C=ε₀×εᵣ/d_{f} (where d_{f} is the thickness of the film, and ε₀ is the permittivity of vacuum 8.854×10⁻¹² F/m, and εᵣ is the relative permittivity of the film). As for the relative permittivity εᵣ of polyethylene terephthalate, 3 was used.

In assessing the effect of static elimination in the present invention, the assessment is made from the following two viewpoints.

Assessment 1: Whether, in a film whose surfaces (obverse surface and reverse surface, or first surface and second surface) are both strongly charged positively and negatively, and oppositely in polarity to each other, the peak to peak amplitude of the charge density following static elimination successfully presents a significant reduction or not.

For this assessment, a film whose surfaces were charged in opposite polarities with the charge density having a peak to peak amplitude of 150 μC/m² or greater prior to static elimination was used. Assessment was made in the following three grades.

“Best”: A film whose peak to peak amplitude of the charge density after static elimination is 30 μC/m² or less.

“Good”: A film whose peak to peak amplitude of the charge density after static elimination is 30 μC/m² or greater, with the peak to peak amplitude presenting a reduction of 30 μC/m² or greater after static elimination.

“No good”: A film whose reduction in the peak to peak amplitude of the charge density after static elimination is smaller than 30 μC/m².

The reference of the peak to peak amplitude of the charge density is set at 30 μC/m² because in the “apparent static elimination”, which is the static elimination by the related-art static elimination technology, the reduction in the charge density in both-side bipolar charges is zero or at most 1 μC/m² in absolute value and it is certain that an amount of charges that is greater than the aforementioned amount can be eliminated.

Assessment 2: Whether, in a film whose surfaces are substantially not charged prior to static elimination, there are excessive charges caused in the post-static elimination film or not.

For this assessment, a film whose surfaces had a charge density of 30 μC/m² or less in absolute value was used. Assessment was made in the following four grades.

“Best”: A film with the maximum value of the absolute values of the charge density after static elimination being 30 μC/m² or less, and the peak to peak amplitude of the charge density being 60 μC/m² or less.

“Good”: A film with the maximum value of the absolute values of the charge density after static elimination being 100 μC/m² or less, and the peak to peak amplitude of the charge density being 60 μC/m² or less.

“Fairly good”: A film with the maximum value of the absolute values o of the charge density after static elimination being 100 μC/m² or less, and the peak to peak amplitude of the charge density being greater than 60 μC/m² but less than or equal to 90 μC/m².

“No good”: A film with the maximum value of the absolute values of the charge density after static elimination being greater than 100 μC/m², and/or with the peak to peak amplitude of the charge density being greater than 90 μC/m².

Experiment 1: A comparative experiment using a raw film A-1, between a static eliminator in which electrode units 8B (FIG. 12B) (electrode units that are not the ion generating electrode exposed type electrode units) are used and the inter-ion generating electrode potential differences in adjacent static eliminators are direct-current potential differences of opposite polarities, and a static eliminator in which electrode units 7 (FIG. 14) are used and the inter-ion generating electrode potential difference is an alternating-current potential difference.

### EXAMPLE 1

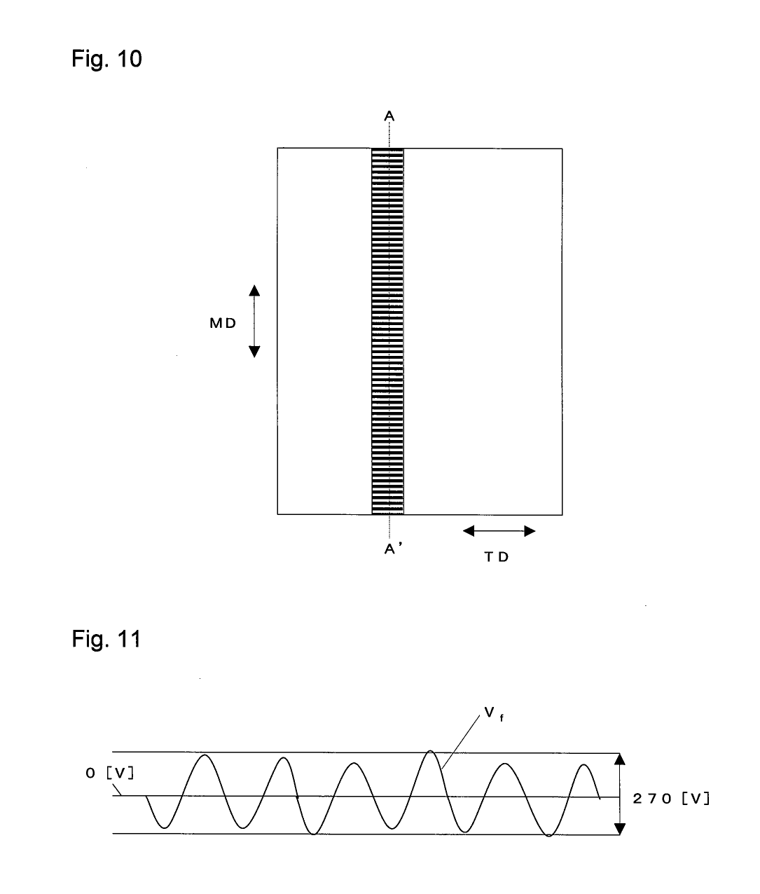

In the static eliminator 5 as shown in FIG. 5, a biaxially stretched polyethylene terephthalate film (Lumirror 38S28 produced by Toray Industries, Inc., referred to as “raw film A-1”) of 300 mm in width and 38 μm in thickness was used as an insulating sheet S, and the film S was moved at speeds u [unit: m/min] shown in Table 1. Prior to the static elimination, cyclical charges in the cycle of 1.1 to 1.2 mm in the traveling direction of the film was performed on the raw film A-1, that is, a range of 10 mm in the width direction of the film, as shown in FIG. 10.

In FIG. 10, arrow TD shows the width direction of the film, and arrow MD shows traveling direction of the film. The distribution of rear side equilibrium potential of the first surface of a cyclically charged portion (portion A-A′ in FIG. 10) was, as shown in FIG. 11, a substantially sinusoidal wave shape in the traveling direction of the sheet, with 270 V in peak-peak centered at 0V (the peak to peak amplitude of the charge density in the surfaces being 190 μC/m²). The distribution of rear side equilibrium potential of the second surface was opposite in polarity to and substantially equal in absolute value to the rear side equilibrium potential of the first surface. Furthermore, the rear side equilibrium potential of the portions of the film S other than the charged portion (portion of 10 mm in width), on each surface, was 15 V or less in absolute value, and the charge density in each surface was within the range of −10 to +10 μC/m², and it was thus confirmed that the aforementioned portions were substantially non-charged.

As the first and second electrode units, electrode units 8B (HER type electrodes, produced by Kasuga Denki, INC.) of FIG. 12B were used. The ion generating electrodes 5d₁ to 5dₙ and ion generating electrodes 5f₁ to 5fₙ in the electrode units 8B are each formed by a needle electrode array 8a (an assembly of partial electrodes 8a₁, 8a₂, . . . ). The intervals d₅ of the needles in the width direction were 10 mm. The needle electrode arrays 8a and the shield electrodes 8b are insulated from each other by insulating materials (vinyl chloride) 8d, 8e. The shield electrodes 8b are disposed continuously in the width direction.

In each static eliminating unit, the first and second electrode units were disposed across the film S orthogonal to the traveling direction of the film S and parallel with the surfaces of the film S, and so that the point end of each needle electrode of the first electrode unit and point end of each needle electrode of the second electrode unit were faced each other. The total number n of the static eliminating units was set at 8. The widthwise dimensions W₁ to W₈ of the static eliminating units were all 40 mm.

The pointed ends of the needles of each needle electrode array, that is, the pointed ends of the ion generating electrodes of each static eliminating unit, were aligned linearly in the width direction, and the sag of the electrodes in the normal directions and the traveling direction of the film S was ignorably small.

The normal direction inter-electrode distances d₁₋₁ to d₁₈ were all set at 40 mm. The static eliminating unit intervals d₂₋₁ to d₂₋₇ were all set at 55 mm. The shield electrode opening widths SOg₁ to SOg₈ and SOh₁ to SOh₈ of each static eliminating unit were all 18 mm. The shield electrodes 8b were all grounded.

In each static eliminating unit, direct-current voltages opposite in polarity and equal in absolute value to each other were applied to the first ion generating electrode and the second ion generating electrode facing each other. A positive direct-current voltage was applied to the first ion generating electrodes of the odd number-th (1st, 3rd, 5th, 7th) static eliminating units from the most upstream point in the traveling direction of the sheet and a negative direct-current voltage was applied to the first ion generating electrodes of the even number-th (2nd, 4th, 6th, 8th) static eliminating units from the most upstream point in the traveling direction of the sheet. In another word, the inter-ion generating electrode potential difference in the odd number-th static eliminating units was positive, and the inter-ion generating electrode potential difference in the even number-th static eliminating units was negative.

The absolute value of the temporal mean value of applied voltages was set, in all the cases, at a voltage V₀, and V₀ was set at 8 kV. The absolute value of the inter-ion generating electrode potential difference in each static eliminating unit was set at 16 kV. As for the application of direct-current voltages, direct-current voltage outputs from two (one for applying positive voltage, another for applying negative voltage) function generators (each of which was a Function Synthesizer 1915 produced by NF Corporation) which were amplified by two (one for applying positive voltage, another for applying negative voltage) high-voltage power sources (each of which was a MODEL 20/20B produced by TRek, Inc.) were used.

The ripple factor of the direct-current applied voltage was checked with an oscilloscope (54540C of Hewlett Packard Japan, Ltd.), and was found to be 0.1% or less. The amplification factor of the high-voltage power sources is 2000 times, and the precision thereof is 0.1%. All the mean ripple factors of the ripple factors of the direct-current voltages applied to the first and second ion generating electrodes in the static eliminating units were the same ripple factor x₀, which was 0.1%. The ripple factor was 0.1% or less with regard to both the positive direct-current voltage and the negative direct-current voltage.

In the odd number-th (1st, 3rd, 5th, 7th) static eliminating units from the most upstream point in the movement direction of the film S, the amount of ions per unit hour which are generated from the first ion generating electrodes charged positive direct-current voltage were measured by a measuring instrument of amount of ion (a MODEL ICM-2 produced by Shimuko Co.). The measuring result showing that the amount of ions having negative polarity was zero and the amount of ions having positive polarity was almost constant in timewise was obtained. On the other hand, in the odd number-th (1st, 3rd, 5th, 7th) static eliminating units from the most upstream point in the movement direction of the film S, the amount of ions per unit hour which are generated from the second ion generating electrodes charged negative direct-current voltage were measured. The measuring result showing that the amount of ions having positive polarity was zero and the amount of ions having negative polarity was almost constant in timewise, and the absolute value thereof was the same to the amount of ions having positive polarity generated from the first ion generating electrodes was obtained. Also on each of the ion generating electrode in the even number-th (2nd, 4th, 6th, 8th) static eliminating units from the most upstream point in the movement direction of the film S, though the polarity of ion is in opposite in the measurement, the result same to the above in the odd number-th static eliminating units was obtained. In light of the results, it was confirmed that a pair of ion cloud having no change of polarity in timewise in each was irradiated at the same time to the first surface and the second surface of the moving film S and after that a pair of ion cloud having no change of polarity in timewise in each and having polarity which was in reverse in the foregoing irradiation was irradiated at the same time to the first surface and the second surface of the moving film S and further each of the amount of ions in the respective polarities was substantially the same.

The shield electrode 5g₁ to 5g₈ and 5h₁ to 5h₈ were all grounded. The film S was set so as to pass through substantially the middle between the first and second ion generating electrodes in the static eliminating units.

As for the distribution of charges of the static-eliminated film S, the distribution of rear side equilibrium potential of the first surface was investigated, and the charge density was determined, on the basis of the aforementioned measuring method. The peak to peak amplitude of the charge density in the cyclically charged portion, and the range of the charge density [unit: μC/m²] in the non-charged portions (portions other than the charged portion), as well as assessment results thereof are shown in Table 1.

### COMPARATIVE EXAMPLE 1

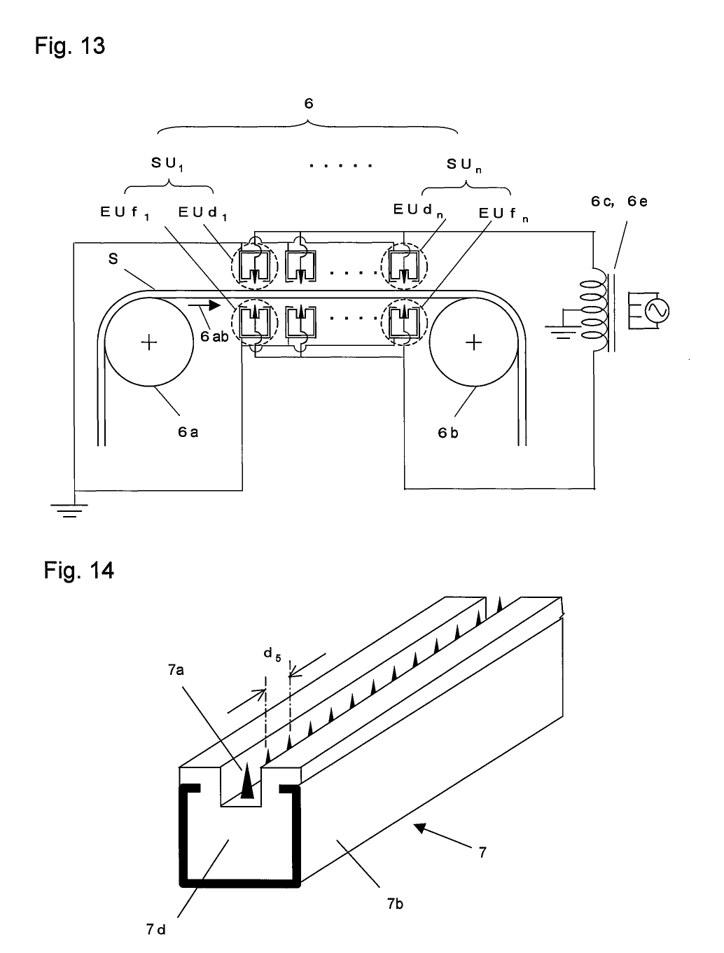

In the static eliminator 6 as shown in FIG. 13, a raw film A-1 subjected to the same charges as in Example 1 was used as an insulating sheet S, and the film S was moved at speeds u [unit: m/min] shown in Table 1.

As first and second electrode units, electrode units 7 in which the needle electrode array 7a are ion generating electrodes as shown in FIG. 14 were used. The intervals d₅ of the needles in the width direction were 12.7 mm. The needle electrode arrays 7a and the shield electrodes 7b are insulated from each other by insulating materials (Teflon (registered trademark)) 7d. In each static eliminating unit, the first and second electrode units were disposed across the film S orthogonal to the traveling direction of the film S and parallel with the surfaces of the film S, and so that the point end of each needle electrode of the first electrode unit and point end of each needle electrode of the second electrode unit faced each other across the film S. The total number n of the static eliminating units was set at 8.

The pointed ends of the needles of each needle electrode array, that is, the pointed ends of the ion generating electrodes of each static eliminating unit, were aligned linearly in the width direction, and the sag of the electrodes in the normal directions and the traveling direction of the sheet was ignorably small.

The normal direction inter-electrode distances d₁₋₁ to d₁₋₈ were all set at 25 mm. The static eliminating unit intervals d₂₋₁ to d₂₋₇ were all set at 30 mm.

The first ion generating electrodes of all the static eliminating units were set so as to be equal in phase, and the second ion generating electrodes of all the static eliminating units were also set so as to be equal in phase. As for the power sources 6c, 6e connected to the first and second ion generating electrodes, alternating-current power sources having an effective voltage of 4 kV and a frequency of 60 Hz were used, and the inputs of the step-up transformers within the power sources were switched so that the two power sources were opposite in phase to each other.

The shield electrodes 7b in the first and second electrode units of all the static eliminating units were all grounded. The film S was set so as to pass through substantially the middle between the first and second ion generating electrodes in the static eliminating units.

As for the distribution of charges of the static-eliminated film S, the distribution of rear side equilibrium potential of the first surface was investigated, and the charge density was determined, on the basis of the aforementioned measuring method. The peak to peak amplitude of the charge density in the cyclically charged portion, and the range of the charge density [unit: μC/m²] in the non-charged portions (portions other than the charged portion), as well as assessment results thereof are shown in Table 1.

Summary of Experiment 1:

As in Table 1, in Example 1, the amount of reduction of the peak to peak amplitude of the charge density in the surfaces of the charged portion was large in all the speeds, although the amount of reduction thereof slightly decreased with increases in the moving speed of the film. Furthermore, the amount of increased charges in the non-charged portions in the film surfaces was very scarce. In Comparative Example 1, there were some speed conditions under which the amount of reduction of the peak to peak amplitude of the charge density in the surfaces of the charged portion was large and some speed conditions under which the amount of increased charges in the non-charged portions was small. However, there were some other speed conditions under which amount of reduction of the peak to peak amplitude of the charge density in the surfaces of the charged portion was small, or which the amount of increased charges in the non-charged portion was heavy. Therefore, in Comparative Example 1, achievement of both reduction of the charge density in the charged portion and restraint of increasing charges of the non-charged portions was not possible in a wide range of speed.

TABLE 1

| | | |
|---|---|---|
| Speed u | | |
| [m/min] | Charged portion*¹ | Non-charged portion |

Example 1

| | | | | |
|---|---|---|---|---|
| Blank | | 190 | | −10-+10 |
| 100 | Best | 0 | Best | −20-−10 |
| 110 | Best | 0 | Best | −20-−10 |
| 150 | Best | 15 | Best | −15-−5 |
| 200 | Best | 25 | Best | −15-−5 |
| 220 | Good | 30 | Best | −10-0 |
| 300 | Good | 60 | Best | −10-0 |

Comparative Example 1

| | | | | |
|---|---|---|---|---|
| Blank | | 190 | | −10-+10 |
| 100 | Best | 0 | No good | −70-+70 |
| 110 | Best | 0 | No good | −350-+350 |
| 150 | Best | 20 | No good | −50-+50 |
| 200 | Good | 30 | Fairly good | −40-+40 |
| 220 | Good | 60, 15*² | No good | −50-+50 |
| 300 | Good | 40 | Good | −30-+30 |

Unit: [μC/m²]
Note
*¹The peak to peak amplitude of the potential in the charged portion does not include the amount of offset caused by the charges of the non-charged portions.
Note
*²As for the charge density in the charged portion at the speed of 220 m/min in Comparative Example 1, sites of great oscillation widths and sites of small oscillation widths appeared in the cycle of about 60 mm, and therefore the values of both the peak to peak amplitude at the sites of great oscillation widths and the peak to peak amplitude at the sites of small oscillation widths are shown.

Experiment 2: A comparative experiment using raw films B, C, with regard to the influence of the polarities of adjacent inter-ion generating electrode potential differences in the case where electrode units 8B (FIG. 12B) (electrode units that are not the ion generating electrode exposed type electrode units) are used and the inter-ion generating electrode potential differences are direct-current potential differences.

### EXAMPLE 2

In the static eliminator 5 as shown in FIG. 5, a biaxially stretched polyethylene terephthalate film (Lumirror 75T10 produced by Toray Industries, Inc., referred to as “raw film B” and “raw film C”) of 300 mm in width and 75 μm in thickness was used as an insulating sheet S, and the film S was moved at a speed of 300 m/min.

The raw film B is a film that has been subjected to a charge process such that in the first surface of the film, positive and negative charges are alternately arranged in the cycle of 5 mm in the traveling direction of the film, and such that the absolute values of the positive and negative peak values of the rear side equilibrium potential are 560 V at maximum (480 to 560 V), that is, the peak to peak amplitude of the charge density is 396 μCC/m² at maximum (340 to 396 μC/m²), and such that at sites whose positions in the in-plane directions are the same, the charged polarity of the first surface of the film and the charged polarity of the second surface thereof are opposite polarities, and the absolute values of the rear side equilibrium potential of the first surface and the rear side equilibrium potential of the second surface are equal.

The raw film C is a film in which the absolute values of the rear side equilibrium potentials of the surfaces thereof are 30 V (the charge density being 10 μC/m²) or less and which is practically non-charged over the entire surfaces.

The normal direction inter-electrode distances d₁₋₁ to d₁₈ were all set at the same distance d₁₀, which was 30 mm. The static eliminating unit intervals d₂₋₁ to d₂₋₇ were all set at a distance d₂₀, which was 40 mm. Other than that, conditions were the same as those in Example 1. Results of evaluation of static elimination of the raw films B, C are shown in Table 2.

The column of “Raw film B” in Table 2 shows the peak to peak amplitudes of the charge density of the film obtained through static elimination of the “raw film B” in order to investigate the degree of reduction from the pre-static elimination peak to peak amplitude of the charge density

The column of “Polarities of the inter-ion generating electrode potential differences” in Table 2 shows, from left toward right in the column, the polarities of the inter-ion generating electrode potential differences sequentially from upstream in the traveling direction of the film S. For example, the indication “++++−−−−” means that the inter-ion generating electrode potential difference is positive in polarity in the most upstream to 4th static eliminating units in the traveling direction of the film S, and the inter-ion generating electrode potential difference is negative in polarity in the following four (5th to 8th) static eliminating units.

### COMPARATIVE EXAMPLE 2

Comparative Example 2 was substantially the same as Example 2, except that positive voltage was applied to the first ion generating electrodes (negative voltage was applied to the second ion generating electrodes) in all the static eliminating units so that the inter-ion generating electrode potential difference was positive in all the static eliminating units. Results of evaluation of static elimination of the raw film B and the raw film C are shown in Table 2.

### EXAMPLE 3

Example 3 was substantially the same as Example 2, except that positive voltage was applied to the first ion generating electrodes (negative voltage was applied to the second ion generating electrodes) of the most upstream (1st) to 6th static eliminating units in the sheet traveling direction of the sheet so that the inter-ion generating electrode potential difference was positive, and negative voltage was applied to the first ion generating electrodes (positive voltage was applied to the second ion generating electrodes) of the 7th and 8th static eliminating units so that the inter-ion generating electrode potential difference was negative. Results of evaluation of static elimination of the raw film B and the raw film C are shown in Table 2.

### EXAMPLE 4

Example 4 was substantially the same as Example 2, except that positive voltage was applied to the first ion generating electrodes (negative voltage was applied to the second ion generating electrodes) of the most upstream (1st) to 4th static eliminating units in the traveling direction of the sheet so that the inter-ion generating electrode potential difference was positive, and negative voltage was applied to the first ion generating electrodes (positive voltage was applied to the second ion generating electrodes) of the 5th to 8th static eliminating units so that the inter-ion generating electrode potential difference was negative. Results of evaluation of static elimination of the raw film B and the raw film C are shown in Table 2.

### EXAMPLE 5

Example 5 was substantially the same as Example 2, except that positive voltage was applied to the first ion generating electrodes (negative voltage was applied to the second ion generating electrodes) of the 1st, 2nd, 5th and 6th static eliminating units in the traveling direction of the sheet so that the inter-ion generating electrode potential difference was positive, and negative voltage was applied to the first ion generating electrodes (positive voltage was applied to the second ion generating electrodes) of the 3rd, 4th, 7th and 8th static eliminating units so that the inter-ion generating electrode potential difference was negative. Results of evaluation of static elimination of the raw film B and the raw film C are shown in Table 2.

Summary of Experiment 2:

From Examples 2 to 5 and Comparative Example 2, it can be understood that the static elimination effect was high in the static eliminator in which the polarities of the inter-ion generating electrode potential differences in ¼ or more (2 or more in these examples) of the total number n (n=8 in these examples) of static eliminating units were opposite to the polarities of the inter-ion generating electrode potential differences in other static eliminating units, that is, ion generating electrodes which irradiate ions of opposite polarities existed along the same surface of the sheet. In particular, it can be understood that the static elimination effect was the highest in the static eliminator of Example 2 in which the polarities of the inter-ion generating electrode potential differences were equal in ½ (4 in these example) of the total number n of the static eliminating units, and the inter-ion generating electrode potential differences were opposite in polarity to each other in adjacent static eliminating units.

Experiment 3: A confirmatory experiment regarding the influences of the adjacent static eliminating unit interval and the polarities of adjacent inter-ion generating electrode direct-current potential differences, in which electrode units 8B (FIG. 12B) (electrode units that are not the ion generating electrode exposed type electrode units) are used.

### EXAMPLE 6

Example 6 was substantially the same as Example 2, except that all the values d₂₀ of the static eliminating unit intervals were set at 70 mm. Results of evaluation of static elimination of the raw film B and the raw film C are shown in Table 2.

### EXAMPLE 7

Example 7 was substantially the same as Example 5, except that, of the static eliminating unit intervals d₂₋₁ to d₂₋₇, the odd number-th static eliminating unit intervals d₂₋₁, d₂₋₃, d₂₋₅, d₂₋₇ were set at 70 mm, and the even number-th static eliminating unit intervals d₂₋₂, d₂₋₄, d₂₋₆ were set at 40 mm. Results of evaluation of static elimination of the raw film B and the raw film C are shown in Table 2.

Summary of Experiment 3:

From Example 2 and Examples 5 to 7, it can be understood that: in the case where the inter-ion generating electrode potential differences in adjacent static eliminating units are opposite in polarity, it is better that the adjacent distance be short to some degree; and in the case where the inter-ion generating electrode potential differences in adjacent static eliminating units are equal in polarity, it is better that the adjacent distance be great to some degree.

Experiment 4: A comparative experiment using electrode units 8B (FIG. 12B) (electrode units that are not the ion generating electrode exposed type electrode units), in the cases where adjacent inter-ion generating electrode potential differences are set as direct-current potential differences of opposite polarities, and as alternating-current potential differences of opposite polarities.

### COMPARATIVE EXAMPLE 3

Comparative Example 3 was substantially the same as Example 2, except that alternating-current voltages having a zero peak value of 8 kV and a frequency of 60 Hz and being opposite in polarity to each other were applied to the first ion generating electrodes and the second ion generating electrodes in the static eliminating units, and that the applied voltages to the first ion generating electrodes of adjacent static eliminating units were set so as to be opposite in phase to each other. Results of evaluation of static elimination of the raw film B and the raw film C are shown in Table 2.

Summary of Experiment 4:

From the comparison between Example 2 and Comparative Example 3, it can be understood that when the alternating-current potential differences were given based on the alternating-current application, an unevenness of charge densities of ±45 μC/m² occurred in the sheet traveling direction. Since in Comparative Example 3, a non-charged film is likely to be charged, it can be understood that it is better to apply the direct-current potential differences based on the direct-current voltage application of Example 2.

TABLE 2

| | | | Static |
|---|---|---|---|
| | Polarity of inter-ion | | eliminating |
| | generating electrode | Application | unit interval |
| | potential difference | method | d₂₀ [mm] |
| Blank | | | |
| Example 2 | +−+−+−+− | DC | 40 |
| Comparative | ++++++++ | DC | 40 |
| Example 2 | | | |
| Example 3 | ++++++−− | DC | 40 |
| Example 4 | ++++−−−− | DC | 40 |
| Example 5 | ++−−++−− | DC | 40 |
| Example 6 | +−+−+−+− | DC | 70 |
| Example 7 | ++−−++−− | DC | 70, 40 |
| Comparative | | AC 60 Hz | 40 |
| Example 3 | | | |

| Charge density [μC/m²] | |
|---|---|
| Raw film B | Raw film C |

| | | | | |
|---|---|---|---|---|
| Blank | | 396 | | −10-+10 |
| Example 2 | Good | 50 | Best | −15-+5 |
| Comparative | Good | 220 | No good | +240-+260 |
| Example 2 | | | | |
| Example 3 | Good | 90 | Best | −15-−5 |
| Example 4 | Good | 140 | Good | −90-−70 |
| Example 5 | Good | 90 | Good | −45-−35 |
| Example 6 | Good | 90 | Best | −15-−5 |
| Example 7 | Good | 70 | Good | −45-−35 |
| Comparative | Good | 90 | No good | −45-+45 |
| Example 3 | | | | |

Experiment 5: A confirmatory experiment regarding the influences of inter-ion generating electrode mean electric field strength 2V₀/d₁₀ (inter-ion generating electrode direct-current potential difference/normal direction inter-electrode distance) and the ripple factor x₀, in which electrode units 8B (FIG. 12B) (electrode units that are not the ion generating electrode exposed type electrode units) are used.

### EXAMPLE 8

The explanation of this example is included in Examples 8-26 described later.

### EXAMPLE 9

The explanation of this example is included in Examples 8-26 described later.

### EXAMPLE 10

The explanation of this example is included in Examples 8-26 described later.

### EXAMPLE 11

The explanation of this example is included in Examples 8-26 described later.

### EXAMPLE 12

The explanation of this example is included in Examples 8-26 described later.

### EXAMPLE 13

The explanation of this example is included in Examples 8-26 described later.

### EXAMPLE 14

The explanation of this example is included in Examples 8-26 described later.

### EXAMPLE 15

The explanation of this example is included in Examples 8-26 described later.

### EXAMPLE 16

The explanation of this example is included in Examples 8-26 described later.

### EXAMPLE 17

The explanation of this example is included in Examples 8-26 described later.

### EXAMPLE 18

The explanation of this example is included in Examples 8-26 described later.

### EXAMPLE 19

The explanation of this example is included in Examples 8-26 described later.

### EXAMPLE 20

The explanation of this example is included in Examples 8-26 described later.

### EXAMPLE 21

The explanation of this example is included in Examples 8-26 described later.

### EXAMPLE 22

The explanation of this example is included in Examples 8-26 described later.

### EXAMPLE 23

The explanation of this example is included in Examples 8-26 described later.

### EXAMPLE 24

The explanation of this example is included in Examples 8-26 described later.

### EXAMPLE 25

The explanation of this example is included in Examples 8-26 described later.

### EXAMPLE 26

The explanation of this example is included in Examples 8-26 described later.

### EXAMPLES 8 TO 26

Examples 8 to 26 were substantially the same as Example 2, except that the normal direction inter-electrode distance d₁₀, the absolute value V₀ of the temporal mean value of direct-current voltage, and the ripple factor x₀ were set as shown in Table 3A. The ripple factor was set by a function generator, and the output waveform of the function generator (waveform prior to voltage amplification) was confirmed by an oscilloscope. The phases of the ripple amounts of the direct-current voltages were set so as to be opposite in phase as in FIG. 7. Results of evaluation of static elimination of the raw film B and the raw film C are shown in Table 3B.

Summary of Experiment 5:

From results of Examples 8 to 26, the static eliminating capability on the raw film B decreases as the inter-ion generating electrode mean electric field strength 2V₀/d₁₀ becomes smaller; however, the raw film C is substantially not affected by the ripple factor. On the other hand, the static eliminating capability on the raw film B increases as 2V₀/d₁₀ becomes greater; however, the peak to peak amplitude of ion attachment to the raw film C becomes greater as the ripple factor becomes greater, and therefore it can be understood that the raw film C is subject to the influence of the ripple factor. Hence, it can be understood that from viewpoints of the static eliminating capability and reduction of the peak to peak amplitude of ion attachment, the ripple factor is preferably 5% or less irrespective of the magnitude of the inter-ion generating electrode mean electric field strength 2V₀/d₁₀, and if the ripple factor exceeds 5%, it is preferable that the magnitude of the inter-ion generating electrode mean electric field strength 2V₀/d₁₀ be smaller than 0.35.

TABLE 3A

| | | | | Normal |
|---|---|---|---|---|
| | Absolute | | | direction |
| | value of | | | inter-ion |
| | temporary | | Normal | generating |
| | mean value of | | direction | electrode mean |
| | applied | Ripple | inter-electrode | electric field |
| | voltage | factor | distance | strength |
| | V₀ [kV] | x₀ [%] | d₁₀ [mm] | 2 V₀/d₁₀ |
| Blank | | | | |
| Example 8 | 8 | 0.1 | 20 | 0.80 |
| Example 9 | 8 | 5 | 20 | 0.80 |
| Example 10 | 8 | 8 | 20 | 0.80 |
| Example 11 | 8 | 10 | 20 | 0.80 |
| Example 12 | 8 | 20 | 20 | 0.80 |
| Example 2 | 8 | 0.1 | 30 | 0.53 |
| Example 13 | 8 | 5 | 30 | 0.53 |
| Example 14 | 8 | 8 | 30 | 0.53 |
| Example 15 | 8 | 10 | 30 | 0.53 |
| Example 16 | 8 | 20 | 30 | 0.53 |
| Example 17 | 8 | 0.1 | 50 | 0.32 |
| Example 18 | 8 | 5 | 50 | 0.32 |
| Example 19 | 8 | 8 | 50 | 0.32 |
| Example 20 | 8 | 10 | 50 | 0.32 |
| Example 21 | 8 | 20 | 50 | 0.32 |
| Example 22 | 4 | 0.1 | 30 | 0.27 |
| Example 23 | 4 | 5 | 30 | 0.27 |
| Example 24 | 4 | 8 | 30 | 0.27 |
| Example 25 | 4 | 10 | 30 | 0.27 |
| Example 26 | 4 | 20 | 30 | 0.27 |

TABLE 3B

| Charged Density [μC/m²] | |
|---|---|
| Raw film B | Raw film C |

| | | | | |
|---|---|---|---|---|
| Blank | | 396 | | −10-+10 |
| Example 8 | Good | 40 | Best | −15-+5 |
| Example 9 | Good | 40 | Best | −15-+5 |
| Example 10 | Good | 50 | Fairly good | −25-+10 |
| Example 11 | Good | 60 | Fairly good | −30-+15 |
| Example 12 | Good | 70 | Fairly good | −50-−30 |
| Example 2 | Good | 50 | Best | −15-+5 |
| Example 13 | Good | 50 | Best | −15-+5 |
| Example 14 | Good | 50 | Fairly good | −20-+10 |
| Example 15 | Good | 60 | Fairly good | −25-+15 |
| Example 16 | Good | 70 | Fairly good | −40-+25 |
| Example 17 | Good | 220 | Best | −15-+5 |
| Example 18 | Good | 220 | Best | −15-+5 |
| Example 19 | Good | 220 | Best | −15-+5 |
| Example 20 | Good | 220 | Best | −20-+5 |
| Example 21 | Good | 220 | Best | −25-+5 |
| Example 22 | Good | 250 | Best | −10-+10 |
| Example 23 | Good | 250 | Best | −10-+10 |
| Example 24 | Good | 250 | Best | −10-+10 |
| Example 25 | Good | 250 | Best | −10-+10 |
| Example 26 | Good | 250 | Best | −15-+10 |

Experiment 6: A comparative experiment using electrode units 8B (FIG. 12B) (electrode units that are not the ion generating electrode exposed type electrode units), in the cases where the most downstream inter-ion generating electrode direct-current potential difference and the normal direction inter-electrode distance of the most downstream static eliminating unit are varied.

### EXAMPLE 27

Example 27 was substantially the same as Example 2, except that the absolute values of the temporal mean values of the direct-current voltages applied to the first ion generating electrode 5d₈ and the second ion generating electrode 5f₈ of the most downstream (8th) static eliminating unit SU₈ in the traveling direction of the film S were set at 5 kV, that is, the absolute value of the inter-ion generating electrode potential difference thereof was set at 10 kV. Results of evaluation of static elimination of the raw film B and the raw film C are shown in Table 4.

### EXAMPLE 28

Example 28 was substantially the same as Example 2, except that only the normal direction inter-electrode distance d₁₋₈ of the most downstream (8th) static eliminating unit SU₈ in the traveling direction of the film S was set at 50 mm. Results of evaluation of static elimination of the raw film B and the raw film C are shown in Table 4.

Summary of Experiment 6:

According to the evaluations through the use of the raw film C, it can be understood that the amount of increased charges of a film that had been non-charged reduced in Examples 27 and 28 rather than in Examples 2. It can be understood that according to the evaluations of static elimination through the use of the raw film B, the static eliminating capability result of Example 27 and 28 was slightly inferior to the result of Example 2, but still of a level of no particular problem.

TABLE 4

| | Applied | | | | | |
|---|---|---|---|---|---|---|
| | voltage to | | | | | |
| | the last | Normal | | | | |
| | unit | direction | | | | |
| | (absolute | inter- | | | | |
| | value of | electrode | | | | |
| | temporal | distance of | | | | |
| | mean value) | the last | | | | |
| | \|V₁₋₈\|, | unit | | | | |
| | \|V₂₋₈\| | d₁₋₈ | Charge density [μC/m²] | | | |
| | [kV] | [mm] | Raw film B | | Raw film C | |
| Blank | | | | 396 | | −10-+10 |
| Example 2 | 8 | 30 | Best | 50 | Best | −15-−5 |
| Example | 5 | 30 | Best | 60 | Best | −10-+10 |
| 27 | | | | | | |
| Example | 8 | 50 | Best | 60 | Best | −10-+10 |
| 28 | | | | | | |

Experiment 7: A comparative experiment using electrode units 8B (FIG. 12B) (electrode units that are not the ion generating electrode exposed type electrode units), in the case where a static eliminating unit having an inter-ion generating electrode alternating-current potential difference was added at the most downstream position.

### EXAMPLE 29

An alternating-current static eliminating unit having first and second ion generating electrodes to which alternating-current voltages were applied was added downstream of the static eliminator of Example 2 in the sheet traveling direction. The electrode units of the alternating-current static eliminating unit were the same as those used in Example 2, and the normal direction inter-electrode distance and the unit interval were the same of Example 2. Alternating-current voltages opposite in polarity to each other and of 4 kV (zero-peak value) and 60 Hz in frequency were applied to the first and second ion generating electrodes of the alternating-current static eliminating unit. Results of evaluation of static elimination of the raw film B and the raw film C are shown in Table 5.

Summary of Experiment 7:

According to the evaluation through the use of the raw film C, it can be understood that the amount of increased charges of a film that had been non-charged reduced in Example 29 rather than in Example 2. Hence, it can be understood that the provision of the static eliminating unit having an alternating-current potential difference at the most downstream position has the effect of reducing the charges in the film surfaces.

TABLE 5

| Charge density [μC/m²] | |
|---|---|
| Raw film B | Raw film C |

| | | | | |
|---|---|---|---|---|
| Blank | | 396 | | −10-+10 |
| Example 2 | Best | 50 | Best | −15-−5 |
| Example 29 | Best | 50 | Best | −10-+10 |

Experiment 8: A supplemental experiment for Experiment 6

### EXAMPLE 30

Example 30 was substantially the same as Example 4, except that the absolute values of the temporal mean values of the direct-current voltages applied to the first ion generating electrode 5d₈ and the second ion generating electrode 5f₈ of the most downstream (8th) static eliminating unit SU₈ in the traveling direction of the film S were set at 5 kV, that is, the absolute value of the inter-ion generating electrode potential difference thereof was set at 10 kV. Results of evaluation of static elimination of the raw film B and the raw film C are shown in Table 6.

### EXAMPLE 31

Example 31 was substantially the same as Example 4, except that only the normal direction inter-electrode distance d₁₋₈ of the most downstream (8th) static eliminating unit SU₈ in the traveling direction of the film S was set at 50 mm. Results of evaluation of static elimination of the raw film B and the raw film C are shown in Table 6.

Summary of Experiment 8:

By comparison, with regard to the raw film C, between the case of Example 4 and the results of Examples 30, 31, the static eliminating capability was somewhat inferior in the evaluation of static elimination using the raw film B; however, the absolute value of the charge density significantly reduced in the evaluation of static elimination using the raw film C. Thus, it can be understood that the amount increased charges of a film having been non-charged can be reduced by reducing the amount of ions attaching to the film from the ion generating electrodes of the most downstream static eliminating unit.

TABLE 6

| | Applied | | | | | |
|---|---|---|---|---|---|---|
| | voltage to | | | | | |
| | the last | Normal | | | | |
| | unit | direction | | | | |
| | (absolute | inter- | | | | |
| | value of | electrode | | | | |
| | temporal | distance of | | | | |
| | mean value) | the last | | | | |
| | \|V₁₋₈\|, | unit | | | | |
| | \|V₂₋₈\| | d₁₋₈ | Charge density [μC/m²] | | | |
| | [kV] | [mm] | Raw film B | | Raw film C | |
| Blank | | | | 396 | | −10-+10 |
| Example 4 | 8 | 30 | Good | 140 | Good | −90-−70 |
| Example | 5 | 30 | Good | 160 | Good | −40-−20 |
| 30 | | | | | | |
| Example | 8 | 50 | Good | 160 | Good | −40-−20 |
| 31 | | | | | | |

Experiment 9: An inspective experiment regarding the relationship between the ripple factor of the inter-ion generating electrode direct-current potential difference and the static eliminating capability.

### EXAMPLE 32

The explanation of this example is included in Examples 32-34 described later.

### EXAMPLE 33

The explanation of this example is included in Examples 32-34 described later.

### EXAMPLE 34

The explanation of this example is included in Examples 32-34 described later.

### EXAMPLES 32 TO 34

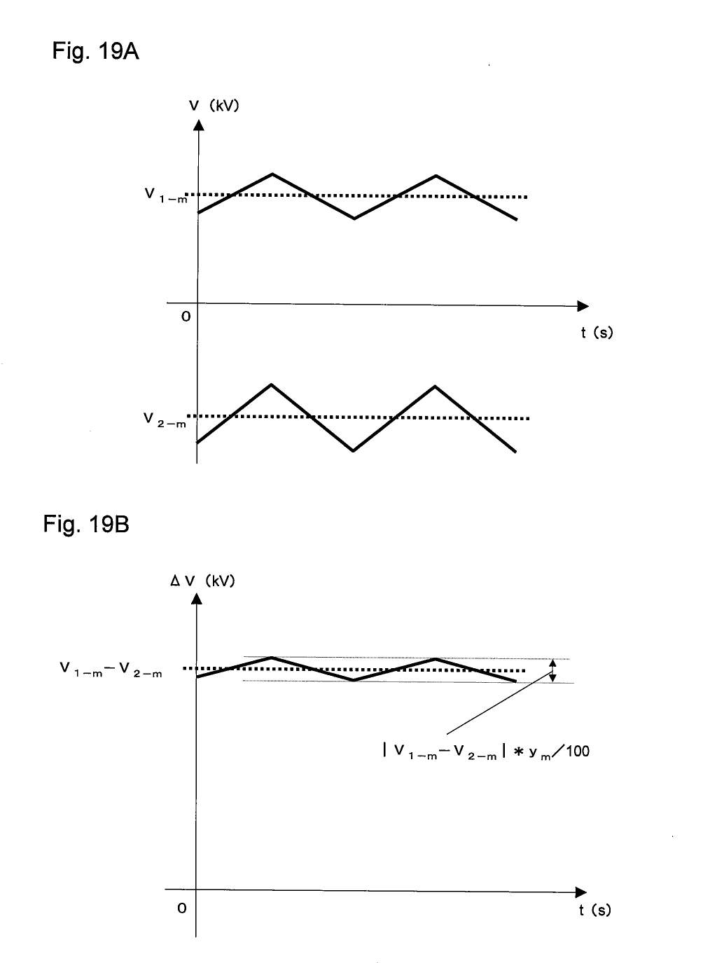

Examples 32 to 34 were substantially the same as Example 2, except that the normal direction inter-electrode distance d₁₀ the absolute value V₀ of the temporal mean value of direct-current voltage, and the ripple factor x₀ were set as in Table 7. The ripple factor was set by a function generator, and the output waveform of the function generator (waveform prior to voltage amplification) was confirmed by an oscilloscope. The phases of the ripple amounts of the direct-current voltages were set so as to be equal in phase as illustrated in FIG. 19A. Results of evaluation of static elimination of the raw film B and the raw film C are shown in Table 7.

Summary of Experiment 9:

If the results of Examples 32 to 34 are compared with those of Examples 10 to 12, it can be understood that there were no differences in the static eliminating capability in the evaluation of static elimination using the raw film B, and the peak to peak amplitude of the charge density was significantly reduced in the evaluation of static elimination using the raw film C. It can be understood that even if the ripple factor of direct-current voltage is 5% or greater, cyclical charges in a film in the traveling direction of the film S having been non-charged is unlikely to be caused provided that the ripple components are equal in phase.

TABLE 7

| | Absolute | | | |
|---|---|---|---|---|
| | value of | | | Normal |
| | temporal | | | direction |
| | mean value | | Normal direction | electric |
| | of applied | Ripple | inter-electrode | field |
| | voltage | factor | distance | strength |
| | V₀ [kV] | x₀ [%] | d₁₀ [mm] | 2V₀/d₁₀ |
| Blank | | | | |
| Example 32 | 8 | 8 | 20 | 0.80 |
| Example 33 | 8 | 10 | 20 | 0.80 |
| Example 34 | 8 | 20 | 20 | 0.80 |

| Charge density [μC/m²] | |
|---|---|
| Raw film B | Raw film C |

| | | | | |
|---|---|---|---|---|
| Blank | | 396 | | −10-+10 |
| Example 32 | Good | 50 | Best | −15-+5 |
| Example 33 | Good | 60 | Best | −15-+5 |
| Example 34 | Good | 70 | Best | −15-+5 |

Experiment 10: Comparison in the static eliminating capability on the charged portion of the film and the non-influence on the non-charged portion of the film, between the ion generating electrode exposed type electrode units 8A (FIG. 12A) and the electrode units 8B (FIG. 12B) that are not the ion generating electrode exposed type electrode units, and comparison in the static eliminating capability on the charged portion of the film and the non-influence on the non-charged portion of the film, in the cases where direct-current static eliminating units and alternating-current static eliminating units are used.

### EXAMPLE 35

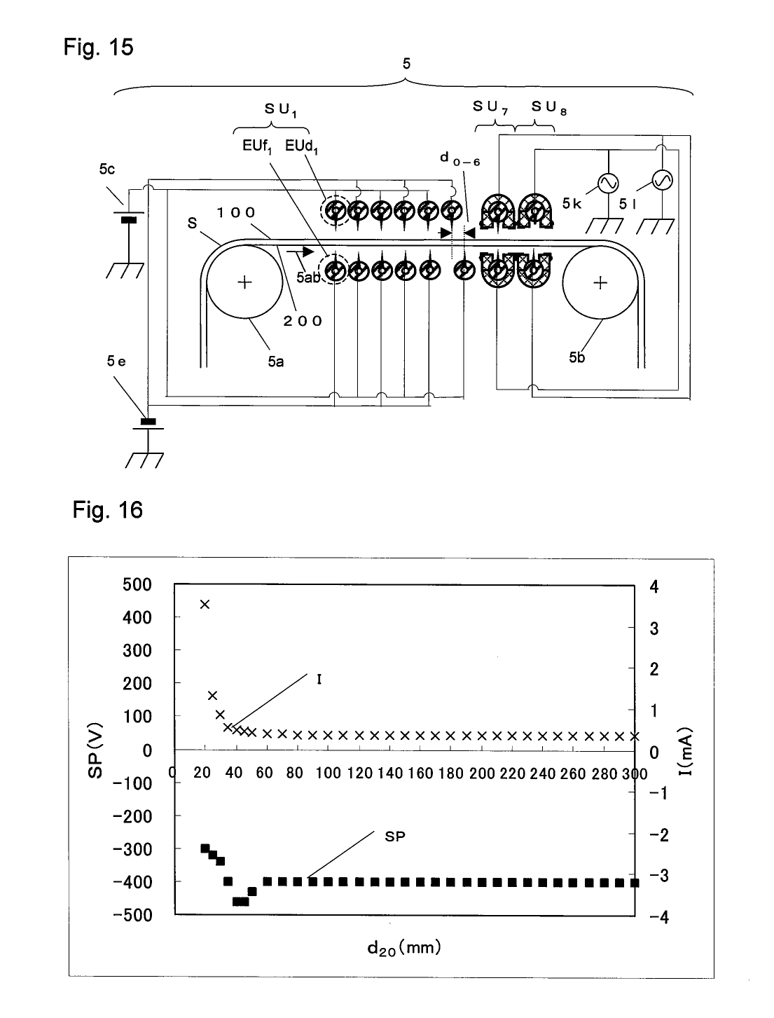

In a static eliminator 5 as shown in FIG. 15, a biaxially stretched polyethylene terephthalate film S (Lumirror 38S28 produced by Toray Industries, Inc., referred to as “raw film A”) of 300 mm in width and 38 μm in thickness was used as an insulating sheet S, and the film S was moved at speeds u [unit: m/min] shown in Table 8. The raw film A includes a raw film A-1 as used in Example 1 or the like, and a raw film A-2 that is greatly different in the amount of charges from the raw film A-1.

Like the raw film A-1, the raw film A-2 had cyclical charges in a range of 10 mm in width as shown in FIG. 10, prior to static elimination. The rear side equilibrium potential of the charges of the cyclically charged portion (portion of A-A′ in FIG. 10) of the raw film A-2 was 1080 V in peak-peak centered at 0 V (the peak to peak amplitude of the charge density of each surface was 760 μC/m²). Incidentally, the intervals between peak portions of the absolute values of the rear side equilibrium potential of the positively charged portions in the cyclically charged portion and peak portions of the absolute values of the rear side equilibrium potential of the negatively charged portions therein are the same as in the raw film A-1. Furthermore, in the case of the raw film A-2, similar to the case of the raw film A-1, the rear side equilibrium potential of the portions of the film S other than the charged portion (portion of 10 mm in width) was 15 V or less in absolute value, and the charge density in each surface was within the range of −10 to +10 μC/m², and it was thus confirmed that the aforementioned portions were substantially non-charged.

As the first and second electrode units, electrode units 8A and electrode units 8B (HER type electrodes, produced by Kasuga Denki, INC.) of FIG. 12A and FIG. 12B were used. As shown in FIG. 12A and FIG. 12B, the ion generating electrodes 5d₁ to 5dₙ and the ion generating electrodes 5fd₁ to 5fₙ are each formed by a needle electrode array 8a (an assembly of partial electrodes 8a₁, 8a₂, . . . ). The electrode units 8A of the ion generating electrode exposed type electrode units that do not have shield electrodes as shown in FIG. 12A, and the electrode units 8B that are not the ion generating electrode exposed type electrode units but have shield electrodes 8b in the vicinities of the ion generating electrodes as shown in FIG. 12B were used in combination.

The intervals d₅ of the needle electrode arrays 8a in the width direction of the film S were 10 mm both in the electrode units 8A, 8B. All the needles in each electrode unit were applied equal voltage so that they had equal potentials. As for the electrode units 8B, the needle electrode arrays 8a and the shield electrodes 8b are insulated from each other by insulating materials (vinyl chloride) 8d, 8e.

The total number n of direct-current static eliminating units was set at 6 (if the alternating-current static eliminating units described below included, the total number was 8). The electrode units 8A of the ion generating electrode exposed type electrode units were used as the upstream-side six static eliminating units SU₁ to SU₆ in the traveling direction of the film S. The electrode units 8B that are not the ion generating electrode exposed type electrode units were used as the downstream side two static eliminating units SU₇, SU₈.

In each static eliminating unit, the first and second electrode units were disposed across the film S orthogonal to the traveling direction of the film S and were parallel with the surfaces of the film S, and so that the point end of each needle electrode of the first electrode unit and point end of each needle electrode of the second electrode unit were faced each other.

However, of the static eliminating units SU₁ to SU₆ disposed at the upstream side in the traveling direction of the film S, with regard to the most downstream 6th static eliminating unit SU₆ alone, the second electrode unit EUf₆ was disposed with a displacement in the traveling direction of the film S so that the electrode discrepancy d₀₋₆ became 25 mm. The other electrode units were disposed so that the electrode discrepancy d₀₋ₖ (k=1, 2, 3, 4, 5, 7, 8) became 0 mm.

The pointed ends of the needles of each needle electrode array, that is, the pointed ends of the ion generating electrodes of each static eliminating unit, were aligned linearly in the width direction of the film S, and the sag of the electrodes in the normal directions and the traveling direction of the film S was ignorably small.

The normal direction inter-electrode distances d₁₋₁ to d₁₋₈ were all set at 40 mm. The static eliminating unit intervals d₂₋₁ to d₂₋₄ were all set at 40 mm, and the static eliminating unit intervals d₂₋₅ and d₂₋₆ were set at 52.5 mm, and the static eliminating unit intervals d₂₋₇ was set at 55 mm.

In each of the six static eliminating units disposed at the upstream side in the traveling direction of the film S, direct-current voltages which were opposite in polarity to each other with respect to a predetermined common potential (0 [unit: V] herein) and whose absolute values had a difference of 0.1 kV or less were applied to the first ion generating electrode and the second ion generating electrode facing each other.

A positive direct-current voltage was applied to the first ion generating electrodes of the odd number-th (1st, 3rd, 5th) static eliminating units from the most upstream point in the traveling direction of the film S so that the inter-ion generating electrode potential difference became positive in polarity. A negative direct-current voltage was applied to the first ion generating electrodes of the even number-th (2nd, 4th, 6th) static eliminating units from the most upstream point in the traveling direction of the film S so that the inter-ion generating electrode potential difference became negative in polarity. The temporal mean values of the absolute values of the applied voltages were each set at 8 kV, that is, set so that the absolute value of the inter-ion generating electrode potential difference in each static eliminating unit became 16 kV.

The ripple components were saw tooth waves, with the ripple factor being 0.1% or less for both the positive direct-current voltage and the negative direct-current voltage. As for the application of direct-current voltages, direct-current voltage outputs from two (one for applying positive voltage, another for applying negative voltage) function generators (each of which was a Function Synthesizer 1915 produced by NF Corporation) which were amplified by two (one for applying positive voltage, another for applying negative voltage) high-voltage power sources (each of which was a MODEL 20/20B produced by TRek, Inc.) were used.

The ripple factor of the direct-current applied voltage was checked with an oscilloscope (54540C of Hewlett Packard Japan, Ltd.), and was found to be 0.1% or less. The amplification factor of the high-voltage power sources is 2000 times, and the precision thereof is 0.1%.

In each of the two static eliminating units SU₇, SU₈ disposed at the downstream side in the traveling direction of the film S, alternating-current voltages of 60 Hz opposite in polarity to each other with reference to a predetermined common potential (0 [unit: V] herein) were applied to the first ion generating electrode and the second ion generating electrode facing each other from alternating-current high-voltage power sources 5k and 5l (FIG. 9) (PAD-101 model produced by Kasuga Denki, INC.), and the effective value thereof was set at 7 kV. Alternating-current voltages of 60 Hz opposite in polarity to each other were applied to the first ion generating electrodes 5d₇, 5d₈ adjacent in the traveling direction of the film S, and the effective value thereof was set at 7 kV.

The shield electrodes 5g₇, 5g₈, 5h₇, 5h₈ of the alternating-current electrode units of the two static eliminating units SU₇, SU₈ disposed at the downstream side in the traveling direction of the film S were all grounded to the earth, and the potential thereof were 0 [unit: V]. The opening widths SOg₇ and SOg₈, and SOh₇ and SOh₈ of the shield electrodes of the electrode units of the two alternating-current static eliminating units SU₇, SU₈ were all set at 18 mm, and the shortest distances between the pointed ends of the ion generating electrodes and the shield electrodes were all set at 12 mm. The film S was set so as to pass through substantially the middle between the first and second ion generating electrodes in the static eliminating units.

As for the distribution of charges of the static-eliminated film S, the rear side equilibrium potential of the first surface was investigated, and the charge density was determined, on the basis of the aforementioned measuring method. The peak to peak amplitudes of the charge densities in the cyclically charged portions of the raw film A-1 and the raw film A-2 and the range of the charge density [unit: μC/m²] in the non-charged portions (portions other than the charged portion) of the raw film A-2 as well as assessment results thereof are shown in Table 8.

### COMPARATIVE EXAMPLE 4

In a static eliminator 6 as shown in FIG. 13, a raw film A-2 as used in Example 35 was used as an insulating sheet S. Other than that, substantially the same conditions as in Comparative Example 1 were adopted to carry out evaluation. The film S was moved at speeds u [unit: m/min] as shown in Table 8.

As for the distribution of charges of the static-eliminated film S, the rear side equilibrium potential of the first surface was investigated, and the charge density was determined, on the basis of the aforementioned measuring method. The peak to peak amplitude of the charge density in the cyclically charged portion of the raw film A-2 and the range of the charge density [unit: μC/m²] in the non-charged portions (portions other than the charged portion) of the raw film A-2 as well as assessment results thereof are shown in Table 8.

### EXAMPLE 36

In the static eliminator 5 as shown in FIG. 15, a raw film A-2 charged in the same manner as in Example 35 was used as an insulating sheet S, and was moved at speeds u [unit: m/min] shown in Table 8. The other conditions were the same as in Example 1. As for the distribution of charges of the static-eliminated film S, the rear side equilibrium potential of the first surface was investigated, and the charge density was determined, on the basis of the aforementioned measuring method. The peak to peak amplitude of the charge density in the cyclically charged portion of the raw film A-2 and the range of the charge density in the non-charged portions (portions other than the charged portion) of the raw film A-2 as well as assessment results thereof are shown in Table 8.

### EXAMPLE 37

In the static eliminator 5 using Example 1, the second electrode unit EUf₆ of the 6th static eliminating unit SU₆ was disposed with a displacement in the traveling direction of the film S so that the electrode discrepancy d₀₋₆ thereof became 25 mm. The other electrode units were disposed so that the electrode displacement amount d₀₋ₖ (k=1, 2, 3, 4, 5, 7, 8) became 0 mm. In each of the two static eliminating units SU₇, SU₈ disposed at the downstream side in the traveling direction of the film S, alternating-current voltages of 60 Hz opposite in polarity to each other were applied to the first ion generating electrode and the second ion generating electrode facing each other from an alternating-current high-voltage power source (PAD-101 Model produced by Kasuga Denki, Inc.), and the effective value thereof was set at 7 kV.

Alternating-current voltages of 60 Hz opposite in polarity to each other were applied to the first ion generating electrodes 5d₇, 5d₈ adjacent in the traveling direction of the film S, and the effective value thereof was set at 7 kV. The other conditions were the same as in Example 1.

As for the distribution of charges of the static-eliminated film S, the rear side equilibrium potential of the first surface was investigated, and the charge density was determined, on the basis of the aforementioned measuring method. The peak to peak amplitudes of the charge densities in the cyclically charged portions of the raw film A-1 and the raw film A-2 and the range of the charge density in the non-charged portions (portions other than the charged portion) of the raw film A-2 as well as assessment results thereof are shown in Table 8.

Summary of Experiment 10:

As in Table 8, in Example 35, the amount of reduction of the peak to peak amplitude of the charge density in each surface of the charged portion was significantly large, in any speed, although the amount of reduction thereof slightly decreased with increases in the moving speed of the film. Furthermore, the amount of increased charges in the non-charged portions in the film surfaces was very scarce. However, in Comparative Example 4, it can be understood that the reduction in the charge density in the charged portion and restriction of increased charges in the non-charged portion cannot be achieved in wide range of the speeds, like in Comparative Example 1. By comparison of Examples 35, 36, 37, it can be understood that Example 35 has a high static eliminating capability.

Reasons for this considered to be that, due to the ion generating electrode exposed type electrode units, leakage of the generated ions to the earth through shield electrodes is prevented, so that most of the generated ions attach to the surfaces of the film S, and that in comparison with the case where the electrode units are not the ion generating electrode exposed type electrode units, the electric field between the facing ion generating electrodes is stronger, and the acceleration force on the generated ions in the normal direction of the film S is stronger, and therefore large amounts of ions attach to the surfaces of the film S.

The output current supplied from the power source to the ion generating electrodes in the case of Example 35 is a half or less of those in the cases of Examples 1, 36 and 37, and therefore the output current capacity of the power source is allowed to be small. Thus, the possibility of a significant reduction in the equipment cost is great. However, if electrode units that are not the ion generating electrode exposed type electrode units, as used in Examples 1, 36 and 37 are employed, there is no practical problem. Furthermore, the amount of increased charges in the non-charged portions was very scare.

TABLE 8

| | | |
|---|---|---|
| Raw film | Raw film | Raw film |
| A-1 | A-2 | A-2 |

| | | | | | |
|---|---|---|---|---|---|
| Speed u | Charged | Charged | Non-charged | Charged | Non-charged |
| [m/min] | portion*1 | portion*1 | portion | portion*1 | portion |

| | Example 35 | | | | | | Comparative Example 4 | | | |
|---|---|---|---|---|---|---|---|---|---|---|
| Blank | | 190 | | 760 | | −10-+10 | | 760 | | −10-+10 |
| 100 | Best | 0 | Best | 0 | Best | −40-−30 | Good | 320 | No good | −70-+70 |
| 110 | Best | 0 | Best | 0 | Best | −40-−30 | Good | 320 | No good | −350-+350 |
| 150 | Best | 0 | Best | 20 | Best | −30-−20 | Good | 360 | No good | −50-+50 |
| 200 | Best | 0 | Best | 25 | Best | −20-−10 | Good | 400 | Fairly good | −40-+40 |
| 220 | Best | 0 | Good | 40 | Best | −20-−10 | Good | 420, 490*2 | No good | −50-+50 |
| 300 | Best | 10 | Good | 80 | Best | −10-+10 | Good | 500 | Good | −30-+30 |
| | Example 37 | | | | | | Example 36 | | | |
| Blank | | 190 | | 760 | | −10-+10 | | 760 | | −10-+10 |
| 100 | Best | 0 | Good | 320 | Best | −10-+10 | Good | 280 | Best | −20-−10 |
| 110 | Best | 0 | Good | 320 | Best | −10-+10 | Good | 280 | Best | −20-−10 |
| 150 | Good | 50 | Good | 370 | Best | −10-+10 | Good | 340 | Best | −15-−5 |
| 200 | Good | 70 | Good | 410 | Best | −10-+10 | Good | 390 | Best | −15-−5 |
| 220 | Good | 80 | Good | 430 | Best | 0-+10 | Good | 390 | Best | −10-0 |
| 300 | Good | 100 | Good | 480 | Best | 0-+10 | Good | 450 | Best | −10-0 |

Note *1 and Note *2 are the same as the notes of Table 1.

Experiment 11: Demonstration of the influence of the polarities of the inter-ion generating electrode potential differences of adjacent static eliminating units and the static eliminating unit intervals on the static eliminating capability, using electrode units 8B (FIG. 12A) (the ion generating electrode exposed type electrode units).

### EXAMPLE 38

In the static eliminating units SU₁ to SU₆ constructed of the ion generating electrode exposed type electrode units of static eliminator 5 of Example 35, the static eliminating unit intervals d₂₋₁ to d₂₋₄ were all set at 30 mm, the static eliminating unit intervals d₂₋₅ and d₂₋₆ were set at 42.5 mm. Other than these, Example 38 was the same as Example 35.

As for the distribution of charges of the static-eliminated film S, the rear side equilibrium potential of the first surface was investigated, and the charge density was determined, on the basis of the aforementioned measuring method. The peak to peak amplitude of the charge density in the cyclically charged portion of the raw film A-2 and the range of the charge density in the non-charged portions (portions other than the charged portion) of the raw film A-2 as well as assessment results thereof are shown in Table 9.

### EXAMPLE 39

In the static eliminating units SU₁ to SU₆ constructed of the ion generating electrode exposed type electrode units of static eliminator 5 of Example 35, the static eliminating unit intervals d₂₋₁ to d₂₋₄ were all set at 70 mm, the static eliminating unit intervals d₂₋₅ and d₂₋₆ were set at 82.5 mm. Other than these, Example 39 was the same as Example 35.

As for the distribution of charges of the static-eliminated film S, the rear side equilibrium potential of the first surface was investigated, and the charge density was determined, on the basis of the aforementioned measuring method. The peak to peak amplitude of the charge density in the cyclically charged portion of the raw film A-2 and the range of the charge density in the non-charged portions (portions other than the charged portion) of the raw film A-2 as well as assessment results thereof are shown in Table 9.

Summary of Experiment 11:

With regard to Examples 35, 38, 39 shown in Table 9, in the case where the inter-ion generating electrode potential differences adjacent in the traveling direction of the film S are opposite in polarity, the ions generated from each ion generating electrode are likely to combine and neutralize with ions of an opposite polarity generated from an ion generating electrode that is disposed at the same surface side of the film S and that is adjacent in the traveling direction of the film S if the intervals between the static eliminating units adjacent in the traveling direction of the film S is smaller than 0.8 times the normal direction inter-electrode distance of each static eliminating unit. The amounts of ions attaching to the surfaces of the film S correspondingly reduce. Therefore, it can be understood that the static eliminating capability is higher if the intervals between static eliminating units adjacent in the traveling direction of the film S are greater than the normal direction inter-electrode distances of the static eliminating units.

If the static eliminating unit intervals are increased as in Example 39, the static eliminating capability slightly declines in comparison with Example 35, but only to a level of no particular problem, and on the other hand, the dimension of the apparatus in the film traveling direction increases. Therefore, in this case, there is a need to secure a sufficient installation space for the apparatus. The charges of a non-charged portion are of a level of no particular problem in either case.

TABLE 9

| Example 35 | |
|---|---|
| Raw film A-1 | Raw film A-2 |

| Speed u | Charged portion | | Charged portion | | | |
|---|---|---|---|---|---|---|
| [m/min] | *1 | | *1 | | Non-charged portion | |
| Blank | | 190 | | 760 | | −10-+10 |
| 100 | Best | 0 | Best | 0 | Best | −40-−30 |
| 110 | Best | 0 | Best | 0 | Best | −40-−30 |
| 150 | Best | 0 | Best | 20 | Best | −30-−20 |
| 200 | Best | 0 | Best | 25 | Best | −20-−10 |
| 220 | Best | 0 | Good | 40 | Best | −20-−10 |
| 300 | Best | 10 | Good | 80 | Best | −10-+10 |

| | Example 38 | | | | Example 39 | | | |
|---|---|---|---|---|---|---|---|---|
| | Raw film A-2 | | | | Raw film A-2 | | | |
| Speed u | Charged portion | | Non-charged | | Charged portion | | Non- | |
| [m/min] | *1 | | portion | | *1 | | charged portion | |
| Blank | | 760 | | −10-+10 | | 760 | | −10-+10 |
| 100 | Good | 300 | Best | −10-0 | Best | 0 | Best | −10-0 |
| 110 | Good | 300 | Best | −10-0 | Best | 30 | Best | −10-0 |
| 150 | Good | 400 | Best | −10-0 | Good | 50 | Best | −10-0 |
| 200 | Good | 460 | Best | −10-0 | Good | 60 | Best | −10-0 |
| 220 | Good | 470 | Best | −10-+10 | Good | 100 | Best | −10-+10 |
| 300 | Good | 630 | Best | −10-+10 | Good | 140 | Best | −10-+10 |

Unit [μC/m²]

Experiment 12: Demonstration of the influence of the relationship between the static eliminating unit interval and the normal direction inter-electrode distance on the static eliminating capability.

### EXAMPLE 40

Of the static eliminating units SU₁ to SU₆ constructed of the ion generating electrode exposed type electrode units, not having a shield electrode of static eliminator 5 in a construction of Example 35, with regard to the static eliminating units other than SU₁, SU₂, the direct-current voltage application was stopped so that the inter-ion generating electrode potential difference was 0 V. Also with regard to the alternating-current static eliminating units SU₇, SU₈, the alternating-current voltage application was stopped. Other than these, Example 40 was the same as Example 35.

The length of each static eliminating unit in the sheet width direction was about 500 mm, in which a length where ion generating electrodes were arranged was about 400 mm. In this state, the raw film A-2 was moved at a speed of 10 m/min, with the static eliminating unit interval d₂₋₁ between the static eliminating units SU₁, SU₂ being a variation parameter.

Results of investigation of the rear side equilibrium potential of the first surface, with respect to the non-charged portions of the raw film A-2 (portions other than the charged portion), on the basis of the aforementioned measuring method, and results of investigation of indicated values of an output current meter that accompanied the direct-current power source used are shown in the graph of FIG. 16.

Summary of Experiment 12:

From the graph of FIG. 16, it can be understood that if the static eliminating unit interval is approximate to the normal direction inter-electrode distance (40 mm), the absolute value of the rear side equilibrium potential becomes greater, in other words, the amount of ion attachment to the film surfaces increases, and that if the static eliminating unit interval is further increased, a substantially constant ion attachment amount is obtained although the absolute value of the rear side equilibrium potential, that is, the amount of ion attachment, declines. It can be understood that if the static eliminating unit interval is made smaller, the output electric current from the direct-current power source increases while the absolute value of the rear side equilibrium potential, that is, the ion attachment amount, declines; that is, the ion attachment efficiency of generated ions to the film surface deteriorates.

Experiment 13: Comparison in the ion attachment efficiency between the electrode units 8A (FIG. 12A) (the ion generating electrode exposed type electrode units) and the shield type electrode units 8B (FIG. 12B) (electrode units that are not the ion generating electrode exposed type electrode units).

### REFERENCE EXAMPLE 1

In a construction of static eliminator 5 of Example 40, only the 1st static eliminating unit constructed of ion generating electrode exposed type electrode unit was used and, for the ion generating electrodes of the other static eliminating units, the application of direct-current voltage was stopped. The static eliminating unit intervals d₂₋₁ between the static eliminating units SU₁, SU₂ was set constant at 40 mm. All the portions of ion generating electrodes at sites where the film was not present between ion generating electrodes facing each other were covered with other films. Other than these, Reference Example 1 was the same as Example 40.

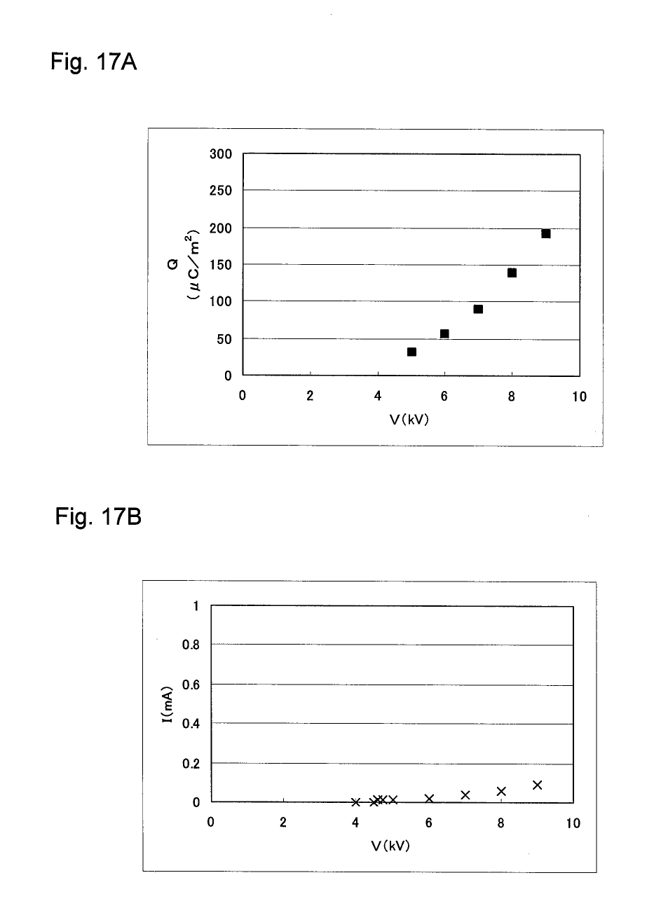

In this state, a raw film A-2 was moved at a speed of 100 m/min, and the rear side equilibrium potential of the first surface was investigated with respect to the non-charged portions of the raw film A-2 (portions other than the charged portion), on the basis of the aforementioned measuring method, with the temporal mean value of the absolute values of the direct-current applied voltages to the ion generating electrodes of the 1st static eliminating unit being a variation parameter. Results are shown in the graph of FIG. 17A. The indicated values of an output electric current meter that accompanied the direct-current power source used were investigated. Results are shown in the graph of FIG. 17B.

### REFERENCE EXAMPLE 2

Each of the electrode units of the 1st static eliminating unit constructed by an ion generating electrode exposed type electrode unit of static eliminator 5 in a construction of Reference Example 1 was constructed by an electrode unit that is not the ion generating electrode exposed type electrode unit but had a shield electrode. The arrangement of the shield electrodes was the arrangement described with Example 36. The other conditions were the same as in Reference Example 1.

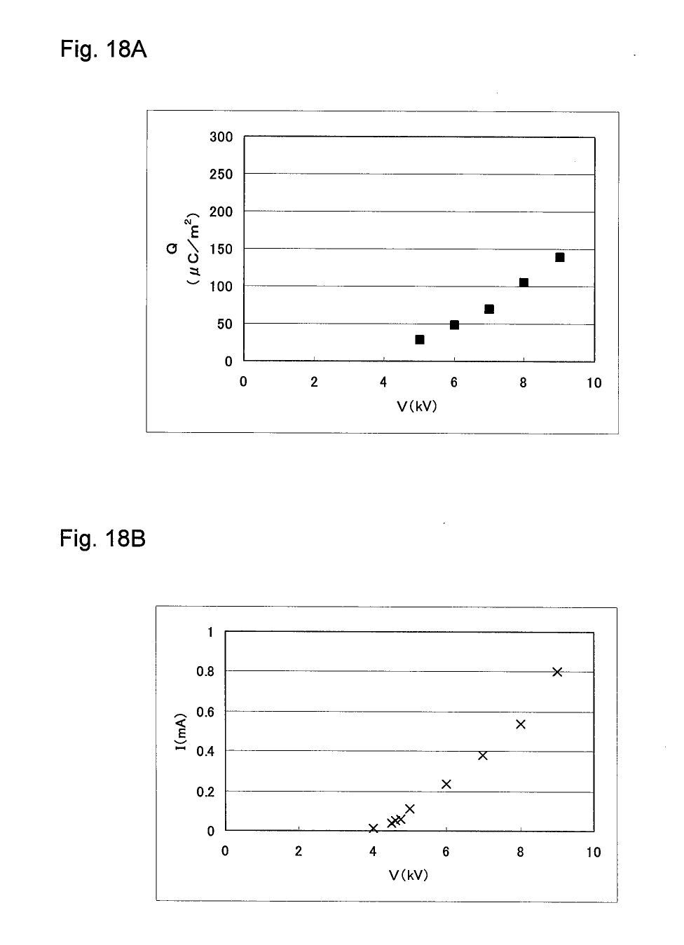

In this state, a raw film A-2 was moved at a speed of 100 m/min, and the rear side equilibrium potential of the first surface was investigated with respect to the non-charged portions of the raw film A-2 (portions other than the charged portion), on the basis of the aforementioned measuring method, where the temporal mean values of the absolute values of the direct-current applied voltages to the ion generating electrodes of the 1st static eliminating unit were used as variation parameters. Results are shown in the graph of FIG. 18A. The indicated values of an output electric current meter that accompanied the direct-current power source used were investigated. Results are shown in the graph of FIG. 18B.

Summary of Experiment 13:

From comparison of the graphs of FIG. 17A, FIG. 17B, FIG. 18A and FIG. 18B, the use of the electrode units constructed by the ion generating electrode exposed type electrode units creates a state where the output electric current supplied from the power source to the ion generating electrodes is less due to absence of the leakage electric current from the grounded shield electrodes, if equal inter-ion generating electrode potential differences are given. Furthermore, an increase of about 30% in the rear side equilibrium potential (that is, the amount of ion attachment to the film surfaces) becomes possible, so that an improvement in the efficiency of ion attachment to the film surfaces and a size reduction of the power source capacity can be realized.

Experiment 14: Comparison of the amount of residual charges in the non-charged portion of the sheet of various embodiments.

### EXAMPLE 41-1

A raw film A-2 subjected to the same charges as in Example 35 was used as an electrical insulating sheet S. Of the static eliminator 5 in a construction of Example 35, the alternating-current voltage application to the first and second ion generating electrodes of the two static eliminating units SU₇, SU₈ disposed at the downstream side of the static eliminator 5 in a construction of Example 35 was stopped. The range of charge density in the non-charged portions of the raw film A-2 (portions other than the charged portion) obtained after the film S was moved at 100 m/min and static-eliminated in the aforementioned state, as well as assessment results thereof, are shown in Table 10.

### EXAMPLE 41-2

A raw film A-2 subjected to the same charges as in Example 35 was used as an electrical insulating sheet S. Of the static eliminator 5 in a construction of Example 41-1, the electrode discrepancy d₀₋ₙ of the static eliminating unit SU₆ disposed in the sixth place in the traveling direction of the film S was set at 0 mm, and the static eliminating unit intervals d₂₋₅, d₂₋₆ were set at 40 mm. Other than these, the same conditions as in Example 41-1 were adopted. The range of charge density in the non-charged portions of the raw film A-2 (portions other than the charged portion) obtained after the film S was moved at 100 m/min and static-eliminated in the aforementioned state, as well as assessment results thereof, are shown in Table 10.

### EXAMPLE 41-3

A raw film A-2 subjected to the same charges as in Example 35 was used as an electrical insulating sheet S, Of the static eliminator 5 in a construction of Example 41-2, the temporal mean values of the absolute values of the direct-current applied voltages applied to the first ion generating electrode 5d₆ and the second ion generating electrode 5f₆ of the 6th static eliminating unit SU₆ in the traveling direction of the film S were set at 5 kV. The other conditions were the same as in Example 41-2. The range of charge density in the non-charged portions of the raw film A-2 (portions other than the charged portion) obtained after the film S was moved at 100 m/min and static-eliminated in the aforementioned state, as well as assessment results thereof, are shown in Table 10.

### EXAMPLE 41-4

A raw film A-2 subjected to the same charges as in Example 35 was used as an electrical insulating sheet S, and Of the static eliminator in a construction of Example 41-2, only the normal direction inter-electrode distance d₁₋₆ of the 6th static eliminating unit SU₆ in the traveling direction of the film S was set at 60 mm. The other conditions were the same as in Example 41-2. The range of charge density in the non-charged portions of the raw film A-2 (portions other than the charged portion) obtained after the film S was moved at 100 m/min and static-eliminated in the aforementioned state, as well as assessment results thereof, are shown in Table 10.

### EXAMPLE 41-5

A raw film A-2 subjected to the same charges as in Example 35 was used as an electrical insulating sheet S. Of the static eliminator 5 in a construction of Example 41-2, the electrode units of the two static eliminating units SU₁, SU₂ being the most upstream in the traveling direction of the film S were the ion generating electrode exposed type electrode units not having a shield electrode, and the other static eliminating units SU₃ to SU₈ had electrode units that were not the ion generating electrode exposed type electrode units but had shield electrodes. Other than these, Example 41-5 was the same as Example 41-2. The range of charge density in the non-charged portions of the raw film A-2 (portions other than the charged portion) obtained after the film S was moved at 100 m/min and static-eliminated in the aforementioned state, as well as assessment results thereof, are shown in Table 10.

### EXAMPLE 41-6

A raw film A-2 subjected to the same charges as in Example 35 was used as an electrical insulating sheet S. Of the static eliminator 5 in a construction of Example 41-2, alternating-current voltages were applied to the first and second ion generating electrodes of the two static eliminating units SU₇, SU₈ disposed in the downstream side in the traveling direction of the film S, and the direct-current voltage application to the ion generating electrodes of the two static eliminating units SU₁, SU₂ from a most upstream point in the traveling direction of the film S was stopped. Other than these, the same conditions as in Example 41-2 were adopted. The range of charge density in the non-charged portions of the raw film A-2 (portions other than the charged portion) obtained after the film S was moved at 100 m/min and static-eliminated in the aforementioned state, as well as assessment results thereof, are shown in Table 10.

### EXAMPLE 41-7

A raw film A-2 subjected to the same charges as in Example 35 was used as an electrical insulating sheet S. Of the static eliminator 5 in a construction of Example 35, the direct-current voltage application to the ion generating electrodes of the two static eliminating units SU₁, SU₂ from a most upstream point in the traveling direction of the film S was stopped. Other than these, the same conditions as in Example 35 were adopted. The range of charge density in the non-charged portions of the raw film A-2 (portions other than the charged portion) obtained after the film S was moved at 100 m/min and static-eliminated in the aforementioned state, as well as assessment results thereof, are shown in Table 10.

Summary of Experiment 14:

It can be understood, from results of Example 41-2, that the charges may increase in some cases even if six electrode units are used for static elimination of the film S. On the other hand, from results of Examples 41-1, 41-3 to 41-7, it can be understood that it is possible to improve the level of charges of the non-charged portions of the film S by contriving so as to reduce the amount of ion attachment to the surfaces of the film S, namely, applying alternating-current voltages, or securing an electrode discrepancy, or disposing electrode units that are not the ion generating electrode exposed type electrode units but have shield electrodes, or reducing the direct-current applied voltage, or increasing the normal direction inter-electrode distance, etc., with respect to downstream-side static eliminating units of the static eliminating units disposed in the traveling direction of the film S.

TABLE 10

| | Construction | | | | |
|---|---|---|---|---|---|
| | | Electric | | | |
| | | potential | Potential | | |
| | | difference | difference | | |
| | Elec- | of direct- | of direct- | | Normal |
| | trode | current | current | Alternating- | direction |
| | dis- | static | static | current | inter- |
| | crep- | eliminating | eliminating | static | electrode |
| | ancy | units | units | eliminating | distance |
| | d₀₋₆ | SU₁, SU₂ | SU₃-SU₆ | units | d₁₋₆ |
| | [mm] | [kV] | [kV] | SU₇, SU₈ | [mm] |
| Blank | | | | | |
| Example | 25 | ±16 | ±16 | OFF | 40 |
| 41-1 | | | | | |
| Example | 0 | ↓ | ↓ | ↓ | 40 |
| 41-2 | | | | | |
| Example | 0 | ↓ | ↓ | ↓ | 40 |
| 41-3 | | | | | |
| Example | 0 | ↓ | ↓ | ↓ | 60 |
| 41-4 | | | | | |
| Example | 0 | ↓ | ↓ | ↓ | 40 |
| 41-5 | | | | | |
| Example | 0 | 0 | ↓ | ON | 40 |
| 41-6 | | | | | |
| Example | 25 | 0 | ↓ | ON | 40 |
| 41-7 | | | | | |

| | Construction | | | |
|---|---|---|---|---|
| | SU₆ | Ion generating | Charges of non-charged | |
| | potential | electrode | portion (100 m/min) | |
| | difference | exposed type | | Charge density |
| | [kV] | electrode unit | Assessment | [μC/m²] |
| Blank | | | Best | −10-+10 |
| Example | −16 | SU₁-SU₆ | Good | −50-−40 |
| 41-1 | | | | |
| Example | −16 | ↓ | Good | −100-−90 |
| 41-2 | | | | |
| Example | −10 | ↓ | Good | −40-−30 |
| 41-3 | | | | |
| Example | −16 | ↓ | Good | −40-−30 |
| 41-4 | | | | |
| Example | ↓ | SU₁-SU₂ | Good | −50-−40 |
| 41-5 | | | | |
| Example | ↓ | SU₁-SU₆ | Good | −60-−40 |
| 41-6 | | | | |
| Example | ↓ | ↓ | Good | −40-−20 |
| 41-7 | | | | |

Experiment 15: Comparison in the static eliminating capability and the amount of residual charges in the non-charged portions of the sheet depending on the arrangement of polarities of the inter-ion generating electrode potential differences in the static eliminating units, using electrode units 8A (FIG. 12A) (the ion generating electrode exposed type electrode units).

### EXAMPLE 42-1

In the static eliminator used in Example 35, a direct-current positive voltage was applied to the first ion generating electrodes of the 1st, 2nd, 3rd and 4th static eliminating units SU₁ to SU₄ from the upstream side in the traveling direction of the film S so as to bring about a state where the inter-ion generating electrode potential difference was positive, and a direct-current negative voltage was applied to the first ion generating electrodes of the 5th and 6th static eliminating units SU₅, SU₆ so as to bring about a state where the inter-ion generating electrode potential difference was negative, and the alternating-current voltage application to the ion generating electrodes of the 7th static eliminating unit SU₇ and the 8th static eliminating unit SU₈ was stopped. The other conditions were the same as in Example 35. The peak to peak amplitude of the charge density in the cyclically charged portion of the raw film A-2 and the range of the charge density in the non-charged portions of the raw film A-2 obtained when the film S was moved at 100 m/min, as well as assessment results thereof, are shown in Table 11.

### EXAMPLE 42-2

In the static eliminator 5 used in Example 42-1, a positive voltage was applied to the first ion generating electrodes of the 1st, 2nd and 5th static eliminating units SU₁, SU₂, SU₅ from the upstream side in the traveling direction of the film S so that the inter-ion generating electrode potential difference became positive in polarity, and a negative voltage was applied to the first ion generating electrodes of the 3rd, 4th and 6th static eliminating units SU₃, SU₄ and SU₆ so that the inter-ion generating electrode potential difference became negative in polarity. The other conditions were the same as in Example 42-1. The peak to peak amplitude of the charge density in the cyclically charged portion of the raw film A-2 and the range of the charge density in the non-charged portions of the raw film A-2 obtained when the film S was moved at 100 m/min, as well as assessment results thereof, are shown in Table 11.

### EXAMPLE 42-3

In the static eliminator 5 used in Example 42-1, a positive voltage was applied to the first ion generating electrodes of the 1st and 6th static eliminating units SU₁, SU₅ from the upstream side in the traveling direction of the film S so that the inter-ion generating electrode potential difference became positive in polarity, and a negative voltage was applied to the first ion generating electrodes of the 2nd, 3rd, 4th and 5th static eliminating units SU₂, SU₃, SU₄ and SU₅ so that the inter-ion generating electrode potential difference became negative in polarity. The other conditions were the same as in Example 42-1. The peak to peak amplitude of the charge density in the cyclically charged portion of the raw film A-2 and the range of the charge density in the non-charged portions of the raw film A-2 obtained when the film S was moved at 100 m/min, as well as assessment results thereof, are shown in Table 11.

### COMPARATIVE EXAMPLE 5

In the static eliminator 5 used in Example 42-1, a positive voltage was applied to the first ion generating electrodes of the 1st to 6th static eliminating units SU₁ to SU₆ from the upstream side in the traveling direction of the film S so that the inter-ion generating electrode potential difference became positive in polarity. The other conditions were the same as in Example 42-1. The peak to peak amplitude of the charge density in the cyclically charged portion of the raw film A-2 and the range of the charge density in the non-charged portions of the raw film A-2 obtained when the film S was moved at 100 m/min, as well as assessment results thereof, are shown in Table

Summary of Experiment 15:

From Examples 41-1, 42-1, 42-2 and 42-3, and Comparative Example 5, it can be understood that increased charges of a non-charged portion of the film S is rare with regard to a static eliminator in which inter-ion generating electrode potential differences in ¼ or more (2 or more in these examples) of the total number n (n=6 in these examples) of static eliminating units to which direct-current voltage is applied are opposite in polarity to the other static eliminating unit.

From Comparative Example 5, it can be understood that in the case where the inter-ion generating electrode potential differences are all equal in polarity in the static eliminating units, the increased charges of non-charged portions of the film S are large.

It can be understood from Example 41-1 that a construction in which the inter-ion generating electrode potential differences in static eliminating units disposed adjacent in the traveling direction of the sheet are opposite in polarity to each other is the most preferable at the point of reduction of the charge density in the surfaces of the charged portion and restoration of amount of increased charges in the non-charged portion. The same thing as this can be said about experiment results (Table 2) obtained using electrode units 8B (electrode units that are not the ion generating electrode exposed type electrode units).

TABLE 11

| | Polarities | | | | |
|---|---|---|---|---|---|
| | of inter-ion | Charged portion | | Non-charged portion | |
| | generating | (100 m/min) | | (100 m/min) | |
| | electrode | | Charge | | Charge |
| | potential | Assess- | density | Assess- | density |
| | differences | ment | [μC/M²] | ment | [μC/m²] |
| Blank | | No good | 760 | Best | −10-+10 |
| Example | +−+−+− | Best | 30 | Good | −50-−40 |
| 41-1 | | | | | |
| Example | ++++−− | Good | 50 | Good | +10-+40 |
| 42-1 | | | | | |
| Example | ++−−+− | Good | 50 | Good | −60-−50 |
| 42-2 | | | | | |
| Example | +−−−−+ | Good | 50 | Good | −120-−90 |
| 42-3 | | | | | |
| Compar- | ++++++ | Good | 160 | No good | +350-+360 |
| ative | | | | | |
| Example 5 | | | | | |

### INDUSTRIAL APPLICABILITY

The static eliminator and the static eliminating method for an electrical insulating sheet of the present invention are preferably used in the case where there is a need to eliminate charges or homogenize states of charges in a surface of an electrically insulating sheet, for example, a plastic film, a paper, etc. They are preferably used in the case where there is a need to eliminate charges or homogenize states of charges in a surface of an extra long sheet or a leaf sheet having specific longitudinal and lateral dimensions, a silicon wafer, a glass substrate or the like. The present invention may be used as a duster apparatus or a dusting method for removing dust from a subject article. The present invention may be used in the case where the charges of the one and other side of a subject article are to be adjusted to equal amounts with the subject article sandwiched in a narrow gap.

1. A static eliminator for an insulating sheet having at least two static eliminating units that are provided with an interval left therebetween in a traveling direction of an insulating sheet, in association with a traveling path of said sheet, each of said static eliminating units having a first electrode unit disposed at a first surface side of said sheet, and a second electrode unit disposed at a second surface side of said sheet, said first electrode unit having a first ion generating electrode, said second electrode unit having a second ion generating electrode that is disposed facing said first ion generating electrode, said static eliminator having a relationship that a direct-current inter-ion generating electrode potential difference is given between said first ion generating electrode and said second ion generating electrode in each of said static eliminating units, and having a relationship that, where the total number of said static eliminating unit is n (n is an integer of 2 or greater), said inter-ion generating electrode potential difference in n/4 number or more (fraction part counted as one) of said static eliminating units among the n number of said static eliminating units, and said inter-ion generating electrode potential difference in the other said static eliminating units are potential differences that are opposite in polarity to each other.

2. A static eliminator for an insulating sheet having at least two static eliminating units that are provided with an interval left therebetween in a traveling direction of an insulating sheet, in association with a traveling path of said sheet, each of said static eliminating units having a first electrode unit disposed at a first surface side of said sheet, and a second electrode unit disposed at a second surface side of said sheet, said first electrode unit having a first ion generating electrode, said second electrode unit having a second ion generating electrode that is disposed facing said first ion generating electrode, said static eliminator having a relationship that said first ion generating electrode and said second ion generating electrode in each of said static eliminating units are given a direct-current inter-ion generating electrode potential difference by applying direct-current voltages opposite in polarity to each other, and having a relationship that, where the total number of said static eliminating unit is n (n is an integer of 2 or greater), said inter-ion generating electrode potential difference in n/4 number or more (fraction part counted as one) of said static eliminating units among the n number of said static eliminating units, and said inter-ion generating electrode potential difference in the other said static eliminating units are potential differences that are opposite in polarity to each other.

3. A static eliminator for an insulating sheet having at least two static eliminating units that are provided with an interval left therebetween in a movement direction of an insulating sheet, in association with a traveling path of said sheet, each of said static eliminating units having a first electrode unit disposed at a first surface side of said sheet, and a second electrode unit disposed at a second surface side of said sheet, said first electrode unit having a first ion generating electrode, said second electrode unit having a second ion generating electrode that is disposed facing said first ion generating electrode, said static eliminator having a relationship that said first ion generating electrode and said second ion generating electrode in each of said static eliminating units are given a direct-current inter-ion generating electrode potential difference by applying a direct-current voltages opposite in polarity to each other with respect to a ground potential to the first and second ion generating electrodes, or by applying a ground potential to one of the first and second ion generating electrodes, and a direct-current voltage to the other one of the first and second ion generating electrodes, and having a relationship that, where the total number of said static eliminating unit is n (n is an integer of 2 or greater), said inter-ion generating electrode potential difference in n/4 number or more (fraction part counted as one) of said static eliminating units among the n number of said static eliminating units, and said inter-ion generating electrode potential difference in the other said static eliminating units are potential differences that are opposite in polarity to each other.

4. A static eliminator for an insulating sheet having at least two static eliminating units that are provided with an interval left therebetween in a traveling direction of an insulating sheet, in association with a traveling path of said sheet, each of said static eliminating units having a first electrode unit disposed at a first surface side of said sheet, and a second electrode unit disposed at a second surface side of said sheet, said first electrode unit having a first ion generating electrode, said second electrode unit having a second ion generating electrode that is disposed facing said first ion generating electrode, said static eliminator having a relationship that said first ion generating electrode and said second ion generating electrode in each of said static eliminating units are given a direct-current inter-ion generating electrode potential difference by giving potential difference opposite in polarity to each other with reference to a predetermined common potential, and having a relationship that, where the total number of said static eliminating unit is n (n is an integer of 2 or greater), said inter-ion generating electrode potential difference in n/4 number or more (fraction part counted as one) of said static eliminating units among the n number of said static eliminating units, and said inter-ion generating electrode potential difference in the other said static eliminating units are potential differences that are opposite in polarity to each other.

5. The static eliminator for an insulating sheet according to claim 1, having a relationship that said inter-ion generating electrode potential difference in n/2 number or more (fraction part disregarded) of said static eliminating units among the n number of said static eliminating units is a potential difference that is opposite in polarity to said inter-ion generating electrode potential difference in the other said static eliminating units.

6. The static eliminator for an insulating sheet according to claim 1, having a relationship that with regard to all of said static eliminating units, said inter-ion generating electrode potential differences of said static eliminating units adjacent in the traveling direction of said sheet are potential differences that are opposite in polarity to each other.

7. A static eliminator for an insulating sheet having at least two static eliminating units that are provided with an interval left therebetween in a traveling direction of an insulating sheet, in association with a traveling path of said sheet, each of said static eliminating units having a first electrode unit disposed at a first surface side of said sheet, and a second electrode unit disposed at a second surface side of said sheet, said first electrode unit having a first ion generating electrode, said second electrode unit having a second ion generating electrode that is disposed facing said first ion generating electrode,
(a) wherein said first electrode unit and said second electrode unit in at least one of said static eliminating units are both ion generating electrode exposed type electrode units, and
(b) wherein said static eliminator has a relationship that direct-current and/or alternating-current inter-ion generating electrode potential difference is given between said first ion generating electrode and said second ion generating electrode in each of said static eliminating units, and
(c) wherein said static eliminator has a relationship that, where the total number of said static eliminating unit is n (n is an integer of 2 or greater), said inter-ion generating electrode potential difference in n/4 number or more (fraction part counted as one) of said static eliminating units among the n number of said static eliminating units, and said inter-ion generating electrode potential difference in the other said static eliminating units are potential differences that are opposite in polarity to each other.

8. The static eliminator for an insulating sheet according to claim 1, having a relationship that in at least one pair of said static eliminating units adjacent in the traveling direction of said sheet, said inter-ion generating electrode potential differences of said at least one pair of said static eliminating units are potential differences that are opposite in polarity to each other, and a static eliminating unit interval of said at least one pair of said static eliminating units is 0.8 or greater times to 3.0 or less times a maximum value of normal direction inter-electrode distances of said at least one pair of said static eliminating units.

9. The static eliminator for an insulating sheet according to claim 8, having a relationship that the static eliminating unit interval of said at least one pair of said static eliminating units is 0.8 or greater times to 2.0 or less times the maximum value of the normal direction inter-electrode distances of said at least one pair of said static eliminating units.

10. The static eliminator for an insulating sheet according to claim 1, wherein in each of said static eliminating units, said first electrode unit has a first shield electrode and said second electrode unit has a second shield electrode, and having a relationship that in at least one pair of said static eliminating units adjacent in the traveling direction of said sheet, said inter-ion generating electrode potential differences of said at least one pair of said static eliminating units are potential differences that are opposite in polarity to each other, and a static eliminating unit interval of said at least one pair of said static eliminating units is 1.0 or greater times to 1.5 or less times a mean value of widthwise dimensions of said at least one pair of said static eliminating units.

11. The static eliminator for an insulating sheet according to claim 1, having a relationship that in at least one pair of said static eliminating units adjacent in the traveling direction of said sheet, said inter-ion generating electrode potential differences of said at least one pair of said static eliminating units are potential differences that are equal in polarity to each other, and a static eliminating unit interval of said at least one pair of said static eliminating units is 2.0 or greater times a maximum value of normal direction inter-electrode distances of said at least one pair of said static eliminating units.

12. The static eliminator for an insulating sheet according to claim 1, wherein in each of said static eliminating units, said first electrode unit has a first shield electrode and said second electrode unit has a second shield electrode, and having a relationship that in at least one pair of said static eliminating units adjacent in the traveling direction of said sheet, said inter-ion generating electrode potential differences of said at least one pair of said static eliminating units are potential differences that are equal in polarity to each other, and a static eliminating unit interval of said at least one pair of said static eliminating units is 1.5 or greater times a mean value of widthwise dimensions of said at least one pair of said static eliminating units.

13. The static eliminator for an insulating sheet according to claim 1, comprising a direct-current power supply whose ripple factor is 5% or less, as a power supply that gives said inter-ion generating electrode potential difference of each of said static eliminating units.

14. The static eliminator for an insulating sheet according to claim 1, having measurement means disposed at a downstream side of said static eliminating units in the traveling direction of said sheet for measuring a surface potential of a side of said insulating sheet opposite from a ground electrically conductive component while keeping said electrical insulating sheet in contact with said ground electrically conductive component, and control means for controlling said inter-ion generating electrode potential difference in at least one of said static eliminating units on a basis of a measurement value of said surface potential.

15. The static eliminator for an insulating sheet according to claim 1, having a relationship that an absolute value of said inter-ion generating electrode potential difference of a static eliminating unit that is provided most downstream in the traveling direction of said sheet among said static eliminating units is smaller than said inter-ion generating electrode potential difference of the other said static eliminating units.

16. The static eliminator for an insulating sheet according to claim 1, wherein a normal direction inter-electrode distance of a static eliminating unit that is provided most downstream in the traveling direction of said sheet among said static eliminating units is greater than the normal direction inter-electrode distance of the other said static eliminating units.

17. The static eliminator for an insulating sheet according to claim 1, wherein an electrode discrepancy of at least a static eliminating unit that is provided most downstream in the traveling direction of said sheet among said static eliminating units is greater than the electrode discrepancy of the other static eliminating units.

18. The static eliminator for an insulating sheet according to claim 1, having at least one alternating-current static eliminating unit that has a first alternating-current ion generating electrode and a second alternating-current ion generating electrode that are disposed facing each other across said sheet, at a downstream side of said static eliminating units in the traveling direction of said sheet, and having a relationship that an alternating-current inter-ion generating electrode potential difference is given between said first alternating-current ion generating electrode and said second alternating-current ion generating electrode.

19. The static eliminator for an insulating sheet according to claim 1, having a relationship that a positive or negative direct-current voltage is applied from at least one single power supply to said first ion generating electrode of at least one of said static eliminating units among said n number of said static eliminating units, and to said second ion generating electrode of at least one of said static eliminating units that is equal in number to said at least one of said static eliminating units and that is other than said at least one of said static eliminating units.

20. A static eliminating method for an insulating sheet, wherein a pair of ion clouds whose polarities do not temporally change are irradiated to an insulating sheet in motion, simultaneously from a side of a first surface and a side of a second surface of said sheet so that a potential difference is given between both surfaces, and then a pair of ion clouds whose polarities have been reversed from the polarities of the previous irradiation and whose polarities do not temporally change are irradiated to the first surface and the second surface of said sheet simultaneously with respect to the surfaces of said sheet, and the irradiation of said ion clouds is performed so that the amounts of ions of the two polarities become substantially equal.

21. A static eliminating method for an insulating sheet, wherein, where a temporal mean value of said inter-ion generating electrode potential difference in the mth (m is an integer of 1 or greater to n or less) one of said static eliminating units in respect to the traveling direction of said sheet is Vₘ [unit: kV], and a normal direction inter-electrode distance of the mth static eliminating unit is d₁₋ₘ [unit: mm], and a ripple factor of said inter-ion generating electrode potential difference is yₘ [unit: %], static elimination of said insulating sheet is performed by using the static eliminator according to claim 1 so that
a relationship expressed by an expression |Vₘ|/d₁₋ₘ>0.26 is satisfied, and
at least one relationship of a first relationship expressed by an expression yₘ≦5 and a second relationship expressed by an expression |Vₘ|<16 and an expression |Vₘ|/d₁₋ₘ<0.35 is satisfied.

22. The static eliminating method for an insulating sheet according to claim 21, wherein a peak to peak amplitude of a sum of the voltage applied to said first ion generating electrode and the voltage applied to said second ion generating electrode in said mth static eliminating unit is 0.05 or greater times to 0.975 or less times an absolute value of the temporal mean value of said inter-ion generating electrode potential difference in said mth static eliminating unit.

23. A static eliminating method for an insulating sheet, wherein said first ion generating electrode and said second ion generating electrode in each of said static eliminating units are given a direct-current inter-ion generating electrode potential difference by applying direct-current voltages opposite in polarity to each other, and wherein, where temporal mean values of the direct-current voltages applied to said first ion generating electrode and said second ion generating electrode in the mth (m is an integer of 1 or greater to n or less) one of said static eliminating units in respect to the traveling direction of said sheet are V₁₋ₘ [unit: kV] and V₂₋ₘ [unit: kV], respectively, and a normal direction inter-electrode distance of the mth static eliminating unit is d₁₋ₘ [unit: mm], and a mean ripple factor of a ripple factor of said direct-current voltage applied to said first ion generating electrode and a ripple factor of said direct-current voltage applied to said second ion generating electrode in said mth static eliminating unit is xₘ [unit: %], static elimination of said insulating sheet is performed by using the static eliminator according to claim 1 so that
a relationship expressed by an expression |V₁₋ₘ-V₂₋ₘ|/d₁₋ₘ>0.26 is satisfied, and
at least one relationship of a first relationship expressed by an expression xₘ≦5 and a second relationship expressed by an expression |V₁₋ₘ|<8, an expression |V₂₋ₘ|<8 and an expression |V₁₋ₘ-V₂₋ₘ|/d₁₋ₘ<0.35 is satisfied.

24. A method for producing a charge-eliminated insulating sheet, wherein a pair of ion clouds whose polarities do not temporally change are irradiated to an insulating sheet in motion, simultaneously from a first surface side and a second surface side of said sheet so that a potential difference is given between both surfaces, and then a pair of ion clouds whose polarities have been reversed from the polarities of the previous irradiation and whose polarities do not temporally change are irradiated to the first surface and the second surface of said sheet simultaneously with respect to the surfaces of said sheet, and the irradiation of said ion clouds is performed so that the amounts of ions of the two polarities become substantially equal.

25. A method for producing a charge-eliminated insulating sheet, wherein, where a temporal mean value of said inter-ion generating electrode potential difference in the mth (m is an integer of 1 or greater to n or less) one of said static eliminating units in respect to the traveling direction of said sheet is Vₘ [unit: kV], and a normal direction inter-electrode distance of the mth static eliminating unit is d₁₋ₘ [unit: mm], and a ripple factor of said inter-ion generating electrode potential difference is yₘ [unit: 0%], static elimination of said insulating sheet is performed by using the static eliminator according to claim 1 so that
a relationship expressed by an expression |Vₘ|/d₁₋ₘ>0.26 is satisfied, and
at least one relationship of a first relationship expressed by an expression yₘ≦5 and a second relationship expressed by an expression |Vₘ|<16 and an expression |Vₘ|/d₁₋ₘ<0.35 is satisfied.

26. A method for producing a charge-eliminated insulating sheet, according to claim 25, wherein a peak to peak amplitude of a sum of the voltage applied to said first ion generating electrode and the voltage applied to said second ion generating electrode in said mth static eliminating unit is 0.05 or greater times to 0.975 or less times an absolute value of the temporal mean value of said inter-ion generating electrode potential difference in said mth static eliminating unit.

27. A method for producing a charge-eliminated insulating sheet, wherein said first ion generating electrode and said second ion generating electrode in each of said static eliminating units are given a direct-current inter-ion generating electrode potential difference by applying direct-current voltages opposite in polarity to each other, and wherein, where temporal mean values of the direct-current voltages applied to said first ion generating electrode and said second ion generating electrode in the mth (m is an integer of 1 or greater to n or less) static eliminating unit in respect to the traveling direction of said sheet are V₁₋ₘ [unit: kV] and V₂₋ₘ [unit: kV], respectively, and a normal direction inter-electrode distance of the mth static eliminating unit is d₁₋ₘ [unit: mm], and a mean ripple factor of a ripple factor of said direct-current voltage applied to said first ion generating electrode and a ripple factor of said direct-current voltage applied to said second ion generating electrode in said mth static eliminating unit is xₘ [unit: 0%], static elimination of said insulating sheet is performed by using the static eliminator according to claim 1 so that
a relationship expressed by an expression |V₁₋ₘ-V₂₋ₘ|/d₁₋ₘ>0.26 is satisfied, and
at least one relationship of a first relationship expressed by an expression xₘ≦5 and a second relationship expressed by an expression |V₁₋ₘ|<8, an expression |V₂₋ₘ|<8 and an expression |V₁₋ₘ-V₂₋ₘ|/d₁₋ₘ<0.35 is satisfied.
